(19) United States
(12) Patent Application Publication
(10) Pub. No.: US 2025/0240136 A1
(43) Pub. Date: Jul. 24, 2025

(54) METHOD AND APPARATUS FOR TRANSMISSION AND RECEPTION OF DATA INFORMATION IN SATELLITE COMMUNICATION SYSTEM

(71) Applicant: Samsung Electronics Co., Ltd., Suwon-si (KR)

(72) Inventors: Sungjin PARK, Suwon-si (KR); Kyoungmin PARK, Suwon-si (KR); Kyungjun CHOI, Suwon-si (KR)

(21) Appl. No.: 19/028,690

(22) Filed: Jan. 17, 2025

(30) Foreign Application Priority Data
Jan. 18, 2024 (KR) 10-2024-0008116

(51) Int. Cl. H04L 5/00; H04W 72/232

(52) U.S. Cl. CPC H04L 5/0048; H04W 72/232

(57) ABSTRACT

The disclosure relates to a fifth generation (5G) or sixth generation (6G) communication system for supporting higher data transfer rates. A method performed by a user equipment (UE) in a communication system is provided. The method includes identifying physical uplink shared channel (PUSCH) transmissions to be transmitted on slots, identifying orthogonal cover code (OCC) groups corresponding to the PUSCH transmissions, and transmitting, on the slots, the PUSCH transmissions with OCC applied based on the OCC groups, wherein a same redundancy version (RV) value is applied for one OCC group among the OCC groups.

### CROSS-REFERENCE TO RELATED APPLICATION(S)

This application is based on and claims priority under 35 U.S.C. § 119(a) of a Korean patent application number 10-2024-0008116, filed on Jan. 18, 2024, in the Korean Intellectual Property Office, the disclosure of which is incorporated by reference herein in its entirety.

### BACKGROUND

### 1. Field

The disclosure relates to a wireless communication system. More particularly, the disclosure relates to an operation of a user equipment (UE) and a base station (BS) in a satellite communication system, and a method for transmitting and receiving data information in a satellite communication system and an apparatus capable of performing the same.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of effectively providing services in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes identifying physical uplink shared channel (PUSCH) transmissions to be transmitted on slots, identifying orthogonal cover code (OCC) groups corresponding to the PUSCH transmissions, and transmitting, on the slots, the PUSCH transmissions with OCC applied based on the OCC groups, wherein a same redundancy version (RV) value is applied for one OCC group among the OCC groups.

According to an embodiment, wherein the method further includes receiving downlink control information (DCI) including PUSCH scheduling information and an RV field, and wherein the PUSCH transmissions are identified based on the DCI.

According to an embodiment, wherein RV values identified based on the RV field are cyclically applied for the OCC groups.

According to an embodiment, wherein the method further includes receiving a first configuration associated with a PUSCH repetition and a second configuration associated with OCC length.

According to an embodiment, wherein the PUSCH transmissions correspond to the PUSCH repetition and wherein the RV values are cyclically applied for the OCC groups in case that a repetition number of the PUSCH repetition is greater than the OCC length.

According to an embodiment, wherein the same RV value is applied for the OCC groups.

According to an embodiment, wherein the PUSCH transmissions are transmitted in a non-terrestrial network (NTN).

In accordance with another aspect of the disclosure, a user equipment (UE) in a communication system is provided. The UE includes a transceiver, and a processor coupled with the transceiver and configured to identify physical uplink shared channel (PUSCH) transmissions to be transmitted on slots, identify orthogonal cover code (OCC) groups corresponding to the PUSCH transmissions, and transmit, on the slots, the PUSCH transmissions with OCC applied based on the OCC groups, wherein a same redundancy version (RV) value is applied for one OCC group among the OCC groups.

According to an embodiment, wherein the processor is further configured to receive downlink control information (DCI) including PUSCH scheduling information and an RV field, and wherein the DCI includes an RV field for the PUSCH transmission.

According to an embodiment, wherein RV values identified based on the RV field are cyclically applied for the OCC groups.

According to an embodiment, wherein the processor is further configured to receive a first configuration associated with a PUSCH repetition and a second configuration associated with OCC length.

According to an embodiment, wherein the RV values are cyclically applied for the OCC groups in case that a repetition number of the PUSCH repetition is greater than the OCC length.

According to an embodiment, wherein the same RV value is applied for the OCC groups.

According to an embodiment, wherein the PUSCH transmissions are transmitted in a non-terrestrial network (NTN).

In accordance with another aspect of the disclosure, a method performed by a base station in a communication system is provided. The method includes transmitting downlink control information (DCI) including physical uplink shared channel (PUSCH) scheduling information; and receiving, on slots, PUSCH transmissions with orthogonal cover code (OCC) applied based on OCC groups corresponding to the PUSCH transmissions, wherein a same redundancy version (RV) value is applied for one OCC group among the OCC groups.

According to an embodiment, wherein the DCI includes an RV field.

According to an embodiment, wherein RV values associated with the RV field are cyclically applied for the OCC groups.

According to an embodiment, wherein the method further includes transmitting a first configuration associated with a PUSCH repetition and a second configuration associated with OCC length.

According to an embodiment, wherein the PUSCH transmissions correspond to the PUSCH repetition, and wherein the RV values are cyclically applied for the OCC groups in case that a repetition number of the PUSCH repetition is greater than the OCC length.

According to an embodiment, wherein the same RV value is applied for the OCC groups.

According to an embodiment, wherein the PUSCH transmissions are received in a non-terrestrial network (NTN).

In accordance with another aspect of the disclosure, a base station in a communication system is provided. The base station includes a transceiver, and a processor coupled with the transceiver and configured to transmit downlink control information (DCI) including physical uplink shared channel (PUSCH) scheduling information, and receive, on slots, PUSCH transmissions with orthogonal cover code (OCC) applied based on OCC groups corresponding to the PUSCH transmissions, wherein a same redundancy version (RV) value is applied for one OCC group among the OCC groups.

According to an embodiment, wherein the DCI includes an RV field.

According to an embodiment, wherein RV values associated with the RV field are cyclically applied for the OCC groups.

According to an embodiment, wherein the processor is further configured to transmit a first configuration associated with a PUSCH repetition and a second configuration associated with OCC length.

According to an embodiment, wherein the RV values are cyclically applied for the OCC groups in case that a repetition number of the PUSCH repetition is greater than the OCC length.

According to an embodiment, wherein the same RV value is applied for the OCC groups.

According to an embodiment, wherein the PUSCH transmissions are received in a non-terrestrial network (NTN).

Embodiments set forth herein provide a device and a method capable of effectively providing services in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates an example of a control resource set configuration of a downlink control channel in a wireless communication system according to an embodiment of the disclosure;

FIG. 5 illustrates a structure of a downlink control channel in a wireless communication system according to an embodiment of the disclosure;

FIG. 6 illustrates, in terms of spans, a case in which a UE may have multiple PDCCH monitoring occasions within a slot in a wireless communication system according to an embodiment of the disclosure;

FIG. 7 illustrates an example of base station beam allocation according to a transmission configuration indicator (TCI) state configuration in a wireless communication system according to an embodiment of the disclosure;

FIG. 8 illustrates an example of a method for allocating a TCI state to a PDCCH in a wireless communication system according to an embodiment of the disclosure;

FIG. 9 illustrates a TCI indication medium access control (MAC) control element (MAC CE) signaling structure for a PDCCH DMRS in a wireless communication system according to an embodiment of the disclosure;

FIG. 10 illustrates an example of a beam configuration with regard to a control resource set and a search space in a wireless communication system according to an embodiment of the disclosure;

FIG. 11 illustrates a method in which a base station and a UE transmit/receive data in consideration of a downlink data channel and a rate matching resource in a wireless communication system according to an embodiment of the disclosure;

FIG. 12 illustrates a method in which, upon receiving a downlink control channel, a UE selects a receivable control resource set in consideration of priority in a wireless communication system according to an embodiment of the disclosure;

FIG. 13 illustrates an example of an aperiodic CSI reporting method according to an embodiment of the disclosure;

FIG. 14 illustrates an example of PUSCH repetitive type B transmission in a wireless communication system according to an embodiment of the disclosure;

FIG. 15 illustrates radio protocol structures of a base station and a UE in single cell, carrier aggregation, and dual connectivity situations according to an embodiment of the disclosure;

FIG. 16 illustrates an example of an antenna port configuration and resource allocation for cooperative communication in a wireless communication system according to an embodiment of the disclosure;

FIG. 17 illustrates an example of a downlink control information (DCI) configuration for cooperative communication in a wireless communication system according to an embodiment of the disclosure;

FIG. 18 illustrates a procedure in which a base station controls transmission power of a UE in a cellular system according to an embodiment of the disclosure;

FIG. 19 illustrates a procedure in which a UE generates a Type-1 (semi-static) hybrid automatic repeat request acknowledgment (HARQ-ACK) codebook according to an embodiment of the disclosure;

FIG. 20 illustrates a procedure in which a UE generates a Type-2 (dynamic) HARQ-ACK codebook according to an embodiment of the disclosure;

FIG. 21 illustrates an Earth orbital period of a communication satellite according to an altitude or height of the satellite according to an embodiment of the disclosure;

FIG. 22 is a block diagram illustrating a method for generating LTE physical uplink control channel (PUCCH) format 5 according to an embodiment of the disclosure;

FIG. 23 illustrates a method by which different UEs perform mapping to virtual frequency tones by applying different OCC values according to an embodiment of the disclosure;

FIG. 24 is a flowchart illustrating a UE processing procedure for PUSCH transmission according to an embodiment of the disclosure;

FIG. 25 illustrates a method of applying an OCC scheme when a UE performs PUSCH repeated transmission for each slot according to an embodiment of the disclosure;

FIG. 26 illustrates a method of applying an OCC scheme when a UE performs PUSCH repeated transmission within one slot according to an embodiment of the disclosure;

FIG. 27 illustrates a method of applying an OCC scheme from a time resource perspective when a UE performs PUSCH transmission according to an embodiment of the disclosure;

FIG. 28 illustrates a method of applying an OCC scheme from a frequency resource perspective when a UE performs PUSCH transmission according to an embodiment of the disclosure;

FIG. 29 is a diagram illustrating OCC spreading applied for each PUSCH group according to an embodiment of the disclosure;

FIG. 30 illustrates a situation in which a specific PUSCH and a PUCCH overlap when UEs perform PUSCH repeated transmission according to an embodiment of the disclosure;

FIG. 31 illustrates resource allocation showing the order in which uplink control information (UCI) is multiplexed to a PUSCH according to an embodiment of the disclosure;

FIG. 32 illustrates a situation in which UEs receive scheduling of PUSCH repeated transmission and the PUSCH repeated transmission overlaps PUCCH repeated transmission according to an embodiment of the disclosure;

FIG. 33 illustrates a procedure of performing PUSCH transmission applied with an OCC scheme according to an embodiment of the disclosure;

FIG. 34 illustrates a structure of a UE in a wireless communication system according to an embodiment of the disclosure; and

FIG. 35 illustrates a structure of a base station in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, a base station is an entity that allocates resources to terminals, and may be at least one of a gNode B, an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or LTE-advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of third generation partnership project (3GPP), LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

To meet the demand for wireless data traffic having increased since deployment of 4G communication systems, efforts have been made to develop an improved 5G or pre-5G communication system. Therefore, the 5G or pre-5G communication system is also called a “beyond 4G network” communication system or a “post LTE” system. The 5G communication system is considered to be implemented in ultrahigh frequency (mmWave) bands, (e.g., 60 GHz bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems. In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like. In the 5G system, hybrid frequency shift keying (FSK) and quadrature amplitude modulation (QAM) (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems (5th generation communication system or new radio (NR)) to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology.

With the advance of wireless communication systems as described above, various services can be provided, and accordingly there is a need for ways to smoothly provide these services.

### [NR Time-Frequency Resources]

Hereinafter, a frame structure of a 5G system will be described in more detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an integrated circuit (IC), or the like.

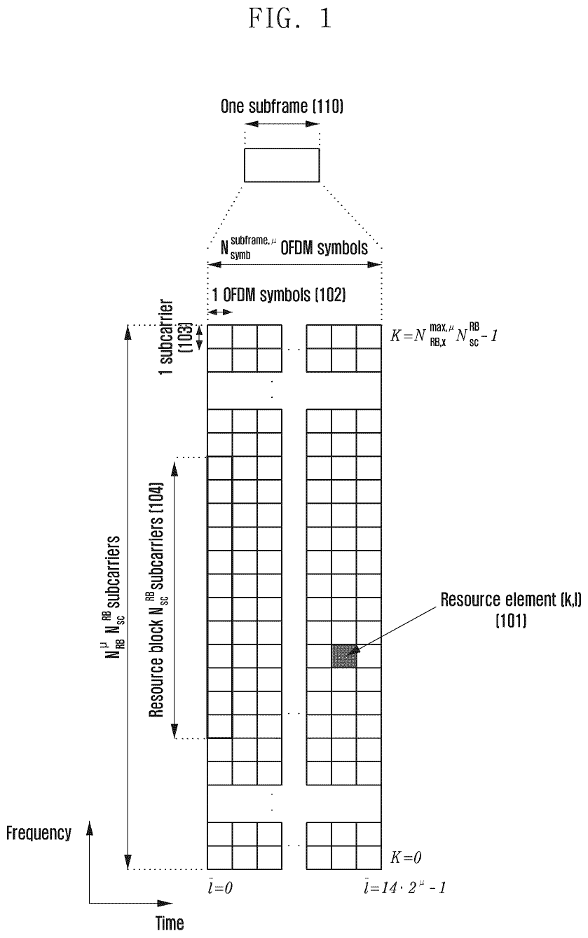

FIG. 1 illustrates a basic structure of a time-frequency domain, which is a radio resource domain used to transmit data or control channels, in a 5G system according to an embodiment of the disclosure.

Referring to FIG. 1, in a subframe 110, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (e.g., 12) consecutive REs may constitute one resource block (RB) 104.

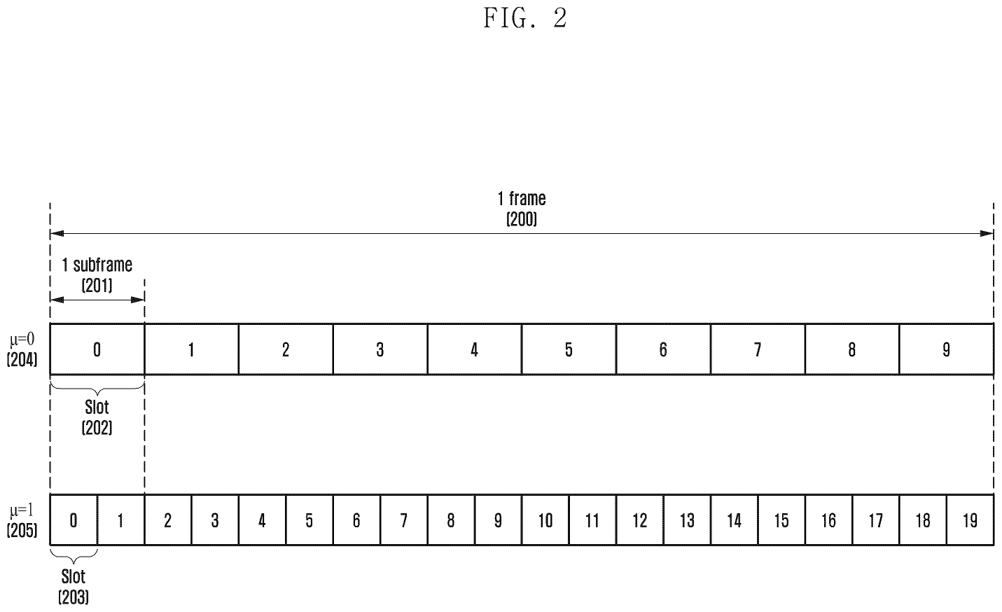

FIG. 2 illustrates a structure of a frame, a subframe, and a slot in a wireless communication system according to an embodiment of the disclosure.

Referring to FIG. 2, an example of a structure of a frame 200, a subframe 201, and a slot 202 is illustrated. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values p for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe Nₛₗₒₜ^{subframe,μ}, may differ depending on the subcarrier spacing configuration value p, and the number of slots per one frame Nₛₗₒₜ^{frame,μ} may differ accordingly. Nₛₗₒₜ^{subframe,μ} and Nₛₗₒₜ^{frame,μ} may be defined according to each subcarrier spacing configuration p as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

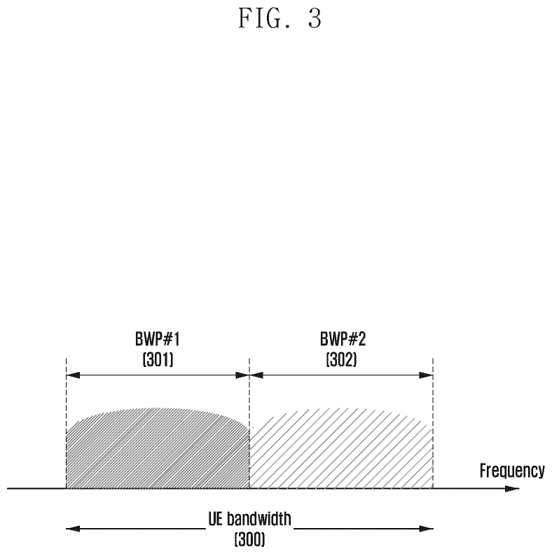

FIG. 3 illustrates an example of a bandwidth part configuration in a wireless communication system according to an embodiment of the disclosure.

Referring to FIG. 3, an example in which a UE bandwidth 300 is configured to include two bandwidth parts, that is, bandwidth part #1 (BWP #1) 301 and bandwidth part #2 (BWP #2) 302 is illustrated. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Of course, the above example is not limiting, and in addition to the configuration information given above, various parameters related to the bandwidth part may be configured for the UE. The base station may transfer the configuration information to the UE through higher layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource set #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to some embodiments, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to some embodiments, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (e.g., a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (TBWP) required during a bandwidth part change are specified in standards, and may be defined given in Table 3 below, for example.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

Note 1: Depends on UE capability.
Note 2: If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (e.g., DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (e.g., the last symbol of slot n+K−1).

### [SS/PBCH Block]

Next, synchronization signal (SS)/PBCH blocks in 5G will be described.

An SS/PBCH block may refer to a physical layer channel block including a primary synchronization signal (PSS), a secondary synchronization signal (SSS), and a PBCH. Details thereof are as follows.
PSS: a signal which becomes a reference of downlink time/frequency synchronization, and provides partial information of a cell ID.
SSS: becomes a reference of downlink time/frequency synchronization, and provides remaining cell ID information not provided by the PSS. Additionally, the SSS may serve as a reference signal for PBCH demodulation of a PBCH.
PBCH: provides mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information, for example.

TABLE 4

| | |
|---|---|
| - | Identifier for DCI formats - [1] bit |
| - | Frequency domain resource assignment -[┌log₂( |

N_{RB}^{UL,BWP}(N_{RB}^{UL,BWP} + 1)/2)┐ ] bits

| | |
|---|---|
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH - [2] |
| | bits |
| - | Uplink/ supplementary uplink (UL/SUL) indicator - 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information, for example.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
        * For resource allocation type 0, ┌N_{RB}^{UL,BWP}/P┐ bits
        * For resource allocation type 1, ┌log₂(N_{RB}^{UL,BWP}(N_{RB}^{UL,BW} +
        1)/2)┐ bits
  - Time domain resource assignment -1, 2, 3, or 4 bits
  - Virtual resource block (VRB)-to-physical resource block (PRB) mapping -
0 or 1 bit, only for resource allocation type 1.
        * 0 bit if only resource allocation type 0 is configured;
        * 1 bit otherwise.
  - Frequency hopping flag - 0 or 1 bit, only for resource allocation type 1.
        * 0 bit if only resource allocation type 0 is configured;
        * 1 bit otherwise.
  - Modulation and coding scheme - 5 bits
  - New data indicator - 1 bit
  - Redundancy version - 2 bits
  - HARQ process number - 4 bits
  - 1st downlink assignment index- 1 or 2 bits
        * 1 bit for semi-static HARQ-ACK codebook;
        * 2 bits for dynamic HARQ-ACK codebook with single HARQ-
        ACK codebook.
  - 2nd downlink assignment index - 0 or 2 bits
        * 2 bits for dynamic HARQ-ACK codebook with two HARQ-ACK
        sub-codebooks;
        * 0 bit otherwise.
  - TPC command for scheduled PUSCH - 2 bits
  $‐ SRS resource indicator - ⌈ {log}_{2} ( {\sum }_{k = 1}^{{L}_{max} \sum } ( \begin{matrix}{N}_{SRS} \\ k\end{matrix} ) ( ) ) ▯▯ ⌉ or ⌈ {log}_{2} ( {N}_{SRS} ) ⌉ bits$
        $* ⌈ {log}_{2} ( {\sum }_{k = 1}^{{L}_{max} \sum } ( \begin{matrix}{N}_{SRS} \\ k\end{matrix} ) ( ) ) ▯▯ ⌉ bits for non - codebook based$
        PUSCH transmission;
        * ┌log₂ (N_{SRS})┐ bits for codebook based PUSCH transmission.
  - Precoding information and number of layers - up to 6 bits
  - Antenna ports - up to 5 bits
  - SRS request - 2 bits
  - Channel state information (CSI) request - 0, 1, 2, 3, 4, 5, or 6 bits
  - Code block group (CBG) transmission information - 0, 2, 4, 6, or 8 bits
  - Phase tracking reference signal (PTRS)-demodulation reference signal
(DDMRS) association - 0 or 2 bits.
  - beta_offset indicator - 0 or 2 bits
  - DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information, for example.

TABLE 6
Identifier for DCI formats - bit

| - | Identifier for DCI formats - [1] bit |
|---|---|
| - | Frequency domain resource assignment - |
| | [┌log₂(N_{RB}^{DL,BWP}(N_{RB}^{DL,BWP} + |
| 1)/2)┐ ] bits | |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Pysical uplink control channel (PUCCH) resource |
| | indicator - 3 bits |
| - | PDSCH-to-HARQ feedback timing indicator - [3] bits |

DC format 1_1 may be used as non-fallback D for scheduling a PDSCH, and in this case, the CRC may be scrambled by a C-RNTI. DCI format 1_1 in which the CRC is scrambled by a C-RNTI may include the following pieces of information, for example.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |
| | * For resource allocation type 0, ┌N_{RB}^{DL,BWP} /P┐ bits |
| | * For resource allocation type 1, |
| | ┌log₂(N_{RB}^{DL,BWP}(N_{RB}^{DL,BWP} + 1)/2)┐ |
| | bits |
| - | Time domain resource assignment -1, 2, 3, or 4 bits |
| - | VRB-to-PRB mapping - 0 or 1 bit, only for resource |
| | allocation type 1. |
| | * 0 bit if only resource allocation type 0 is configured; |
| | * 1 bit otherwise. |
| - | Physical resource block (PRB) bundling size indicator - 0 or 1 bit |
| - | Rate matching indicator - 0, 1, or 2 bits |
| - | Zero power (ZP) channel state information (CSI)-reference |
| | signal (RS) trigger |

- 0, 1, or 2 bits
For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, and Search Space]

Hereinafter, a downlink control channel in a 5G communication system will be described in more detail with reference to the accompanying drawings.

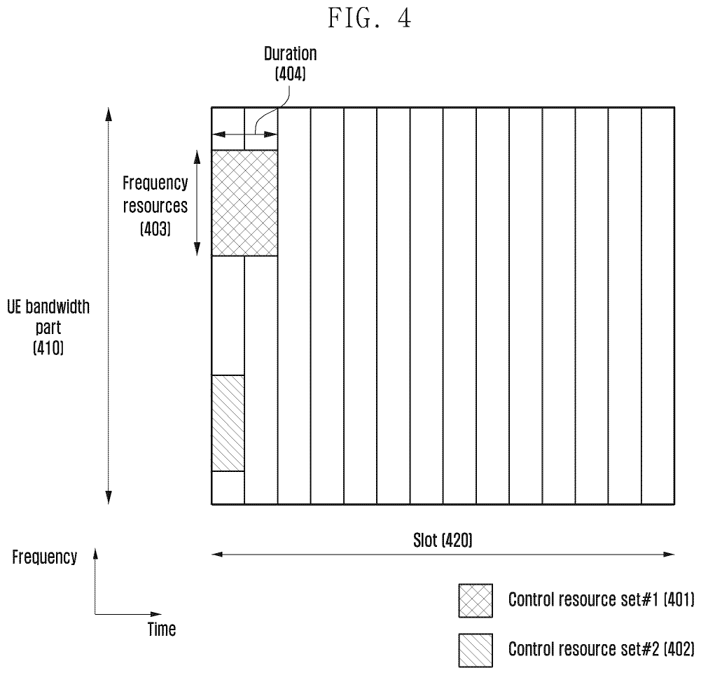

FIG. 4 illustrates an example of a control resource set (CORESET) used to transmit a downlink control channel in a 5G wireless communication system according to an embodiment of the disclosure.

Referring to FIG. 4, an example in which a UE bandwidth part 410 is configured along the frequency axis, and two CORESETs (CORESET #1 420 and CORESET #2 401) are configured within one slot 402 along the time axis is illustrated. The control resource sets 401 and 402 may be configured in a specific frequency resource 410 within the entire UE bandwidth part 403 along the frequency axis. The control resource sets 401 and 402 may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through higher layer signaling (e.g., system information, master information block (MIB), radio resource control (RRC) signaling). The description that a control resource set is configured for a UE means that information such as a control resource set identity, the control resource set's frequency location, and the control resource set's symbol duration is provided. For example, the control resource set may include the following pieces of information: given in Table 8 below.

TABLE 8

| | |
|---|---|
| ConControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG- |

bundle, allContiguousRBs},

| | |
|---|---|
| interleaverSize | ENUMERATED {n2, n3, n6} |

```
                (interleaver size)
                shiftIndex
INTEGER(0..maxNrofPhysicalResourceBlocks-1)
OPTIONAL
              (interleaver shift)
          },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |
| | OPTIONAL, -- Need S |

}

In Table 9, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

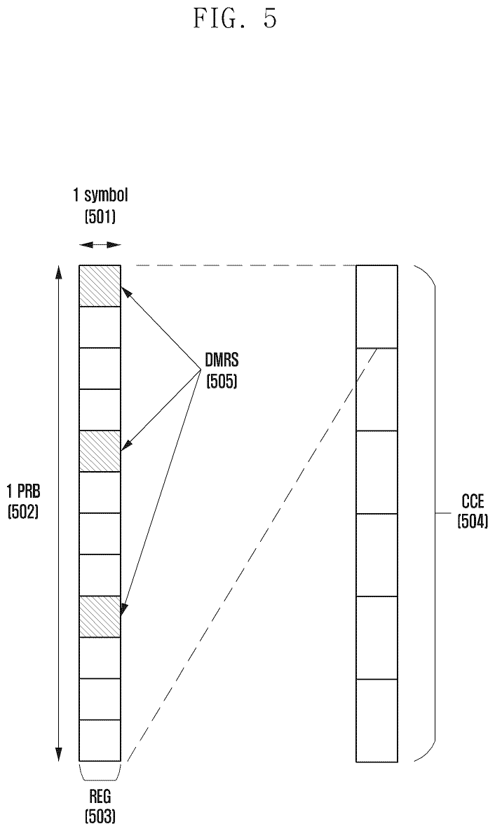

FIG. 5 illustrates a structure of a downlink control channel in a wireless communication system according to an embodiment of the disclosure. FIG. 5 illustrates an example of a basic unit of time and frequency resources constituting a downlink control channel available in a 5G system.

Referring to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element (CCE) 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through higher layer signaling (e.g., SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the following pieces of information may be included.

TABLE 9

| | |
|---|---|
| SearchSpace ::= | SEQUENCE { |

-- Identity of the search space. SearchSpaceId = 0 identifies the SearchSpace configured via
PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| duration (monitoring duration) | INTEGER (2..2559) |
| monitoringSymbolsWithinSlot | BIT STRING (SIZE (14)) |

(monitoring symbols within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

},

| | |
|---|---|
| searchSpaceType | CHOICE { |

```
    (search space type)
      -- Configures this search space as common search space (CSS) and DCI formats to
monitor.
```

| | |
|---|---|
| common | SEQUENCE { |

```
    (common search space)
    }
```

| | |
|---|---|
| ue-Specific | SEQUENCE { |

```
    (UE-specific search space)
        -- Indicates whether the UE monitors in this USS for DCI formats 0-0 and 1-0 or for
formats 0-1 and 1-1.
```

| | |
|---|---|
| formats | ENUMERATED {formats0-0-And-1-0, |

formats0-1-And-1-1},
...
}

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
   DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI (SI-RNTI): used to schedule a PDSCH in which system information is transmitted

Interruption RNTI (INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI) for indicating power control command for PUCCH

Transmit power control for SRS RNTI (TPC-SRS-RNTI): used to indicate a power control command regarding an SRS

The DCI formats enumerated above may follow the definitions given below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L
i=0, . . . , L−1
   Y_{p,n}_{_{s,f}}^{μ}=(Aₚ·Y_{p,n}_{_{s,f}}^{μ}₋₁) mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The Y_{p,n}_{_{s,f}}^{μ} value may correspond to 0 in the case of a common search space.

The Y_{p,n}_{_{s,f}}^{μ} value may correspond to a value changed by the UE's identity (C-RNTI or ID configured for the UE by the base station) and the time index in the case of a UE-specific search space.

In 5G, multiple search space sets may be configured by different parameters (e.g., parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [PDCCH: Span]

The UE may perform UE capability reporting at each subcarrier spacing with regard to a case in which the same has multiple PDCCH monitoring occasions inside a slot, and the concept “span” may be used in this regard. A span refers to consecutive symbols configured such that the UE can monitor the PDCCH inside the slot, and each PDCCH monitoring occasion is inside one span. A span may be expressed by (X,Y) wherein X refers to the minimum number of symbols by which the first symbols of two consecutive spans are spaced apart from each other, and Y refers to the number of consecutive symbols in which a PDCCH can be monitored within one span. A UE may monitor a PDCCH in a range of Y symbols from the first symbol of the span within the span.

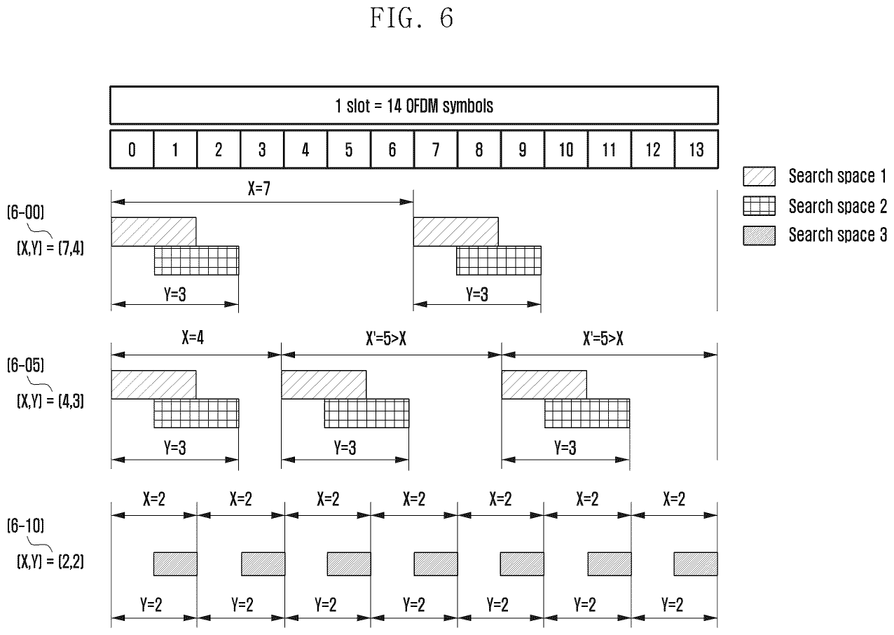

FIG. 6 illustrates, in terms of spans, a case in which a UE may have multiple PDCCH monitoring occasions within a slot in a wireless communication system according to an embodiment of the disclosure.

Referring to FIG. 6, possible spans are (X,Y)=(7,3), (4,3), (2,2), and the three cases may be indicated by “6-00”, “6-05”, and “6-10”, respectively. As an example, “6-00” may describe a case in which there are two spans described by (7,4) inside a slot. The spacing between the first symbols of two spans is described as X=7, a PDCCH monitoring occasion may exist inside a total of Y=3 symbols from the first symbol of each span, and search spaces 1 and 2 may exist inside Y=3 symbols, respectively. As another example, “6-05” may describe a case in which there are a total of three spans described by (4,3) inside a slot, and the second and third spans are spaced apart by X′=5 symbols which are larger than X=4.

### [PDCCH: UE Capability Report]

The slot location at which the above-described common search space and the UE-specific search space are positioned is indicated by parameter “monitoringSymbolsWitninSlot” in Table 13-1, and the symbol location inside the slot is indicated as a bitmap through parameter “monitoringSymbolsWithinSlot” in Table 9. Meanwhile, the symbol location inside a slot at which the UE can monitor search spaces may be reported to the base station through the following UE capabilities.
UE capability 1 (hereinafter referred to as FG 3-1). This UE capability may have the following meaning: if there is one monitoring occasion (MO) regarding type 1 and type 3 common search spaces or UE-specific search spaces inside a slot, as in Table 11 below, the UE can monitor the corresponding MO when the corresponding MO is located inside the first three symbols inside the slot. This UE capability is a mandatory capability which is to be supported by all UEs that support NR, and whether or not UE capability 1 is supported is not explicitly reported to the base station.

TABLE 11

| | Feature | | Field name in |
|---|---|---|---|
| Index | group | Components | TS 38.331 [2] |
| 3-1 | Basic DL | 1) One configured CORESET per BWP per cell in | n/a |
| | control | addition to CORESET0 | |
| | channel | CORESET resource allocation of 6RB bit-map | |
| | | and duration of 1-3 OFDM symbols for FR1 | |
| | | For type 1 CSS without dedicated RRC | |
| | | configuration and for type 0, 0A, and 2 CSSs, | |
| | | CORESET resource allocation of 6RB bit-map | |
| | | and duration 1-3 OFDM symbols for FR2 | |
| | | For type 1 CSS with dedicated RRC | |
| | | configuration and for type 3 CSS, UE specific SS, | |
| | | CORESET resource allocation of 6RB bit-map | |
| | | and duration 1-2 OFDM symbols for FR2 | |
| | | REG-bundle sizes of 2/3 RBs or 6 RBs | |
| | | Interleaved and non-interleaved CCE-to-REG | |
| | | mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast | |
| | | PDCCH transmission per BWP per cell | |
| | | PDCCH aggregation levels 1, 2, 4, 8, 16 | |
| | | UP to 3 search space sets in a slot for a | |
| | | scheduled SCell per BWP | |
| | | This search space limit is before applying all | |
| | | dropping rules. | |
| | | For type 1 CSS with dedicated RRC | |
| | | configuration, type 3 CSS, and UE-SS, the | |
| | | monitoring occasion is within the first 3 OFDM | |
| | | symbols of a slot | |
| | | For type 1 CSS without dedicated RRC | |
| | | configuration and for type 0, 0A, and 2 CSS, the | |
| | | monitoring occasion can be any OFDM symbol(s) | |
| | | of a slot, with the monitoring occasions for any of | |
| | | Type 1- CSS without dedicated RRC | |
| | | configuration, or Types 0, 0A, or 2 CSS | |
| | | configurations within a single span of three | |
| | | consecutive OFDM symbols within a slot | |
| | | 3) Monitoring DCI formats 0_0, 1_0, 0_1, 1_1 | |
| | | 4) Number of PDCCH blind decodes per slot with | |
| | | a given SCS follows Case 1-1 table | |
| | | 5) Processing one unicast DCI scheduling DL and | |
| | | one unicast DCI scheduling UL per slot per | |
| | | scheduled CC for FDD | |
| | | 6) Processing one unicast DCI scheduling DL and | |
| | | 2 unicast DCI scheduling UL per slot per | |
| | | scheduled CC for TDD | |

UE capability 2 (hereinafter referred to as FG 3-2). This UE capability has the following meaning: if there is one monitoring occasion (MO) regarding a common search space or a UE-specific search space inside a slot, as in Table 12 below, the UE can monitor the corresponding MO no matter what of the start symbol location of the corresponding MO may be. This UE capability is optionally supported by the UE, and whether or not this UE capability is supported is explicitly reported to the base station.

TABLE 12

| | Feature | | Field name in |
|---|---|---|---|
| Index | group | Components | TS 38.331 [2] |
| 3-2 | PDCCH | For a given UE, all search space | pdcchMonitoringSingleOccasion |
| | monitoring | configurations are within the same | |
| | on any span | span of 3 consecutive OFDM | |
| | of up to 3 | symbols in the slot | |
| | consecutive | | |
| | OFDM symbols | | |
| | of a slot | | |

UE capability 3 (hereinafter, referred to as FG 3-5, 3-5a, or 3-5b). This UE capability has the following meaning: if there are multiple monitoring occasions (MO) regarding a common search space or a UE-specific search space inside a slot, as in Table 13 below, the pattern of the MO which the UE can monitor is indicated. The above-mentioned pattern includes the spacing X between start symbols of different MOs, and the maximum symbol length Y regarding one MO. The combination of (X,Y) supported by the UE may be one or multiple among {(2,2), (4,3), (7,3)}. This UE capability is optionally supported by the UE, and whether or not this UE capability is supported and the above-mentioned combination of (X,Y) are explicitly reported to the base station.

TABLE 13

| | Feature | | Field name in |
|---|---|---|---|
| Index | group | Components | TS 38.331 [2] |
| 3-5 | For type 1 | For type 1 CSS with dedicated RRC | pdcch- |
| | CSS with | configuration, type 3 CSS, and UE-SS, | MonitoringAnyOccasions |
| | dedicated RRC | monitoring occasion can be any OFDM | {3-5. withoutDCI-Gap |
| | configuration, | symbol(s) of a slot for Case 2 | 3-5a. withDCI-Gap} |
| | type 3 CSS, | | |
| | and UE-SS, | | |
| | monitoring | | |
| | occasion can | | |
| | be any OFDM | | |
| | symbol(s) of | | |
| | a slot for | | |
| | Case 2 | | |
| 3-5a | For type 1 | For type 1 CSS with dedicated RRC | |
| | CSS with | configuration, type 3 CSS and UE-SS, | |
| | dedicated RRC | monitoring occasion can be any OFDM | |
| | configuration, | symbol(s) of a slot for Case 2, with | |
| | type 3 CSS, | minimum time separation (including the | |
| | and UE-SS, | cross-slot boundary case) between two | |
| | monitoring | DL unicast DCIs, between two UL | |
| | occasion can | unicast DCIs, or between a DL and an | |
| | be any OFDM | UL unicast DCI in different monitoring | |
| | symbol(s) of | occasions where at least one of them is | |
| | a slot for | not the monitoring occasions of FG-3-1, | |
| | Case 2 with a | for a same UE as | |
| | DCI gap | 2OFDM symbols for 15 kHz | |
| | | 4OFDM symbols for 30 kHz | |
| | | 7OFDM symbols for 60 kHz with | |
| | | NCP | |
| | | 11OFDM symbols for 120 kHz | |
| | | Up to one unicast DL DCI and up to one | |
| | | unicast UL DCI in a monitoring occasion | |
| | | except for the monitoring occasions of | |
| | | FG 3-1. | |
| | | In addition for TDD the minimum | |
| | | separation between the first two UL | |
| | | unicast DCIs within the first 3 OFDM | |
| | | symbols of a slot can be zero OFDM | |
| | | symbols. | |
| 3-5b | All PDCCH | PDCCH monitoring occasions of FG-3- | |
| | monitoring | 1, plus additional PDCCH monitoring | |
| | occasion can | occasion(s) can be any OFDM symbol(s) | |
| | be any OFDM | of a slot for Case 2, and for any two | |
| | symbol(s) of | PDCCH monitoring occasions belonging | |
| | a slot for | to different spans, where at least one of | |
| | Case 2 with a | them is not the monitoring occasions of | |
| | span gap | FG-3-1, in same or different search | |
| | | spaces, there is a minimum time | |
| | | separation of X OFDM symbols | |
| | | (including the cross-slot boundary case) | |
| | | between the start of two spans, where | |
| | | each span is of length up to Y | |
| | | consecutive OFDM symbols of a slot. | |
| | | Spans do not overlap. Every span is | |
| | | contained in a single slot. The same span | |
| | | pattern repeats in every slot. The | |
| | | separation between consecutive spans | |
| | | within and across slots may be unequal | |
| | | but the same (X, Y) limit must be | |
| | | satisfied by all spans. Every monitoring | |
| | | occasion is fully contained in one span. | |
| | | In order to determine a suitable span | |
| | | pattern, first a bitmap b(l), 0 <= l <= 13 is | |
| | | generated, where b(l) = 1 if symbol l of | |
| | | any slot is part of a monitoring occasion, | |
| | | b(l) = 0 otherwise. The first span in the | |
| | | span pattern begins at the smallest l for | |
| | | which b(l) = 1. The next span in the span | |
| | | pattern begins at the smallest l not | |
| | | included in the previous span(s) for | |
| | | which b(l) = 1. The span duration is | |
| | | max{maximum value of all CORESET | |
| | | durations, minimum value of Y in the UE | |
| | | reported candidate value} except | |
| | | possibly the last span in a slot which can | |
| | | be of shorter duration. A particular | |
| | | PDCCH monitoring configuration meets | |
| | | the UE capability limitation if the span | |
| | | arrangement satisfies the gap separation | |
| | | for at least one (X, Y) in the UE reported | |
| | | candidate value set in every slot, | |
| | | including cross slot boundary. | |
| | | For the set of monitoring occasions | |
| | | which are within the same span: | |
| | | Processing one unicast DCI | |
| | | scheduling DL and one unicast DCI | |
| | | scheduling UL per scheduled CC across | |
| | | this set of monitoring occasions for FDD | |
| | | Processing one unicast DCI | |
| | | scheduling DL and two unicast DCI | |
| | | scheduling UL per scheduled CC across | |
| | | this set of monitoring occasions for TDD | |
| | | Processing two unicast DCI | |
| | | scheduling DL and one unicast DCI | |
| | | scheduling UL per scheduled CC across | |
| | | this set of monitoring occasions for TDD | |
| | | The number of different start symbol | |
| | | indices of spans for all PDCCH | |
| | | monitoring occasions per slot, including | |
| | | PDCCH monitoring occasions of FG-3- | |
| | | 1, is no more than floor(14/X) (X is | |
| | | minimum among values reported by UE). | |
| | | The number of different start symbol | |
| | | indices of PDCCH monitoring occasions | |
| | | per slot including PDCCH monitoring | |
| | | occasions of FG-3-1, is no more than 7. | |
| | | The number of different start symbol | |
| | | indices of PDCCH monitoring occasions | |
| | | per half-slot including PDCCH | |
| | | monitoring occasions of FG-3-1 is no | |
| | | more than 4 in SCell. | |

The UE may report whether the above-described capability 2 and/or capability 3 are supported and relevant parameters to the base station. The base station may allocate time-domain resources to the common search space and the UE-specific search space, based on the UE capability report. During the resource allocation, the base station may ensure that the MO is not positioned not at a location at which the UE cannot monitor the same.

### [QCL, TCI State]

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a quasi-co-location (QCL) configuration as in Table 14 below. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 14 below.

TABLE 14

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 15 below. Referring to Table 15, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state may include the serving cell index and the BWP index of the reference RS indicated by the corresponding QCL information, the type and ID of the reference BS, and a QCL type as in Table 14 above.

TABLE 15

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first refernece RS of RS (target RS) referring to
corresponding TCI state ID)

| | | |
|---|---|---|
| qcl-Type2 | QCL-Info | OPTIONAL, -- Need R |

```
  (QCL information of second refernece RS of RS (target RS) referring to
corresponding TCI state ID)
  ...
}
```

| | | |
|---|---|---|
| QCL-Info ::= | SEQUENCE { | |
| cell | ServCellIndex | OPTIONAL, -- Need R |

(serving cell index of reference RS indicated by corresponding QCL
information)

| | | |
|---|---|---|
| bwp-Id | BWP-Id | OPTIONAL, -- Cond CSI-RS- |

Indicated
(BWP index of reference RS indicated by corresponding QCL information)

| | |
|---|---|
| referenceSignal | CHOICE { |
| csi-rs | NZP-CSI-RS-ResourceId, |
| ssb | SSB-Index |

```
    (one of CSI-RS ID or SSB ID indicated by corresponding QCL information)
  },
```

| | |
|---|---|
| qcl-Type | ENUMERATED {typeA, typeB, typeC, typeD}, |

...
}

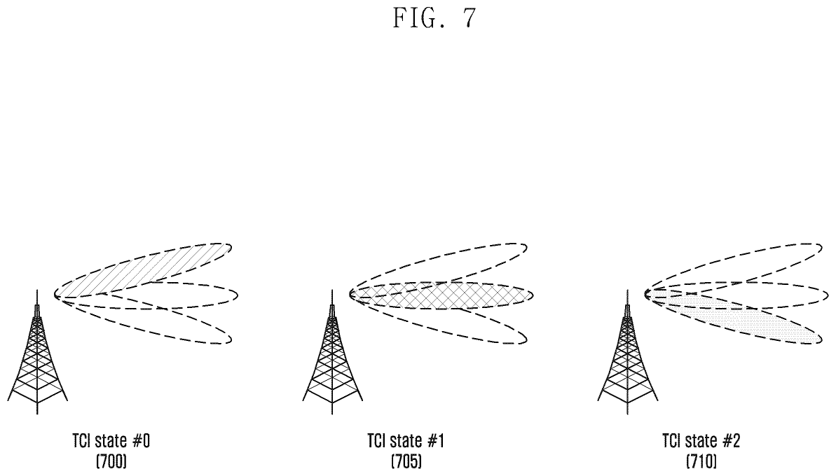

FIG. 7 illustrates an example of base station beam allocation according to a TCI state configuration in a wireless communication system according to an embodiment of the disclosure. FIG. 7 illustrates an example of base station beam allocation according to a TCI state configuration.

Referring to FIG. 7, the base station may transfer information regarding N different beams to the UE through N different TCI states. For example, in the case of N=3 as in FIG. 7, the base station may configure qcl-Type2 parameters included in three TCI states 700, 705, and 710 in QCL type D while being associated with CSI-RSs or SSBs corresponding to different beams, thereby notifying that antenna ports referring to the different TCI states 700, 705, and 710 are associated with different spatial Rx parameters (that is, different beams).

Tables 16 to 20 below enumerate valid TCI state configurations according to the target antenna port type.

Table 16 enumerates valid T state configurations when the target antenna port is a CSI-RS for tracking (TRS). The TRS refers to a non-zero power CSI-RS (NZP CSI-RS) which has no repetition parameter configured therefor, and trs-Info of which is configured as “true”, among CRI-RSs. In Table 16, configuration no. 3 may be used for an aperiodic TRS.

TABLE 16
Valid TCI state configurations when the target
antenna port is a CSI-RS for tracking (TRS)

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | SSB | QCL- | SSB | QCL-TypeD |
| | | TypeC | | |
| 2 | SSB | QCL- | CSI-RS (BM) | QCL-TypeD |
| | | TypeC | | |
| 3 | TRS | QCL- | TRS (same as | QCL-TypeD |
| | (periodic) | TypeA | DL RS 1) | |

Table 17 enumerates valid TCI state configurations when the target antenna port is a CSI-RS for CSI. The CSI-RS for CSI refers to an NZP CSI-RS which has no parameter indicating repetition (e.g., repetition parameter) configured therefor, and trs-Info of which is not configured as “true”, among CRI-RSs.

TABLE 17
Valid TCI state configurations when the
target antenna port is a CSI-RS for CSI

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | TRS | QCL- | SSB | QCL-TypeD |
| | | TypeA | | |
| 2 | TRS | QCL- | CSI-RS for BM | QCL-TypeD |
| | | TypeA | | |
| 3 | TRS | QCL- | TRS (same as | QCL-TypeD |
| | | TypeA | DL RS 1) | |
| 4 | TRS | QCL- | | |
| | | TypeB | | |

Table 18 enumerates valid T state configurations when the target antenna port is a CSI-RS for beam management (BM) (which has the same meaning as CSI-RS for L1 RSRP reporting). The CSI-RS for BM refers to an NZP CSI-RS which has a repetition parameter configured to have a value of “on” or “off”, and trs-Info of which is not configured as “true”, among CRI-RSs.

TABLE 18
Valid TCI state configurations when the target antenna
port is a CSI-RS for BM (for L1 RSRP reporting)

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | TRS | QCL- | TRS (same as | QCL-TypeD |
| | | TypeA | DL RS 1) | |
| 2 | TRS | QCL- | CSI-RS (BM) | QCL-TypeD |
| | | TypeA | | |
| 3 | SS/PBCH | QCL- | SS/PBCH | QCL-TypeD |
| | Block | TypeC | Block | |

Table 19 enumerates valid TCI state configurations when the target antenna port is a PDCCH DMRS.

TABLE 19
Valid TCI state configurations when the
target antenna port is a PDCCH DMRS

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | TRS | QCL- | TRS (same as | QCL-TypeD |
| | | TypeA | DL RS 1) | |
| 2 | TRS | QCL- | CSI-RS (BM) | QCL-TypeD |
| | | TypeA | | |
| 3 | CSI-RS | QCL- | CSI-RS (same | QCL-TypeD |
| | (CSI) | TypeA | as DL RS 1) | |

Table 20 enumerates valid TCI state configurations when the target antenna port is a PDSCH DMRS.

TABLE 20
Valid TCI state configurations when the
target antenna port is a PDSCH DMRS

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS | QCL- | CSI-RS (CSI) | QCL-TypeD |
| | (CSI) | TypeA | | |

According to a representative QCL configuration method based on Tables 16 to 20 above, the target antenna port and reference antenna port for each operation are configured and operated such as “SSB”->“TRS”->“CSI-RS for CSI, or CSI-RS for BM, or PDCCH DMRS, or PDSCH DMRS”. Accordingly, it is possible to help the UE's receiving operation by associating statistical characteristics that can be measured from the SSB and TRS with respective antenna ports.

### [PDCCH: Regarding TCI State]

Specific TCI state combinations applicable to a PDCCH DMRS antenna port may be given in Table 21 below. The fourth row in Table 21 corresponds to a combination assumed by the UE before RRC configuration, and no configuration is possible after the RRC.

TABLE 21

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS | QCL- | | |
| | (CSI) | TypeA | | |
| 4 | SS/PBCH | QCL- | SS/PBCH | QCL-TypeD |
| | Block | TypeA | Block | |

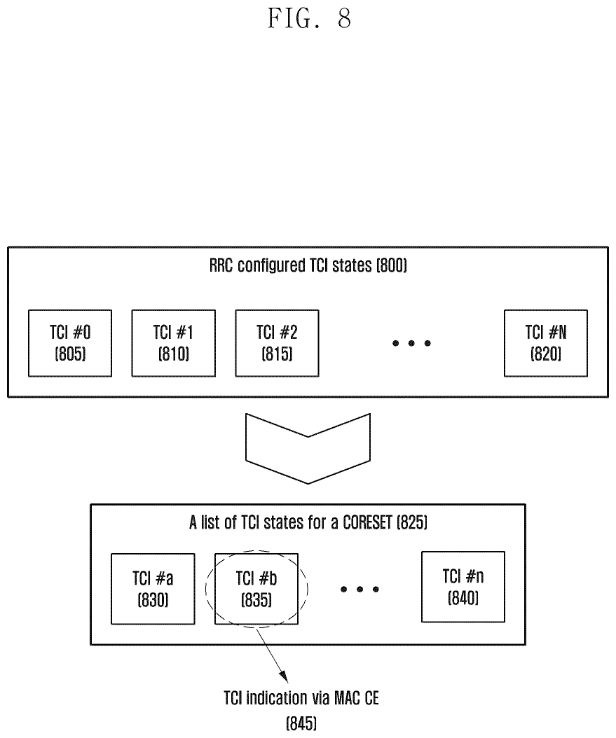

FIG. 8 illustrates an example of a method for allocating a TCI state to a PDCCH in a wireless communication system according to an embodiment of the disclosure.

Referring to FIG. 8, in NR, a hierarchical signaling method as illustrated in FIG. 8 is supported for dynamic allocation regarding a PDCCH beam. Referring to FIG. 8, the base station may configure N TCI states 805, 810, . . . , 820 for the UE through RRC signaling 800, and may configure some of the states as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

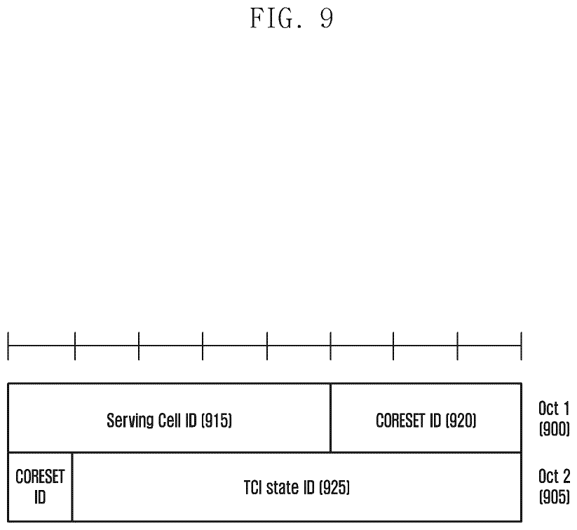

FIG. 9 illustrates a TCI indication MAC CE signaling structure for a PDCCH DMRS in a wireless communication system according to an embodiment of the disclosure. FIG. 9 illustrates a TCI indication MAC CE signaling structure for the PDCCH DMRS.

Referring to FIG. 9, the TCI indication MAC CE signaling for the PDCCH DMRS may be configured by 2 bytes (16 bits), and include a 5-bit serving cell ID 915, a 4-bit CORESET ID 920, and a 7-bit TCI state ID 925.

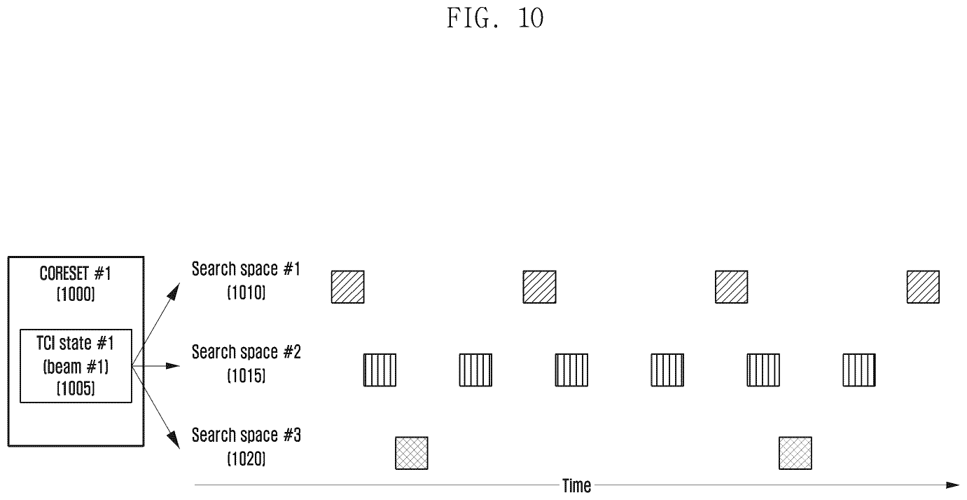

FIG. 10 illustrates an example of a beam configuration with regard to a control resource set and a search space in a wireless communication system according to an embodiment of the disclosure. FIG. 10 illustrates an example of a beam configuration with regard to a control resource set (CORESET) and a search space according to the above description.

Referring to FIG. 10, the base station may indicate one of TCI state lists included in CORESET 1000 configuration through MAC CE signaling (1005). Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. Based on the activation command regarding the TCI state received through the MAC CE, the UE may correctly receive the DMRS of the corresponding CORESET, based on QCL information in the activated TCI state.

With regard to a CORESET having a configured index of 0 (CORESET #0), if the UE has failed to receive a MAC CE activation command regarding the TCI state of CORESET #0, the UE may assume that the DMRS transmitted in CORESET #0 has been QCL-ed with a SS/PBCH block identified in the initial access process, or in a non-contention-based random access process not triggered by a PDCCH command.

With regard to a CORESET having a configured index value other than 0 (CORESET #X), if the UE has no TCI state configured regarding CORESET #X, or if the UE has one or more TCI states configured therefor but has failed to receive a MAC CE activation command for activating one thereof, the UE may assume that the DMRS transmitted in CORESET #X has been QCL-ed with a SS/PBCH block identified in the initial access process.

### [PDCCH: Regarding QCL Prioritization Rule]

Hereinafter, operations for determining QCL priority regarding a PDCCH will be described in detail.

If multiple control resource sets which operate according to carrier aggregation inside a single cell or band and which exist inside a single or multiple in-cell activated bandwidth parts overlap temporally while having identical or different QCL-TypeD characteristics in a specific PDCCH monitoring occasion, the UE may select a specific control resource set according to a QCL priority determining operation and may monitor control resource sets having the same QCL-TypeD characteristics as the corresponding control resource set. That is, if multiple control resource sets overlap temporally, only one QCL-TypeD characteristic can be received. The QCL priority may be determined by the following criteria.
Criterion 1. A control resource set connected to a common search space having the lowest index inside a cell corresponding to the lowest index among cells including a common search space
Criterion 2. A control resource set connected to a UE-specific search space having the lowest index inside a cell corresponding to the lowest index among cells including a UE-specific search space

As described above, if one criterion among the criteria is not satisfied, the next criterion may be applied. For example, if control resource sets overlap temporally in a specific PDCCH monitoring occasion, and if all control resource sets are not connected to a common search space but connected to a UE-specific search space (e.g., if criterion 1 is not satisfied), the UE may omit application of criterion 1 and apply criterion 2.

If selecting control resource set according to the above-mentioned criteria, the UE may additionally consider the two aspects with regard to QCL information configured for the control resource set. Firstly, if control resource set 1 has CSI-RS 1 as a reference signal having a relation of QCL-TypeD, if this CSI-RS 1 has a relation of QCL-TypeD with reference signal SSB 1, and if another control resource set 2 has a relation of QCL-TypeD with reference signal SSB 1, the UE may consider that the two control resource sets 1 and 2 have different QCL-TypeD characteristics. Secondly, if control resource set 1 has CSI-RS 1 configured for cell 1 as a reference signal having a relation of QCL-TypeD, if this CSI-RS 1 has a relation of QCL-TypeD with reference signal SSB 1, if control resource set 2 has a relation of QCL-TypeD with reference signal CSI-RS 2 configured for cell 2, and if this CSI-RS 2 has a relation of QCL-TypeD with the same reference signal SSB 1, the UE may consider that the two control resource sets have the same QCL-TypeD characteristics.

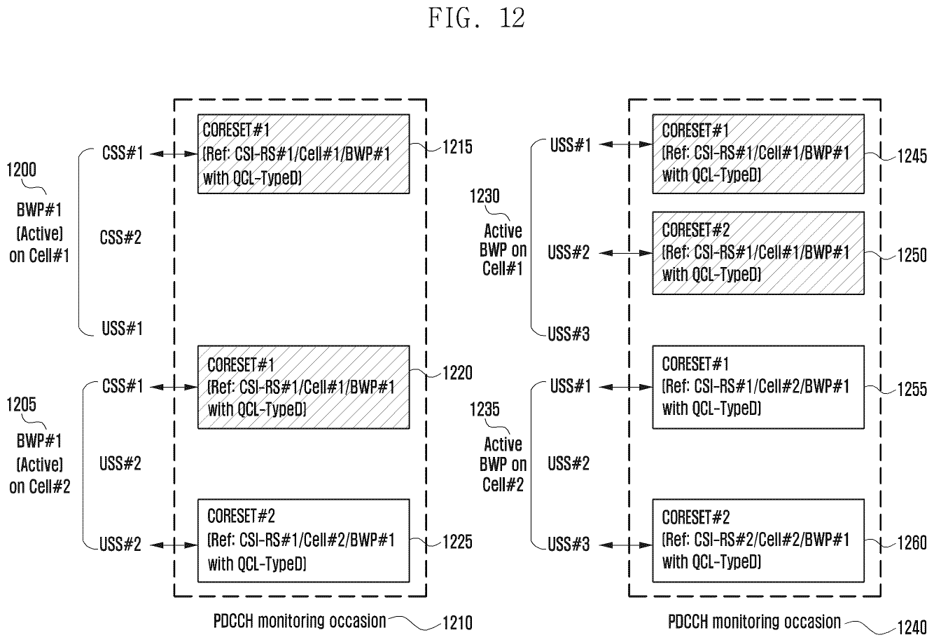

FIG. 12 illustrates a method in which, upon receiving a downlink control channel, a UE selects a receivable control resource set in consideration of priority in a wireless communication system according to an embodiment of the disclosure.

Referring to FIG. 12, the UE may be configured to receive multiple control resource sets overlapping temporally in a specific PDCCH monitoring occasion 1210, and such multiple control resource sets may be connected to a common search space or a UE-specific search space with regard to multiple cells. In the corresponding PDCCH monitoring occasion, control resource set no. 1 1200 connected to common search space no. 1 may exist in bandwidth part no. 1 1215 of cell no. 1, and control resource set no. 1 1205 connected to common search space no. 1 and control resource set no. 2 1220 connected to UE-specific search space no. 2 may exist in bandwidth part no. 1 1225 of cell no. 2. The control resource sets 1215 and 1220 may have a relation of QCL-TypeD with CSI-RS resource no. 1 configured in bandwidth part no. 1 of cell no. 1, and the control resource set 1225 may have a relation of QCL-TypeD with CSI-RS resource no. 1 configured in bandwidth part no. 1 of cell no. 2. If criterion 1 is applied to the corresponding PDCCH monitoring occasion 1210, all other control resource sets having the same reference signal of QCL-TypeD as control resource set no. 1 1215 may be received. Therefore, the UE may receive the control resource sets 1220 and 1215 in the corresponding PDCCH monitoring occasion 1210.

As another example, the UE may be configured to receive multiple control resource sets overlapping temporally in a specific PDCCH monitoring occasion 1240, and such multiple control resource sets may be connected to a common search space or a UE-specific search space with regard to multiple cells. In the corresponding PDCCH monitoring occasion, control resource set no. 1 1230 connected to UE-specific search space no. 1 and control resource set no. 2 1245 connected to UE-specific search space no. 2 may exist in bandwidth part no. 1 1230 of cell no. 1, and control resource set no. 1 1235 connected to UE-specific search space no. 1 and control resource set no. 2 1255 connected to UE-specific search space no. 3 may exist in bandwidth part no. 1 1230 of cell no. 2. The control resource sets 1245 and 1250 may have a relation of QCL-TypeD with CSI-RS resource no. 1 configured in bandwidth part no. 1 of cell no. 1, the control resource set 1255 may have a relation of QCL-TypeD with CSI-RS resource no. 1 configured in bandwidth part no. 1 of cell no. 2, and the control resource set 1260 may have a relation of QCL-TypeD with CSI-RS resource no. 2 configured in bandwidth part no. 1 of cell no. 2. If criterion 1 is applied to the corresponding PDCCH monitoring occasion 1240, there is no common search space, and the next criterion, that is, criterion 2, may thus be applied. If criterion 2 is applied to the corresponding PDCCH monitoring occasion 1240, all other control resource sets having the same reference signal of QCL-TypeD as control resource set no. 1 1245 may be received. Therefore, the UE may receive the control resource sets 1250 and 1245 in the corresponding PDCCH monitoring occasion 1240.

### [Regarding Rate Matching/Puncturing]

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching Operation

The base station may transmit channel A after mapping the same only to remaining resource domains other than resource C (area overlapping resource B) among the entire resource A which is to be used to transmit symbol sequence A to the UE. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3}(corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A based on an assumption that symbol sequence A has been mapped and transmitted in the remaining area other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3}(corresponding to resource C) among resource A. Consequently, the UE may perform a series of following receiving operations based on an assumption that symbol sequence {symbol #1, symbol #2, symbol #4} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3}(corresponding to resource C) is not transmitted, and based on the assumption that symbol sequence {symbol #1, symbol #2, symbol #4} corresponding to remaining resources {resource #1, resource #2, resource #4} other than {resource #3}(corresponding to resource C) among resource A has been mapped and transmitted, the UE may receive the same. Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining region other than resource C among the resource region A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3}(corresponding to resource C) is not transmitted, and based on the assumption that symbol sequence {symbol #1, symbol #2, symbol #4} corresponding to remaining resources {resource #1, resource #2, resource #4} other than {resource #3}(corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring a rate matching resource for the purpose of rate matching in a 5G communication system will be described. Rate matching refers to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

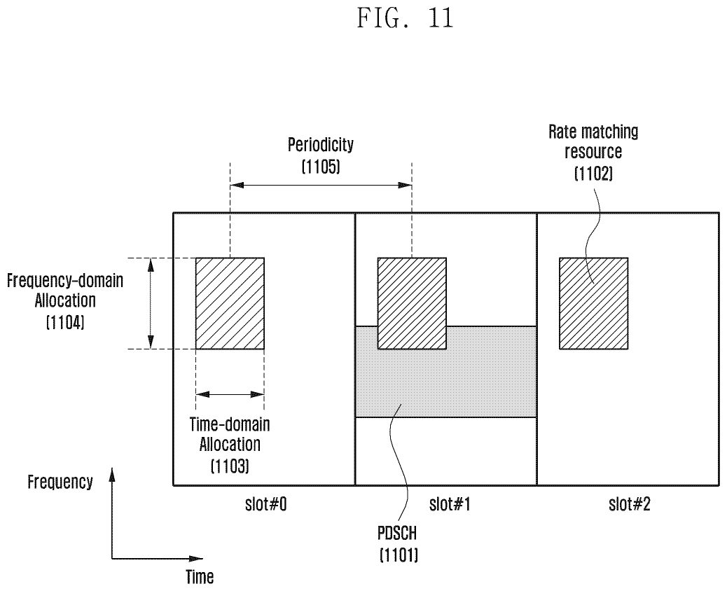

FIG. 11 illustrates a method in which a base station and a UE transmit/receive data in consideration of a downlink data channel and a rate matching resource in a wireless communication system according to an embodiment of the disclosure.

Referring to FIG. 11, a downlink data channel (PDSCH) 1101 and a rate matching resource 1102 is illustrated. The base station may configure one or multiple rate matching resources 1102 for the UE through higher layer signaling (e.g., RRC signaling). Rate matching resource 1102 configuration information may include time-domain resource allocation information 1103, frequency-domain resource allocation information 1104, and periodicity information 1105. A bitmap corresponding to the frequency-domain resource allocation information 1104 will hereinafter be referred to as “first bitmap”, a bitmap corresponding to the time-domain resource allocation information 1103 will be referred to as “second bitmap”, and a bitmap corresponding to the periodicity information 1105 will be referred to as “third bitmap”. If all or some of time and frequency resources of the scheduled PDSCH 1101 overlap a configured rate matching resource 1102, the base station may rate-match and transmit the PDSCH 1101 in a rate matching resource 1102 part, and the UE may perform reception and decoding after assuming that the PDSCH 1101 has been rate-matched in a rate matching resource 1102 part.

The base station may dynamically notify the UE, through DCI, of whether the PDSCH will be rate-matched in the configured rate matching resource part through an additional configuration (e.g., corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

The UE may have a maximum of four RateMatchPatterns configured per each bandwidth part through higher layer signaling, and one RateMatchPattern may include the following contents.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattern) may be additionally configured wherein time and frequency domains including respective RB-level and symbol-level bitmap pairs are repeated.
may include a resource area corresponding to a time domain pattern configured by time and frequency domain resource areas configured by a CORESET inside a bandwidth part and a search space configuration in which corresponding resource areas are repeated.

### RE Level

The UE may have the following contents configured through higher layer signaling.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (e.g., reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### [Regarding LTE CRS Rate Match]

Next, a rate matching process regarding the above-mentioned LTE CRS will be described in detail. In NR, for coexistence between long term evolution (LTE) and new RAT (NR) (LTE-NR coexistence), the pattern of cell-specific reference signal (CRS) of LTE may be configured for an NR UE. More specifically, the CRS pattern may be provided by RRC signaling including at least one parameter inside ServingCellConfig IE (information element) or ServingCellConfigCommon IE. Examples of the parameter may include lte-CRS-ToMatchAround, lte-CRS-PatternList1-r16, lte-CRS-PatternList2-r16, crs-RateMatch-PerCORESETPoolIndex-r16, and the like.

Rel-15 NR provides a function by which one CRS pattern can be configured per serving cell through parameter lte-CRS-ToMatchAround. In Rel-16 NR, the above function has been expanded such that multiple CRS patterns can be configured per serving cell. More specifically, a UE having a single-TRP (transmission and reception point) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16. As another example, the UE having a multi-TRP configuration may have a CRS configured for each TRP. That is, the CRS pattern regarding TRP1 may be configured through parameter lte-CRS-PatternList1-r16, and the CRS pattern regarding TRP2 may be configured through parameter lte-CRS-PatternList2-r16. If two TRPs are configured as above, whether the CRS patterns of TRP1 and TRP2 are both to be applied to a specific physical downlink shared channel (PDSCH) or only the CRS pattern regarding one TRP is to be applied is determined through parameter crs-RateMatch-PerCORESETPoolIndex-r16, wherein if parameter crs-RateMatch-PerCORESETPoolIndex-r16 is configured “enabled”, only the CRS pattern of one TRP is applied, and both CRS patterns of the two TRPs are applied in other cases.

Table 22 shows a ServingCellConfig IE including the CRS patterns, and Table 23 shows a RateMatchPatternLTE-CRS IE including at least one parameter regarding CRS patterns.

TABLE 22

| | |
|---|---|
| ServingCellConfig ::= | SEQUENCE { |

| | |
|---|---|
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF BWP- |

| | |
|---|---|
| Id | OPTIONAL, -- Need N |

| | |
|---|---|
| downlinkBWP-ToAddModList | SEQUENCE (SIZE (1..maxNrofBWPs)) OF |

| | |
|---|---|
| BWP-Downlink | OPTIONAL, -- Need N |

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, ms5, ms6, ms8, ms10, |

ms20, ms30,

ms40,ms50, ms60, ms80,ms100, ms200,ms300, ms500,
ms750, ms1280, ms1920, ms2560, spare10, spare9,

spare8,

spare7, spare6, spare5, spare4, spare3, spare2, spare1 }

OPTIONAL, -- Need R

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH-ServingCellConfig } |

OPTIONAL, -- Need M

| | |
|---|---|
| pdsch-ServingCellConfig | SetupRelease { PDSCH-ServingCellConfig } |

OPTIONAL, -- Need M

| | |
|---|---|
| csi-MeasConfig | SetupRelease { CSI-MeasConfig } |

OPTIONAL, -- Need M

| | |
|---|---|
| sCellDeactivationTimer | ENUMERATED {ms20, ms40, ms80, ms160, ms200, |

ms240,

| ms320, ms400, ms480, ms520, ms640, ms720, | |
|---|---|
| ms840, ms1280, spare2, spare1} | OPTIONAL, -- Cond |

ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |

| | |
|---|---|
| dummy | ENUMERATED {enabled} |

OPTIONAL, -- Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

```
OPTIONAL, -- Cond MeasObject
  ...,
  [[
```

| | |
|---|---|
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE |
| (1..maxNrofRateMatchPatterns)) OF RateMatchPattern | OPTIONAL, -- Need N |
| rateMatchPatternToReleaseList | SEQUENCE (SIZE |
| (1..maxNrofRateMatchPatterns)) OF RateMatchPatternId | OPTIONAL, -- Need N |
| downlinkChannelBW-PerSCS-List | SEQUENCE (SIZE (1..maxSCSs)) OF SCS- |

| | |
|---|---|
| SpecificCarrier | OPTIONAL -- Need S |

```
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL-DL-ConfigDedicated- |

| | |
|---|---|
| IAB-MT-r16 | OPTIONAL, -- Cond TDD_IAB |

| | |
|---|---|
| dormantBWP-Config-r16 | SetupRelease { DormantBWP-Config-r16 } |

OPTIONAL, -- Need M

| | |
|---|---|
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

| | |
|---|---|
| } | OPTIONAL, -- |

Cond AsyncCA

| | |
|---|---|
| channelAccessConfig-r16 | SetupRelease { ChannelAccessConfig-r16 } |

OPTIONAL, -- Need M

| | |
|---|---|
| intraCellGuardBandsDL-List-r16 | SEQUENCE (SIZE (1..maxSCSs)) OF |

| | |
|---|---|
| IntraCellGuardBandsPerSCS-r16 | OPTIONAL, -- Need S |

| | |
|---|---|
| intraCellGuardBandsUL-List-r16 | SEQUENCE (SIZE (1..maxSCSs)) OF |

| | |
|---|---|
| IntraCellGuardBandsPerSCS-r16 | OPTIONAL, -- Need S |

| | |
|---|---|
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS-PatternList-r16 } |

OPTIONAL, -- Need M

| | |
|---|---|
| lte-CRS-PatternList2-r16 | SetupRelease { LTE-CRS-PatternList-r16 } |

OPTIONAL, -- Need M

| | |
|---|---|
| crs-RateMatch-PerCORESETPoolIndex-r16 | ENUMERATED {enabled} |

OPTIONAL, -- Need R

| | |
|---|---|
| enableTwoDefaultTCI-States-r16 | ENUMERATED {enabled} |

OPTIONAL, -- Need R

| | |
|---|---|
| enableDefaultTCI-StatePerCoresetPoolIndex-r16 | ENUMERATED {enabled} |

OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

```
TABLE 23
    - RateMatchPatternLTE-CRS
The IE RateMatchPatternLTE-CRS is used to configure a pattern to rate match around LTE
CRS. See TS 38.214 [19], clause 5.1.4.2.
      RateMatchPatternLTE-CRS information element
-- ASN1START
-- TAG-RATEMATCHPATTERNLTE-CRS-START
```

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, n100, spare2, |

spare 1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) OF |

RateMatchPatternLTE-CRS
-- TAG-RATEMATCHPATTERNLTE-CRS-STOP
-- ASN1STOP
RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause
5.1.4.2).
v-Shift
Shifting value v-shift in LTE to rate match around LTE CRS (see TS 38.214 [19], clause
5.1.4.2).

### [PDSCH: Processing Time]

Next, a PDSCH processing time (PDSCH processing procedure time) will be described. If the base station schedules the UE to transmit a PDSCH by using DCI format 1_0, 1_1 or 1_2, the UE may need a PDSCH processing time for receiving a PDSCH by applying a transmission method (modulation/demodulation and coding indication index (MCS), demodulation reference signal-related information, time and frequency resource allocation information, and the like) indicated through DCI. The PUSCH preparation procedure time is defined in NR in consideration thereof. The PUSCH processing time of the UE may follow Equation 2 given below.

$${T}_{proc , 1} = ( {N}_{1} + {d}_{1 , 1} + {d}_{2} ) ( 2048 + 1 \; 44 ) {κ2}^{- μ} {T}_{c} + {T}_{ext} \qquad Equation 2$$

Each parameter in T_{proc,1} described above in Equation 3 may have the following meaning.
N₁: the number of symbols determined according to UE processing capability 1 or 2 based on the UE's capability and numerology μ. N₁ may have a value in Table 24-1 if UE processing capability 1 is reported according to the UE's capability report, and may have a value in Table 24-2 if UE processing capability 2 is reported, and if availability of UE processing capability 2 is configured through higher layer signaling. The numerology p may correspond to the minimum value among μ_{PDCCH}, PDSCH, μ_{UL} so as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an uplink channel in which a HARQ-ACK is to be transmitted.

TABLE 24-1
PDSCH processing time in the case of PDSCH processing capability 1

PDSCH decoding time N₁ [symbols]

| | | If PDSCH mapping type A and B |
|---|---|---|
| | If PDSCH mapping type A and B | both do not correspond to dmrs- |
| | both correspond to dmrs- | AdditionalPosition = pos0 inside |
| | AdditionalPosition = pos0 inside | DMRS-DownlinkConfig which is |
| | DMRS-DownlinkConfig which is | higher layer signaling, or if no |
| μ | higher layer signaling | upper layer parameter is configured |
| 0 | 8 | N_{1,0} |
| 1 | 10 | 13 |
| 2 | 17 | 20 |
| 3 | 20 | 24 |

TABLE 24-2
PDSCH processing time in the case
of PDSCH processing capability 2

| | PDSCH decoding time N₁ [symbols] |
|---|---|
| | If PDSCH mapping type A and B both correspond to dmrs- |
| | AdditionalPosition = pos0 inside DMRS-DownlinkConfig which is |
| μ | higher layer signaling |
| 0 | 3 |
| 1 | 4.5 |
| 2 | 9 for frequency range 1 |

κ: 64
Tₑₓₜ: if the UE uses a shared spectrum channel access scheme, the UE may calculate Tₑₓₜ and apply the same to the PDSCH processing time. Otherwise, Tₑₓₜ is assumed to be 0.
If l₁ which represents the PDSCH DMRS location value is 12, N_{1,0} in table 22 above has the value of 14, and otherwise has the value of 13.

With regard to PDSCH mapping type A, if the last symbol of the PDSCH is the i^{th} symbol in the slot in which the PDSCH is transmitted, and if i<7, d_{1,1} is then 7-i, and d_{1,1} is otherwise 0.
d₂: if a PUCCH having a high priority index temporally overlaps another PUCCH or a PUSCH having a low priority index, d₂ of the PUCCH having a high priority index may be configured as a value reported from the UE. Otherwise, d₂ is 0.

If PDSCH mapping type B is used with regard to UE processing capability 1, the d_{1,1} value may be determined by the number (L) of symbols of a scheduled PDSCH and the number of overlapping symbols between the PDCCH that schedules the PDSCH and the scheduled PDSCH, as follows.
If L≥7, then d_{1,1}=0.
If—L≥4 and L≤6, then d_{1,1}=7−L.
If L=3, then d_{1,1}j=min (d, 1).
If L=2, then d_{1,1}=3+d.

If PDSCH mapping type B is used with regard to UE processing capability 2, the d_{1,1}j value may be determined by the number (L) of symbols of a scheduled PDSCH and the number of overlapping symbols between the PDCCH that schedules the PDSCH and the scheduled PDSCH, as follows.
If L≥7, then d_{1,1}j=0.
If−L≥4 and L≤6, then d_{1,1}=7−L.
If L=2,
If the scheduling PDCCH exists inside a CORESET including three symbols, and if the CORESET and the scheduled PDSCH have the same start symbol, then d1,1=3.
Otherwise, d_{1,1}j=d.
In the case of a UE supporting capability 2 inside a given serving cell, the PDSCH processing time based on UE processing capability 2 may be applied by the UE if processingType2Enabled (higher layer signaling) is configured as “enable” with regard to the corresponding cell.

If the location of the first uplink transmission symbol of a PUCCH including HARQ-ACK information (in connection with the corresponding location, K₁ defined as the HARQ-ACK transmission timepoint, a PUCCH resource used to transmit the HARQ-ACK, and the timing advance effect may be considered) does not start earlier than the first uplink transmission symbol that comes after the last symbol of the PDSCH over a time of T_{proc,1}, the UE needs to transmit a valid HARQ-ACK message. That is, the UE needs to transmit a PUCCH including a HARQ-ACK only if the PDSCH processing time is sufficient. The UE cannot otherwise provide the base station with valid HARQ-ACK information corresponding to the scheduled PDSCH. The T_{proc,1} may be used in the case of either a normal or an expanded CP. In the case of a PDSCH having two PDSCH transmission locations configured inside one slot, d_{1,1} is calculated with reference to the first PDSCH transmission location inside the corresponding slot.

### [PDSCH: Reception Preparation Time During Cross-Carrier Scheduling]

Next, in the case of cross-carrier scheduling in which the numerology (μ_{PDCCH}) by which a scheduling PDCCH is transmitted and the numerology (μ_{PDSCH}) by which a PDSCH scheduled by the corresponding PDCCH is transmitted are different from each other, the PDSCH reception preparation time (N_{pdsch}) of the UE defined with regard to the time interval between the PDCCH and PDSCH will be described.

If μ_{PDCCH}<μ_{PDSCH}, the scheduled PDSCH cannot be transmitted before the first symbol of the slot coming after N_{pdsch} symbols from the last symbol of the PDCCH that scheduled the corresponding PDSCH. The transmission symbol of the corresponding PDSCH may include a DM-RS.

If μ_{PDCCH}>μ_{PDSCH}, the scheduled PDSCH may be transmitted after N_{pdsch} symbols from the last symbol of the PDCCH that scheduled the corresponding PDSCH. The transmission symbol of the corresponding PDSCH may include a DM-RS.

TABLE 25
Npdsch according to scheduled PDCCH subcarrier spacings

| μ_{PDCCH} | N_{pdsch} [symbols] |
|---|---|
| 0 | 4 |
| 1 | 5 |
| 2 | 10 |
| 3 | 14 |

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set.
srs-ResourceSetld: an SRS resource set index
srs-ResourceldList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive higher layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (e.g., periodicityAndOffset).

The base station may activate or deactivate SRS transmission for the UE through higher layer signaling including RRC signaling or MAC CE signaling, or L1 signaling (e.g., DCI). For example, the base station may activate or deactivate periodic SRS transmission for the UE through higher layer signaling. The base station may indicate activation of an SRS resource set having resourceType configured as “periodic” through higher layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through higher layer signaling.

For example, the base station may activate or deactivate semi-persistent SRS transmission for the UE through higher layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through higher layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “‘beamManagement”, the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 26

| | |
|---|---|
| SRS-Resource ::= | SEQUENCE { |
| srs-ResourceId | , |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

quenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS-PeriodicityAndOffset, |

```
        ...
      },
```

| | |
|---|---|
| periodic | SEQUENCE { |
| periodicityAndOffset-p | SRS-PeriodicityAndOffset, |

```
        ...
      }
  },
```

| | |
|---|---|
| sequenceId | INTEGER (0..1023), |
| spatialRelationInfo | SRS-SpatialRelationInfo |

```
  OPTIONAL, -- Need R
    ...
}
```

Configuration information spatialRelationlnfo in Table 26 above may be applied, with reference to one reference signal, to a beam used for SRS transmission corresponding to beam information of the corresponding reference signal. For example, configuration of spatialRelationlnfo may include information as in Table 27 below.

TABLE 27

| | |
|---|---|
| SRS-SpatialRelationInfo ::= | SEQUENCE { |
| servingCellId | ServCellIndex OPTIONAL, -- |
| | Need S |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the above-described spatialRelationlnfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “‘csi-RS-Index”, the UE may apply the reception beam which was used to receive the CSI-RS corresponding to csi-RS-Index as the transmission beam for the corresponding SRS transmission. If upper signaling referenceSignal has a configured value of “ssb-Index”, the UE may apply the reception beam which was used to receive the SS/PBCH block corresponding to ssb-Index as the transmission beam for the corresponding SRS transmission.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 28 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 28 through upper signaling. If PUSCH transmission is operated by a configured grant, parameters applied to the PUSCH transmission are applied through configuredGrantConfig (upper signaling) in Table 28 except for dataScramblingIdentityPUSCH, txConfig, codebookSubset, maxRank, and scaling of UCI-OnPUSCH, which are provided by pusch-Config (upper signaling) in Table 29. If provided with transformPrecoder inside configuredGrantConfig (upper signaling) in Table 28, the UE applies tp-pi2BPSK inside pusch-Config in Table 29 to PUSCH transmission operated by a configured grant.

TABLE 28

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...
  }
OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 29, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationlnfo. If the UE has no configured txConfig inside pusch-Config in Table 29, the UE does not expect scheduling through DCI format 0_1.

TABLE 29

| | |
|---|---|
| PUSCH-Config ::= | SEQUENCE { |

| | |
|---|---|
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

| | |
|---|---|
| TimeDomainResourceAllocationList } | OPTIONAL, -- Need M |

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M
tp-pi2BPSK

| | |
|---|---|
| OPTIONAL, -- Need S | ENUMERATED {enabled} |

...
}

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent’” as UE capability, the UE does not expect that the value of codebookSubset (upper signaling) will be configured as “fullyAndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 11) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### [PUSCH: Preparation Procedure Time]

Next, a PDSCH processing time (PDSCH processing procedure time) will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation 3 given below.

$$Equation 3$$

$${T}_{proc 2} = max ( ( {N}_{2} + {d}_{2 , 1} + {d}_{2} ) ( 2048 + 1 \; 44 ) {κ2}^{μ} {T}_{c} + {T}_{ext} + {T}_{switch} , {d}_{2 , 2} )$$

Each parameter in T_{proc,2} described above in Equation 3 may have the following meaning.
N₂: the number of symbols determined according to UE processing capability 1 or 2, based on the UE's capability, and numerology p. N₂ may have a value in Table 40 if UE processing capability 1 is reported according to the UE's capability report, and may have a value in Table 41 if UE processing capability 2 is reported, and if availability of UE processing capability 2 is configured through higher layer signaling.

TABLE 30

| μ | PUSCH preparation time N₂ [symbols] |
|---|---|
| 0 | 10 |
| 1 | 12 |
| 2 | 23 |
| 3 | 36 |

TABLE 31

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.

$$- {T}_{c} : has 1 / ( Δ {f}_{max} \cdot {N}_{f} ) , Δ {f}_{max} = 480 \cdot {10}^{3} Hz , {N}_{f} = 4096 ..$$

d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE determine that the PUSCH preparation procedure time is insufficient if the first symbol of a PUSCH starts earlier than the first uplink symbol in which a CP starts after Tproc,2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repetition Transmission]

Hereinafter, repetition transmission of an uplink data channel in a 5G system will be described in detail. A 5G system supports two types of uplink data channel repetition transmission methods, PUSCH repetition type A transmission and PUSCH repetition type B transmission. One of PUSCH repetition type A transmission and PUSCH repetition type B transmission may be configured for a UE through higher layer signaling.

### PUSCH Repetition Type a Transmission

As described above, the symbol length of an uplink data channel and the location of the start symbol may be determined by a time domain resource allocation method in one slot, and a base station may notify a UE of the number of repetition transmissions through higher layer signaling (e.g., RRC signaling) or L1 signaling (e.g., DCI).
Based on the number of repetition transmissions received from the base station, the UE may repetitively transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE omits uplink data channel transmission, but counts the number of repetition transmissions of the uplink data channel.

### PUSCH Repetition Type B Transmission

As described above, the symbol length of an uplink data channel and the location of the start symbol may be determined by a time domain resource allocation method in one slot, and a base station may notify a UE of the number of repetition transmissions through higher layer signaling (e.g., RRC signaling) or L1 signaling (e.g., DCI).
The nominal repetition of the uplink data channel is determined as follows, based on the previously configured start symbol and length of the uplink data channel. The slot in which the n^{th} nominal repetition starts is given by

$${K}_{s} + ⌊ \frac{s + n \cdot L}{{N}_{symb}^{slot}} ⌋ ,$$

and the symbol starting in that slot is given by mod(S+n·L, N_{symb}^{slot}). The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod(S+(n+1)·L−1,N_{symb}^{slot}). In this regard, n=0, . . . , numberofrepetitions-1, S refers to the start symbol of the configured uplink data channel, and L refers to the symbol length of the configured uplink data channel. Kₛ refers to the slot in which PUSCH transmission starts, and N_{symb}^{slot} refers to the number of symbols per slot.
The UE determines an invalid symbol for PUSCH repetition type B transmission. A symbol configured as a downlink by tdd-UL-DL-ConfigurationCommon or tdd-UL-DL-ConfigurationDedicated is determined as the invalid symbol for PUSCH repetition type B transmission. Additionally, the invalid symbol may be configured in an upper layer parameter (e.g., InvalidSymbolPattern). The upper layer parameter (e.g., InvalidSymbolPattern) may provide a symbol level bitmap across one or two slots, thereby configuring the invalid symbol. In the bitmap, 1 represents the invalid symbol. Additionally, the periodicity and pattern of the bitmap may be configured through the upper layer parameter (for example, InvalidSymbolPattern). If an upper layer parameter (e.g., InvalidSymbolPattern) is configured, and if parameter InvalidSymbolPatternIndicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an upper layer parameter (e.g., InvalidSymbolPattern) is configured, and if parameter InvalidSymbolPatternIndicator-ForDCIFormat0_1 or InvalidSymbolPatternIndicator-ForDCIFormat0_2 is not configured, the UE applies the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot.

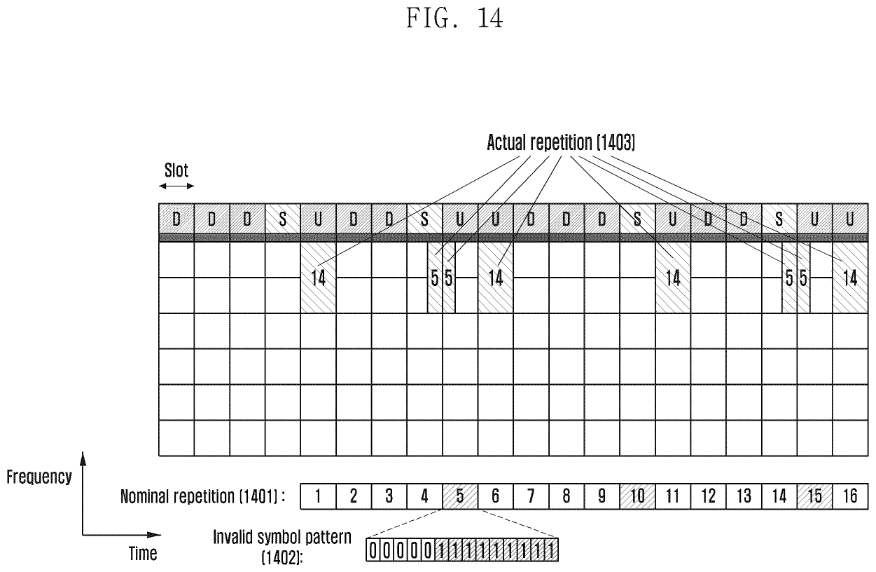

FIG. 14 illustrates an example of PUSCH repetition type B transmission in a wireless communication system according to an embodiment of the disclosure.

Referring to FIG. 14, the UE may receive the following configurations: the start symbol S of an uplink data channel is 0, the length L of the uplink data channel is 14, and the number of repeated transmissions is 16. In this case, nominal repetitions may appear in 16 consecutive slots (1403). Thereafter, the UE may determine that the symbol configured as a downlink symbol in each nominal repetition 1401 is an invalid symbol. The UE determines that symbols configured as 1 in the invalid symbol pattern 1402 are invalid symbols. If valid symbols other than invalid symbols in respective nominal repetitions constitute one or more consecutive symbols in one slot, they are configured and transmitted as actual repetitions (1403).

In addition, with regard to PUSCH repetition transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repetition transmissions are scheduled inside one slot or across the boundary of consecutive slots. In connection with method 1, time domain resource allocation information inside DCI indicates resources of the first repetition transmission. In addition, time domain resource information of remaining repetition transmissions may be determined according to time domain resource information of the first repetition transmission, and the uplink or downlink direction determined with regard to each symbol of each slot. Each repetition transmission occupies consecutive symbols.
Method 2 (multi-segment transmission): through one UL grant, two or more PUSCH repetition transmissions are scheduled in consecutive slots. Transmission no. 1 is designated for each slot, and the start point or repetition length differs between respective transmissions. In method 2, time domain resource allocation information inside DCI indicates the start point and repetition length of all repetition transmissions. In the case of performing repetition transmissions inside a single slot through method 2, if there are multiple bundles of consecutive uplink symbols in the corresponding slot, respective repetition transmissions may be performed with regard to respective uplink symbol bundles. If there is a single bundle of consecutive uplink symbols in the corresponding slot, PUSCH repetition transmission is performed once according to the method of NR Release 15.
Method 3: two or more PUSCH repetition transmissions are scheduled in consecutive slots through two or more UL grants. Transmission no. 1 may be designated with regard to each slot, and the nth UL grant may be received before PUSCH transmission scheduled by the (n−1)th UL grant is over.
Method 4: through one UL grant or one configured grant, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. Time domain resource allocation information inside DCI or configured grant refers to resources of the first repetition transmission indicated by the base station. Time domain resource information of remaining repetition transmissions may be determined with reference to resource information of the first repetition transmission and the uplink or downlink direction of symbols. If time domain resource information of repetition transmission indicated by the base station spans a slot boundary or includes an uplink/downlink switching point, the corresponding repetition transmission may be divided into multiple repeated transmissions. One repetition transmission may be included in one slot with regard to each uplink period.

The above-described repetition transmission may be applied to both a dynamic grant (DG) PUSCH and a configured grant (CG) PUSCH. The DG PUSCH refers to a scheme in which all scheduling information is provided by DCI, and the CG PUSCH refers to a scheme in which PUSCH scheduling information is provided only through an upper signal or partially provided through DCI. In addition, the DG PUSCH corresponds to a scheme in which a UE transmits a PUSCH only in a scheduling region provided by DCI, and the CG PUSCH corresponds to a scheme in which a UE periodically transmits a PUSCH at periodicity configured by an upper signal without separately receiving DCI.

### [PUSCH: Frequency Hopping Process]

Hereinafter, frequency hopping of a physical uplink shared channel (PUSCH) in a 5G system will be described in detail.

5G supports two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported.

The intra-slot frequency hopping method supported in PUSCH repetition type A transmission may include a method in which a UE transmits allocated resources in the frequency domain, after changing the same by a configured frequency offset, by two hops in one slot. The start RB of each hop in connection with intra-slot frequency hopping may be expressed by Equation 4 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad Equation 4$$

In Equation 4, i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by └N_{symb}^{PUSCH,s}/2┘, and number of symbols of the second hop may be represented by N_{symb}^{PUSCH,s}/2−└N_{symb}^{PUSCH,s}/2┘. N_{symb}^{PUSCH,s}/2 is the length of PUSCH transmission in one slot and is expressed by the number of OFDM symbols.

Next, the inter-slot frequency hopping method supported in PUSCH repetition type A and type B transmissions is a method in which the UE transmits allocated resources in the frequency domain, after changing the same by a configured frequency offset, in each slot. The start RB during a slot in connection with inter-slot frequency hopping may be expressed by Equation 5 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad Equation 5$$

In Equation 5, nₛ^{μ} as denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an upper layer parameter.

Next, the inter-repetition frequency hopping method supported in PUSCH repetition type B transmission is a method in which resources allocated in the frequency domain regarding one or multiple actual repetitions in each nominal repetition are moved by a configured frequency offset and then transmitted. The index RBstart(n) of the start RB in the frequency domain regarding one or multiple actual repetitions in the nth nominal repetition may follow Equation 6 given below:

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad Equation 6$$

In Equation 6, n denotes the index of nominal repetition, and RB_{offset} denotes an RB offset between two hops through an upper layer parameter.

### [PUSCH: Multiplexing Rule During AP/SP CSI Reporting]

Hereinafter, a method for channel state measurement and channel state report in a 5G communication system will be described in detail. The channel state information (CSI) may include channel quality information (CQI), precoding matric indicator (PMI), CSI-RS resource indicator (CRI), SS/PBCH block resource indicator (SSBRI), layer indicator (LI), rank indicator (RI), and/or L1-reference signal received power (L1-RSRP). The base station may control time and frequency resources for the above-described UE CSI measurement and report.

For the above-described CSI measurement and report, the UE may be configured with setting information (CSIReportConfig) for N(>1) CSI reports, setting information (CSI-ResourceConfig) for M(>1) RS transmission resources, and one or two trigger state (CSI-AperiodicTriggerStateList and CSI-SemiPersistentOnPUSCH-TriggerStateList) list information through higher layer signaling. Configuration information for the above-described CSI measurement and report may be more specifically described in Table 32 to Table 38.

### Table 32: CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214 [19], clause 5.2.1.

TABLE 32
CSI-ReportConfig information element

-- ASN1START
-- TAG-CSI-REPORTCONFIG-START

| CSI-ReportConfig ::= | SEQUENCE { | | |
|---|---|---|---|
| reportConfigId | CSI-ReportConfigId, | | |
| carrier | ServCellIndex | OPTIONAL, | -- Need S |

| | |
|---|---|
| resourcesForChannelMeasurement | CSI-ResourceConfigId, |

| | | |
|---|---|---|
| csi-IM-ResourcesForInterference | CSI-ResourceConfigId | OPTIONAL, -- Need R |

| | | |
|---|---|---|
| nzp-CSI-RS-ResourcesForInterference | CSI-ResourceConfigId | OPTIONAL, -- |

Need R

| | |
|---|---|
| reportConfigType | CHOICE { |
| periodic | SEQUENCE { |

| | |
|---|---|
| reportSlotConfig | CSI-ReportPeriodicityAndOffset, |

| | |
|---|---|
| pucch-CSI-ResourceList | SEQUENCE (SIZE (1..maxNrofBWPs)) OF |

PUCCH-CSI-Resource
},

| | |
|---|---|
| semiPersistentOnPUCCH | SEQUENCE { |

| | |
|---|---|
| reportSlotConfig | CSI-ReportPeriodicityAndOffset, |

| | |
|---|---|
| pucch-CSI-ResourceList | SEQUENCE (SIZE (1..maxNrofBWPs)) OF |

PUCCH-CSI-Resource
},

| | |
|---|---|
| semiPersistentOnPUSCH | SEQUENCE { |

| | |
|---|---|
| reportSlotConfig | ENUMERATED {sl5, sl10, sl20, sl40, sl80, sl160, |

sl320},

| | |
|---|---|
| reportSlotOffsetList | SEQUENCE (SIZE (1..maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE (1..maxNrofUL-Allocations)) OF |

```
INTEGER(0..32)
    }
  },
```

| | |
|---|---|
| reportQuantity | CHOICE { |
| none | NULL, |

| | |
|---|---|
| cri-RI-PMI-CQI | NULL, |

| | |
|---|---|
| cri-RI-i1 | NULL, |
| cri-RI-i1-CQI | SEQUENCE { |

| | |
|---|---|
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |

| | |
|---|---|
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, Need -- R |

| | |
|---|---|
| timeRestrictionForChannelMeasurements | ENUMERATED {configured, |

notConfigured},

| | |
|---|---|
| timeRestrictionForInterferenceMeasurements | ENUMERATED {configured, |

notConfigured},

| | |
|---|---|
| codebookConfig | CodebookConfig |

OPTIONAL, -- Need R

| | |
|---|---|
| dummy | ENUMERATED {n1, n2} |

OPTIONAL, -- Need R

| | |
|---|---|
| groupBasedBeamReporting | CHOICE { |

| | |
|---|---|
| enabled | NULL, |
| disabled | SEQUENCE { |

| | |
|---|---|
| nrofReportedRS | ENUMERATED {n1, n2, n3, n4} |

```
OPTIONAL -- Need S
    }
  },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |

| | |
|---|---|
| non-PMI-PortIndication | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |

| | |
|---|---|
| reportSlotConfig-v1530 | ENUMERATED {sl4, sl8, sl16} |

| | |
|---|---|
| } | OPTIONAL -- Need R |

```
  ]],
  [[
```

| | |
|---|---|
| semiPersistentOnPUSCH-v1610 | SEQUENCE { |
| reportSlotOffsetListDCI-0-2-r16 | SEQUENCE (SIZE (1..maxNrofUL-Allocations-r16)) |

| | | |
|---|---|---|
| OF INTEGER(0..32) | OPTIONAL, | -- Need R |

| | |
|---|---|
| reportSlotOffsetListDCI-0-1-r16 | SEQUENCE (SIZE (1..maxNrofUL-Allocations-r16)) |

| | | |
|---|---|---|
| OF INTEGER(0..32) | OPTIONAL | -- Need R |

| | |
|---|---|
| } | OPTIONAL, -- Need R |

| | |
|---|---|
| aperiodic-v1610 | SEQUENCE { |

| | |
|---|---|
| reportSlotOffsetListDCI-0-2-r16 | SEQUENCE (SIZE (1..maxNrofUL-Allocations-r16)) |

| | | |
|---|---|---|
| OF INTEGER(0..32) | OPTIONAL, | -- Need R |

| | |
|---|---|
| reportSlotOffsetListDCI-0-1-r16 | SEQUENCE (SIZE (1..maxNrofUL-Allocations-r16)) |

| | | |
|---|---|---|
| OF INTEGER(0..32) | OPTIONAL | -- Need R |

| | |
|---|---|
| } | OPTIONAL, -- Need R |

| | |
|---|---|
| reportQuantity-r16 | CHOICE { |
| cri-SINR-r16 | NULL, |

| | |
|---|---|
| ssb-Index-SINR-r16 | NULL |

| | |
|---|---|
| } | OPTIONAL, -- Need R |

| | |
|---|---|
| codebookConfig-r16 | CodebookConfig-r16 |

OPTIONAL -- Need R
]]
}
CSI-ReportPeriodicityAndOffset ::= CHOICE {

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| PortIndexFor8Ranks ::= | CHOICE { | |
|---|---|---|
| portIndex8 | SEQUENCE{ | |
| rank1-8 | PortIndex8 | OPTIONAL, -- |

Need R

| | |
|---|---|
| rank2-8 | SEQUENCE(SIZE(2)) OF PortIndex8 |

OPTIONAL, -- Need R

| | |
|---|---|
| rank3-8 | SEQUENCE(SIZE(3)) OF PortIndex8 |

OPTIONAL, -- Need R

| | |
|---|---|
| rank4-8 | SEQUENCE(SIZE(4)) OF PortIndex8 |

OPTIONAL, -- Need R

| | |
|---|---|
| rank5-8 | SEQUENCE(SIZE(5)) OF PortIndex8 |

OPTIONAL, -- Need R

| | |
|---|---|
| rank6-8 | SEQUENCE(SIZE(6)) OF PortIndex8 |

OPTIONAL, -- Need R

| | |
|---|---|
| rank7-8 | SEQUENCE(SIZE(7)) OF PortIndex8 |

OPTIONAL, -- Need R

| | |
|---|---|
| rank8-8 | SEQUENCE(SIZE(8)) OF PortIndex8 |

OPTIONAL -- Need R
},

| portIndex4 | SEQUENCE{ | |
|---|---|---|
| rank1-4 | PortIndex4 | OPTIONAL, -- |

Need R

| | |
|---|---|
| rank2-4 | SEQUENCE(SIZE(2)) OF PortIndex4 |

OPTIONAL, -- Need R

| | |
|---|---|
| rank3-4 | SEQUENCE(SIZE(3)) OF PortIndex4 |

OPTIONAL, -- Need R

| | |
|---|---|
| rank4-4 | SEQUENCE(SIZE(4)) OF PortIndex4 |

OPTIONAL -- Need R
},

| portIndex2 | SEQUENCE{ | |
|---|---|---|
| rank1-2 | PortIndex2 | OPTIONAL, -- |

Need R

| | |
|---|---|
| rank2-2 | SEQUENCE(SIZE(2)) OF PortIndex2 |

OPTIONAL -- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

-- TAG-CSI-REPORTCONFIG-STOP
-- ASN1STOP

CSI-ReportConfig field descriptions
carrier
Indicates in which serving cell the CSI-ResourceConfig indicated below
are to be found. If the field is absent, the resources are on
the same serving cell as this report configuration.
codebookConfig
Codebook configuration for Type-1 or Type-2 including codebook
subset restriction. Network does not configure codebookConfig
and codebookConfig-r16 simultaneously to a UE
cqi-FormatIndicator
Indicates whether the UE shall report a single (wideband) or multiple
(subband) CQI. (see TS 38.214 [19], clause 5.2.1.4).
cqi-Table
Which CQI table to use for CQI calculation (see TS 38.214 [19],
clause 5.2.2.1).
csi-IM-ResourcesForInterference
CSI IM resources for interference measurement.
csi-ResourceConfigId of a CSI-Resource Config included in the
configuration of the serving cell indicated with the field ″carrier″
above. The CSI-ResourceConfig indicated here contains only
CSI-IM resources. The bwp-Id in that
CSI-ResourceConfig is the same value as the bwp-Id in the CSI-
ResourceConfig indicated by resourcesForChannelMeasurement.
csi-ReportingBand
Indicates a contiguous or non-contiguous subset of subbands in the
bandwidth part which CSI shall be reported for. Each bit in the
bit-string represents one subband. The right-most bit in the bit
string represents the lowest subband in the BWP. The choice
determines the number of subbands (subbands3 for 3 subbands,
subbands4 for 4 subbands, and so on) (see TS 38.214 [19], clause
5.2.1.4). This field is absent if there are less than 24 PRBs (no sub
band) and present otherwise, the number of sub bands can be from
3 (24 PRBs, sub band size 8) to 18 (72 PRBs, sub band size 4).
dummy
This field is not used in the specification. If received it shall be
ignored by the UE.
groupBasedBeamReporting
Turning on/off group beam based reporting (see TS 38.214 [19],
clause 5.2.1.4).
non-PMI-PortIndication
Port indication for RI/CQI calculation. For each CSI-RS resource
in the linked ResourceConfig for channel measurement, a port
indication for each rank R, indicating which R ports to use.
Applicable only for non-PMI feedback (see TS 38.214 [19], clause
5.2.1.4.2).
The first entry in non-PMI-PortIndication corresponds to the NZP-
CSI-RS-Resource indicated by the first entry in nzp-CSI-RS-
Resources in the NZP-CSI-RS-ResourceSet indicated in the
first entry of nzp-CSI-RS-ResourceSetList of the CSI-ResourceConfig
whose CSI-ResourceConfigId is indicated in a CSI-MeasId together
with the above CSI-ReportConfigId; the second entry in non-PMI-
PortIndication corresponds to the NZP-CSI-RS-Resource indicated by
the second entry in nzp-CSI-RS-Resources in the NZP-CSI-RS-
ResourceSet indicated in the first entry of nzp-CSI-RS-ResourceSetList
of the same CSI-ResourceConfig, and so on until the NZP-CSI-
RS-Resource indicated by the last entry in nzp-CSI-RS-Resources
in the in the NZP-CSI-RS-ResourceSet indicated in the first entry of
nzp-CSI-RS-ResourceSetList of the same CSI-ResourceConfig. Then
the next entry corresponds to the NZP-CSI-RS-Resource indicated
by the first entry in nzp-CSI-RS-Resources in the NZP-CSI-RS-
ResourceSet indicated in the second entry of nzp-CSI-RS-
ResourceSetList of the same CSI-ResourceConfig and so on.
nrofReportedRS
The number (N) of measured RS resources to be reported per report
setting in a non-group-based report. N <= N_max, where N_max
is either 2 or 4 depending on UE capability. (see TS 38.214 [19],
clause 5.2.1.4) When the field is absent the UE applies the value 1.
nzp-CSI-RS-ResourcesForInterference
NZP CSI RS resources for interference measurement.
csi-ResourceConfigId of a CSI-ResourceConfig included
in the configuration of the serving cell indicated with the field
″carrier″ above. The CSI-ResourceConfig indicated here contains only
NZP-CSI-RS resources. The bwp-Id in that
CSI-ResourceConfig is the same value as the bwp-Id in the
CSI-ResourceConfig indicated by resourcesForChannelMeasurement.
p0alpha
Index of the p0-alpha set determining the power control for this CSI
report transmission (see TS 38.214 [19], clause 6.2.1.2).
pdsch-BundleSizeForCSI
PRB bundling size to assume for CQI calculation when reportQuantity
is CRI/RI/i1/CQI. If the field is absent, the UE assumes that no
PRB bundling is applied (see TS 38.214 [19], clause 5.2.1.4.2).
pmi-FormatIndicator
Indicates whether the UE shall report a single (wideband) or
multiple (subband) PMI. (see TS 38.214 [19], clause 5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214
[19], clause 5.2.1.4).
reportQuantity
The CSI related quantities to report. see TS 38.214 [19], clause 5.2.1.
If the field reportQuantity-r16 is present,
UE shall ignore reportQuantity (without suffix).
reportSlotConfig
Periodicity and slot offset (see TS 38.214 [19], clause 5.2.1.4). If the
field reportSlotConfig-v1530 is present, the UE shall ignore the
value provided in reportSlotConfig (without suffix).
reportSlotOffsetList,
reportSlotOffsetListDCI-0-1, reportSlotOffsetListDCI-0-2
Timing offset Y for semi persistent reporting using PUSCH. This
field lists the allowed offset values. This list must have the
same number of entries as the pusch-TimeDomainAllocationList
in PUSCH-Config. A particular value is indicated in DCI. The
network indicates in the DCI field of the UL grant, which of the
configured report slot offsets the UE shall apply. The DCI value 0
corresponds to the first report slot offset in this list, the DCI
value 1 corresponds to the second report slot offset in this list,
and so on. The first report is transmitted in slot n + Y, second
report in n + Y + P, where P is the configured periodicity.
Timing offset Y for aperiodic reporting using PUSCH. This field
lists the allowed offset values. This list must have the same
number of entries as the pusch-TimeDomainAllocationList
in PUSCH-Config. A particular value is indicated in DCI. The
network indicates in the DCI field of the UL grant, which of the
configured report slot offsets the UE shall apply. The DCI value
0 corresponds to the first report slot offset in this list, the DCI
value 1 corresponds to the second report slot offset in this list,
and so on (see TS 38.214 [19], clause 6.1.2.1). The field
reportSlotOffsetList applies to DCI format 0_0, the field
reportSlotOffsetListDCI-0-1 applies to DCI format 0_1 and the
field reportSlotOffsetListDCI-0-2 applies to DCI format 0_2
(see TS 38.214 [19], clause 6.1.2.1).
resourcesForChannelMeasurement
Resources for channel measurement. csi-ResourceConfigId of a
CSI-ResourceConfig included in the configuration of the
serving cell indicated with the field ″carrier″ above. The
CSI-ResourceConfig indicated here contains only NZP-CSI-RS
resources and/or SSB resources. This CSI-ReportConfig
is associated with the DL BWP indicated by bwp-Id in
that CSI-ResourceConfig.
subbandSize
Indicates one out of two possible BWP-dependent values for the
subband size as indicated in TS 38.214 [19], table 5.2.1.4-2.
If csi-ReportingBand is absent, the UE shall ignore this field.
timeRestrictionForChannelMeasurements
Time domain measurement restriction for the channel (signal)
measurements (see TS 38.214 [19], clause 5.2.1.1).
timeRestrictionForInterferenceMeasurements
Time domain measurement restriction for interference measurements
(see TS 38.214 [19], clause 5.2.1.1).

### Table 33: CSI-ResourceConfig

The IE CSI-ResourceConfig defines a group of one or more NZP-CSI-RS-ResourceSet, CSI-IM-ResourceSet and/or CSI-SSB-ResourceSet.

TABLE 33
CSI-ResourceConfig information element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId

OPTIONAL, --

Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

CSI-ResourceConfig field descriptions
bwp-Id
The DL BWP which the CSI-RS associated with this CSI-
ResourceConfig are located in (see TS 38.214 [19], clause 5.2.1.2.
csi-IM-ResourceSetList
List of references to CSI-IM resources used for beam measurement and
reporting in a CSI-RS resource set. Contains up to maxNrofCSI-
IM-ResourceSetsPerConfig resource sets if resourceType is
′aperiodic′ and 1 otherwise (see TS 38.214 [19], clause 5.2.1.2).
csi-ResourceConfigId
Used in CSI-ReportConfig to refer to an instance of CSI-ResourceConfig.
csi-SSB-ResourceSetList
List of references to SSB resources used for beam measurement and
reporting in a CSI-RS resource set (see TS 38.214 [19], clause 5.2.1.2).
nzp-CSI-RS-ResourceSetList
List of references to NZP CSI-RS resources used for beam measurement
and reporting in a CSI-RS resource set. Contains up to maxNrofNZP-
CSI-RS-ResourceSetsPerConfig resource sets if resourceType
is ′aperiodic′ and 1 otherwise (see TS 38.214 [19], clause 5.2.1.2).
resourceType
Time domain behavior of resource configuration (see TS 38.214 [19],
clause 5.2.1.2). It does
not apply to resources provided in the csi-SSB-ResourceSetList.

### Table 34: NZP-CSI-RS-ResourceSet

The IE NZP-CSI-RS-ResourceSet is a set of Non-Zero-Power (NZP) CSI-RS resources (their IDs) and set-specific parameters.

TABLE 34
NZP-CSI-RS-ResourceSet information element

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

```
OPTIONAL, -- Need R
  ...,
  [[
```

| | |
|---|---|
| aperiodicTriggeringOffset-r16 | INTEGER(0..31) |

OPTIONAL -- Need S
]]
}
-- TAG-NZP-CSI-RS-RESOURCESET-STOP
-- ASN1STOP

NZP-CSI-RS-ResourceSet field descriptions
aperiodicTriggeringOffset, aperiodicTriggeringOffset-r16
Offset X between the slot containing the DCI that triggers a set of
aperiodic NZP CSI-RS resources and the slot in which the CSI-
RS resource set is transmitted. For aperiodicTriggeringOffset,
the value 0 corresponds to 0 slots, value 1 corresponds to 1 slot,
value 2 corresponds to 2 slots, value 3 corresponds to 3 slots,
value 4 corresponds to 4 slots, value 5 corresponds to 16 slots,
value 6 corresponds to 24 slots. For aperiodicTriggeringOffset-
r16, the value indicates the number of slots. The network
configures only one of the fields. When neither field is
included, the UE applies the value 0.
nzp-CSI-RS-Resources
NZP-CSI-RS-Resources associated with this NZP-CSI-RS
resource set (see TS 38.214 [19], clause 5.2). For CSI,
there are at most 8 NZP CSI RS resources per resource set.
repetition
Indicates whether repetition is on/off. If the field is set to off
or if the field is absent, the UE may not assume that the NZP-
CSI-RS resources within the resource set are transmitted with
the same downlink spatial domain transmission filter (see TS
38.214 [19], clauses 5.2.2.3.1 and 5.1.6.1.2). It can only be
configured for CSI-RS resource sets which are associated with
CSI-ReportConfig with report of L1 RSRP or ″no report″.
trs-Info
Indicates that the antenna port for all NZP-CSI-RS resources in
the CSI-RS resource set is same. If the field is absent or
released the UE applies the value false (see TS 38.214 [19],
clause 5.2.2.3.1).

### Table 35: CSI-SSB-ResourceSet

The IE CSI-SSB-ResourceSet is used to configure one SS/PBCH block resource set which refers to SS/PBCH as indicated in ServingCellConfig Common.

TABLE 35
CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) |

OF SSB-Index,
...
}
-- TAG-CSI-SSB-RESOURCESET-STOP
-- ASN1STOP

### Table 36: CSI-IM-ResourceSet

The IE CSI-IM-ResourceSet is used to configure a set of one or more CSI Interference Management (IM) resources (their IDs) and set-specific parameters.

TABLE 36
CSI-IM-ResourceSet information element

-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM-ResourcesPerSet)) OF |

CSI-IM-ResourceId,
...
}
-- TAG-CSI-IM-RESOURCESET-STOP
-- ASN1STOP

CSI-IM-ResourceSet field descriptions
csi-IM-Resources
CSI-IM-Resources associated with this CSI-IM-ResourceSet
(see TS 38.214 [19], clause 5.2)

### Table 37: CSI-AperiodicTriggerStateList

The CSI-AperiodicTriggerStateList IE is used to configure the UE with a list of aperiodic trigger states. Each codepoint of the DCI field “CSI request” is associated with one trigger state. Upon reception of the value associated with a trigger state, the UE will perform measurement of CSI-RS (reference signals) and aperiodic reporting on L1 according to all entries in the associatedReportConfigInfoList for that trigger state.

TABLE 37
CSI-AperiodicTriggerStateList information element

-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI-AperiodicTriggers)) |

OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-AssociatedReportConfigInfo,
...
}

| | |
|---|---|
| CSI-AssociatedReportConfigInfo ::= | SEQUENCE { |

| | |
|---|---|
| reportConfigId | CSI-ReportConfigId, |

| | |
|---|---|
| resourcesForChannel | CHOICE { |

| | |
|---|---|
| nzp-CSI-RS | SEQUENCE { |

| | |
|---|---|
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS-ResourcesPerSet)) |

OF TCI-StateId OPTIONAL -- Cond Aperiodic
},

| | |
|---|---|
| csi-SSB-ResourceSet | INTEGER (1..maxNrofCSI-SSB-ResourceSetsPerConfig) |

},

| | |
|---|---|
| csi-IM-ResourcesForInterference | INTEGER(1..maxNrofCSI-IM-ResourceSetsPerConfig) |

OPTIONAL, -- Cond CSI-IM-ForInterference
nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

...
}
-- TAG-CSI-APERIODICTRIGGERSTATELIST-STOP
-- ASN1STOP

CSI-AssociatedReportConfigInfo field descriptions
csi-IM-ResourcesForInterference
CSI-IM-ResourceSet for interference measurement. Entry
number in csi-IM-ResourceSetList in the CSI-
ResourceConfig indicated by csi-IM-ResourcesForInterference
in the CSI-ReportConfig indicated by reportConfigId above (1
corresponds to the first entry, 2 to the second entry, and so on).
The indicated CSI-IM-ResourceSet should have exactly
the same number of resources like the NZP-CSI-RS-
ResourceSet indicated in nzp-CSI-RS-ResourcesforChannel.
csi-SSB-ResourceSet
CSI-SSB-ResourceSet for channel measurements. Entry
number in csi-SSB-ResourceSetList in the CSI-
ResourceConfig indicated by resourcesForChannelMeasurement
in the CSI-ReportConfig indicated by reportConfigId
above (1 corresponds to the first entry, 2 to the second
entry, and so on).
nzp-CSI-RS-ResourcesForInterference
NZP-CSI-RS-ResourceSet for interference measurement.
Entry number in nzp-CSI-RS-ResourceSetList in the
CSI-ResourceConfig indicated by nzp-CSI-RS-
ResourcesForInterference in the CSI-ReportConfig indicated
by reportConfigId above (1 corresponds to
the first entry, 2 to the second entry, and so on).
qcl-info
List of references to TCI-States for providing the QCL
source and QCL type for each NZP-CSI-RS-Resource
listed in nzp-CSI-RS-Resources of the NZP-CSI-RS-
ResourceSet indicated by nzp-CSI-RS-ResourcesforChannel.
Each TCI-StateId refers to the TCI-State which has this
value for tci-Stateld and is defined in tci-StatesToAddModList
in the PDSCH-Config included in the BWP-Downlink
corresponding to the serving cell and to the DL BWP to which
the resourcesForChannelMeasurement (in the CSI-ReportConfig
indicated by reportConfigld above) belong to. First entry
in qcl-info-forChannel corresponds to first entry in nzp-CSI-RS-
Resources of that NZP-CSI-RS-ResourceSet, second entry in qcl-
info-forChannel corresponds to second entry in nzp-CSI-RS-
Resources, and so on (see TS 38.214 [19], clause 5.2.1.5.1)
reportConfigId
The reportConfigId of one of the CSI-ReportConfigToAddMod
configured in CSI-MeasConfig
resourceSet
NZP-CSI-RS-ResourceSet for channel measurements. Entry
number in nzp-CSI-RS-ResourceSetList in the CSI-
ResourceConfig indicated by resourcesForChannelMeasurement
in the CSI-ReportConfig indicated by reportConfigId
above (1 corresponds to the first entry, 2 to thesecond entry,
and so on).

| Conditional Presence | Explanation |
|---|---|
| Aperiodic | The field is mandatory present if the NZP- |
| | CSI-RS-Resources in the associated |
| | resourceSet have the resourceType aperiodic. |
| | The field is absent otherwise. |
| CSI-IM-ForInterference | This field is optional need M if the CSI- |
| | ReportConfig identified by reportConfigId |
| | is configured with csi-IM- |
| | ResourcesForInterference; |
| | otherwise it is absent. |
| NZP-CSI-RS- | This field is optional need M if the CSI- |
| ForInterference | ReportConfig identified by reportConfigId |
| | is configured with nzp-CSI- |
| | RS-ResourcesForInterference; |
| | otherwise it is absent. |

### Table 38: CSI-SemiPersistentOnPUSCH-TriggerStateList

The CSI-SemiPersistentOnPUSCH-TriggerStateList IE is used to configure the UE with list of trigger states for semi-persistent reporting of channel state information on L1. See also TS 38.214 [19], clause 5.2.

TABLE 38
CSI-SemiPersistentOnPUSCH-TriggerStateList information element

```
-- ASN1START
-- TAG-CSI-SEMIPERSISTENTONPUSCHTRIGGERSTATELIST-START
CSI-SemiPersistentOnPUSCH-TriggerStateList ::= SEQUENCE(SIZE
(1..maxNrOfSemiPersistentPUSCH-Triggers)) OF CSI-SemiPersistentOnPUSCH-TriggerState
CSI-SemiPersistentOnPUSCH-TriggerState ::= SEQUENCE {
  associatedReportConfigInfo CSI-ReportConfigId,
  ...
}
-- TAG-CSI-SEMIPERSISTENTONPUSCHTRIGGERSTATELIST-STOP
-- ASN1STOP
```

For the above-described CSI report setting (CSI-ReportConfig), each report setting CSI-ReportConfig may be associated with the CSI resource setting associated with the corresponding report configuration, and one downlink (DL) bandwidth part identified by an higher layer parameter bandwidth part identifier (bwp-id) given as the CSI-ResourceConfig. As a time domain report operation for each report setting CSI-ReportConfig, “aperiodic”, “semi-persistent”, and “periodic” methods are supported, and they may be configured from the base station to the UE by a reportConfigType parameter configured from the higher layer. The semi-persistent CSI report method supports “PUCCH based semipersistent (semi-PersistentOnPUCCH)” and “PUSCH based semi-persistent (semi-PersistentOnPUSCH)”. In case of the periodic or semi-persistent CSI report method, the UE may be configured with PUCCH or PUSCH resources to transmit the CSI from the base station through higher layer signaling. The period and slot offset of the PUCCH or PUSCH resource to transmit the CSI may be given based on numerology of the uplink (UL) bandwidth part configured to transmit the CSI report. In case of the aperiodic CSI report method, the UE may be scheduled with the PUSCH resource to transmit the CSI from the base station through L1 signaling (the above-described DCI format 0_1).

For the above-described CSI resource setting (CSI-ResourceConfig), each CSI resource setting CSI-ReportConfig may include S(≥1) CSI resource sets (given as the higher layer parameter csi-RS-ResourceSetList). The CSI resource set list may be configured by a non-zero power (NZP) CSI-RS resource set and an SS/PBCH block set, or may be configured by a CSI-interference measurement (CSI-IM) resource set. Each CSI resource setting may be located in a downlink (DL) bandwidth part being identified by the higher layer parameter bwp-id, and the CSI resource setting may be connected to the CSI report setting of the same downlink bandwidth part. The time domain behavior of the CSI-RS resource in the CSI resource setting may be configured as one of “aperiodic”, “periodic”, or “semi-persistent” from the higher layer parameter resourceType. For the periodic or semi-persistent CSI resource setting, the number of CSI-RS resource sets may be limited to S=1, and the configured period and slot offset may be given in the numerology of DL BWP, as being identified by bwp-id. The UE may be configured with one or more CSI resource settings for channel or interference measurement through higher layer signaling from a base station, and CSI resources below may be included.
CSI-IM resource for interference measurement
NZP CSI-RS resource for interference measurement
NZP CSI-RS resource for channel measurement

For the CSI-RS resource sets in which the higher layer parameter resourceType is associated with the resource setting configured as “aperiodic”, “periodic”, or “semi-persistent”, the trigger state for the CSI report setting in which the reportType is configured as “aperiodic”, and the resource setting for channel or interference measurement for one or a plurality of CCs may be configured as the higher layer parameter CSI-AperiodicTriggerStateList.

The aperiodic CSI report of the UE may be performed by using the PUSCH, the periodic CSI report may be performed by using the PUCCH, and the semi-persistent CSI report may be performed by using the PUSCH in case of being triggered or activated by the DCI, and may be performed by using the PUCCH after being activated by a MAC control element (MAC CE). As described above, the CSI resource setting may also be configured as aperiodic, periodic, or semi-persistent. A combination between the CSI report setting and the CSI resource setting may be supported based on the following Table 39.

TABLE 39
Table 5.2.1.4-1: Triggering/Activation of CSI Reporting
for the possible CSI-RS Configurations.

| CSI-RS | Periodic CSI | Semi-Persistent | Aperiodic CSI |
|---|---|---|---|
| Configuration | Reporting | CSI Reporting | Reporting |
| Periodic | No dynamic | For reporting on | Triggered by DCI; |
| CSI-RS | triggering/ | PUCCH, the UE | additionally, |
| | activation | receives an | activation |
| | | activation | command |
| | | command | [10, TS 38.321] |
| | | [10, TS 38.321]; | possible |
| | | for reporting | as defined in |
| | | on PUSCH, the UE | Subclause |
| | | receives triggering | 5.2.1.5.1. |
| | | on DCI | |
| Semi- | Not | For reporting on | Triggered by DCI; |
| Persistent | Supported | PUCCH, the UE | additionally, |
| CSI-RS | | receives an | activation |
| | | activation | command |
| | | command | [10, TS 38.321] |
| | | [10, TS 38.321]; | possible as |
| | | for reporting | defined in |
| | | on PUSCH, the UE | Subclause 5.2.1.5.1. |
| | | receives triggering | |
| | | on DCI | |
| Aperiodic | Not | Not Supported | Triggered by DCI; |
| CSI-RS | Supported | | additionally, |
| | | | activation command |
| | | | [10, TS 38.321] |
| | | | possible as defined in |
| | | | Subclause 5.2.1.5.1. |

The aperiodic CSI report may be triggered to a “CSI request” field of the above-described DCI format 0_1 corresponding to the scheduling DCI for the PUSCH. The UE may monitor the PDCCH, obtain the DCI format 0_1, and obtain PUSCH scheduling information and a CSI request indicator. The CSI request indicator may be configured with NTS (=0, 1, 2, 3, 4, 5, or 6) bits, and may be determined by the higher layer signaling (reportTriggerSize). One trigger state among one or a plurality of aperiodic CSI report trigger states that may be configured by the higher layer signaling (CSI-AperiodicTriggerStateList) may be triggered by the CSI request indicator.
If all bits of the CSI request field are 0, this implies that the CSI report is not requested.
   If the number M of CSI trigger states in the configured CSI-AperiodicTriggerStateLite is larger than 2NTs-1, in accordance with a predefined mapping relationship, M CSI trigger states may be mapped on 2NTs-1, and one of 2NTs1 trigger states may be indicated as a CSI request field.
   If the number M of CSI trigger states in the configured CSI-AperiodicTriggerStateLite is equal to or smaller than 2NTs-1, one of M CSI trigger states may be indicated as the CSI request field.

Table 40 below represents an example of the relationship between a CSI request indicator and a CSI trigger state that can be indicated by the indicator.

TABLE 40

| CSI | CSI | CSI- | CSI- |
|---|---|---|---|
| request field | trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

With respect to the CSI resources in the CSI trigger state triggered as the CSI request field, the UE may perform measurement, and may generate the CSI (including at least one of CQI, PMI, CRI, SSBRI, LI, RI, or L1-RSRP as described above) based on the measurement. The UE may transmit the obtained CSI by using the PUSCH being scheduled by the corresponding DCI format 0_1. If one bit corresponding to the uplink data indicator (UL-SCH indicator) in the DCI format 0_1 indicates “1”, the UE may multiplex the uplink data (UL-SCH) and the obtained CSI to the PUSCH resource scheduled by the DCI format 0_1 and transmit the same. If one bit corresponding to the uplink data indicator (UL-SCH indicator) in the DCI format 0_1 indicates “0”, the UE may map only the CSI to the PUSCH resource scheduled by the DCI format 0_1 without uplink data (UL-SCH) and transmit the same.

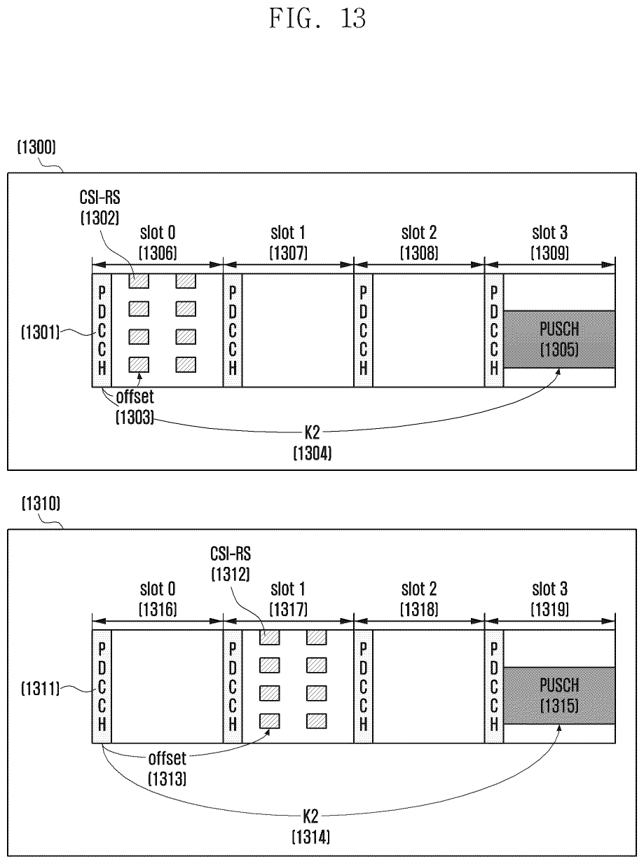

FIG. 13 illustrates an example of an aperiodic CSI report method according to an embodiment of the disclosure.

Referring to FIG. 13, the UE may obtain DCI format 01 by monitoring a PDCCH 1301, and may obtain scheduling information for the PUSCH 1305 and CSI request information based on the measurement. The UE may obtain resource information on the CSI-RS 1302 to be measured from the received CSI request indicator. The UE may determine, at which point, to perform measurement of a resource of the CSI-RS 1302 being transmitted based on a time point at which the DCI format 0_1 is received and the CSI resource set configuration (e.g., parameter (above-described aperiodicTriggeringOffset) for the offset in the NZP CSI-RS resource set configuration (NZP-CSI-RS-ResourceSet)). More specifically, the UE may be configured with an offset value X of the parameter aperiodicTriggeringOffset in the NZP-CSI-RS resource set configuration from the base station through higher layer signaling, and the configured offset value X may denote the offset between the slot having received the DCI for triggering the aperiodic CSI report and the slot for transmitting the CSI-RS resource. For example, the aperiodicTriggeringOffset parameter value and the offset value X may have a mapping relationship described in Table 41 below.

TABLE 41

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

In an example 1300 of FIG. 13, the offset value 1303 is configured as X=0. In this case, the UE may receive a CSI-RS 1302 in a slot (corresponding to a slot 0 1306 of FIG. 13) in which the DCI format 0_1 triggering the aperiodic CSI report is received, and may report CSI information through a PUSCH 1305 to the base station, the CSI information being measured by using the received CSI-RS. The UE may obtain, from the DCI format 0_1, scheduling information (a plurality of pieces of information respectively corresponding to fields of the DCI format 0_1) with respect to the PUSCH 1305 for a CSI report. For example, the UE may obtain information about a slot in which the PUSCH 1305 is to be transmitted, from time-domain resource allocation information of the DCI format 0_1 with respect to the PUSCH 1305. In the example 1300 of FIG. 13, the UE may obtain 3 as K2 value 1304 corresponding to a slot offset value for PDCCH-to-PUSCH, and thus, the PUSCH 1305 may be transmitted in a slot 3 1309 that is distant, by 3 slots (slot 0 1306, slot 1307, slot 2 1308 of FIG. 13), from the slot 0 1306 in which the PDCCH 1301 is received.

In an example 1310 of FIG. 13, the UE may obtain DCI format 0_1 by monitoring a PDCCH 1311, and may obtain, from the DCI format 0_1, scheduling information with respect to a PUSCH 1315 and CSI information. The UE may obtain, from a received CSI request indicator, resource information with respect to a CSI-RS 1312 to be measured. In the example 1310 of FIG. 13, the aforementioned offset value 1313 for CSI-RS is configured as X=1. In this case, the UE may receive the CSI-RS 1312 in a slot (slot 0 1316 of FIG. 13) in which the DCI format 0_1 triggering an aperiodic CSI report is received, and may report, to the base station via the PUSCH 1315, CSI information measured by using a received CSI-RS. In the example 1310 of FIG. 13, the UE may obtain 3 as K2 value 1314 corresponding to a slot offset value for PDCCH-to-PUSCH, and thus, the PUSCH 1315 may be transmitted in a slot 3 1319 that is distant, by 3 slots (slot 0 1316, slot 1317, slot 2 1318 of FIG. 13), from the slot 0 1316 in which the PDCCH 1311 is received.

The aperiodic CSI report may include at least one of CSI part 1 or CSI part 2 or both CSI part 1 and CSI part 2, and when the aperiodic CSI report is to be transmitted through a PUSCH, the aperiodic CSI report and a transport block may be multiplexed. For the multiplexing, a CRC may be inserted into an input bit of aperiodic CSI, and then encoding and rate matching may be performed thereon, and thereafter, the input bit may be mapped with a particular pattern to a resource element in a PUSCH and transmitted. The CRC insertion may be omitted depending on a coding method or a length of input bits. The number of modulation symbols to be calculated for rate matching in multiplexing of CSI Part 1 or CSI part 2 included in the aperiodic CSI report may be calculated as in Table 42.

TABLE 42
For CSI part 1 transmission on PUSCH not using repetition type B with UL-SCH, the number of
coded modulation symbols per layer for CSI part 1 transmission, denoted as Q_{CSI-part1}′, is
determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$
$⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$
...
For CSI part 1 transmission on an actual repetition of a PUSCH with repetition Type B with UL-
SCH, the number of coded modulation symbols per layer for CSI part 1 transmission, denoted as
Q_{CSI-part1}′, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ ,$
$⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , {\sum }_{l = 0}^{{N}_{symb , actual}^{PUSCH} - 1} {M}_{sc , actual}^{UCI} ( l ) - {Q}_{ACK / CG - UCI}^{′} \}$
...
For CSI part 1 transmission on PUSCH without UL-SCH, the number of coded modulation
symbols per layer for CSI part 1 transmission, denoted as Q_{CSI-part1}′, is determined as follows:
if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
else
${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
end if
...
For CSI part 2 transmission on PUSCH not using repetition type B with UL-SCH, the number of
coded modulation symbols per layer for CSI part 2 transmission, denoted as Q_{CSI-part2}′, is
determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$
$⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{SCI - 1}^{′} \}$
For CSI part 2 transmission on an actual repetition of a PUSCH with repetition Type B with UL-
SCH, the number of coded modulation symbols per layer for CSI part 2 transmission, denoted as
Q_{CSI-part2}′, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ ,$
$⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$
...
For CSI part 2 transmission on PUSCH without UL-SCH, the number of coded modulation
symbols per layer for CSI part 2 transmission, denoted as Q_{CSI-part2}′, is determined as follows:
${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$

In particular, in PUSCH repetition types A and B, the UE may multiplex and transmit the aperiodic CSI report only in first repetition from among PUSCH repetitions. The aperiodic CSI report information to be multiplexed is encoded by using a polar code scheme, and here, in order to multiplex the aperiodic CSI report information for multiple PUSCH repetitions, each of the PUSCH repetitions has to have the same frequency and time resource allocation, and in particular, in a case of the PUSCH repetition type B, each actual repetition may have a different OFDM symbol length, and thus, the aperiodic CSI report may be multiplexed and transmitted only in first PUSCH repetition.

In addition, for the PUSCH repetition type B, in a case where the UE receives DCI to schedule the aperiodic CSI report or to activate a semi-persistent CSI report without scheduling of a transport block, even when the number of PUSCH repetitions configured by higher layer signaling is greater than 1, the UE may assume a value of nominal repetition as 1. In addition, when the aperiodic or semi-persistent CSI report is scheduled or activated without scheduling of a transport block based on the PUSCH repetition type B, the UE may expect that first nominal repetition is the same as first actual repetition. For a PUSCH being transmitted while including semi-persistent CSI based on the PUSCH repetition type B without scheduling of DCI after the semi-persistent CSI report is activated by DCI, if first nominal repetition is different from first actual repetition, transmission with respect to the first nominal repetition may be ignored.

### [Regarding UE Capability Report]

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA—NR dual connectivity (EN-DC). The UE capability enquiry message may be transmitted initially after the UE is connected to the base station, in general, but may be requested in any condition if needed by the base station.

Upon receiving the UE capability report request from the base station in the above operation, the UE may configure UE capability according to band information and RAT type requested by the base station. The method in which the UE configures UE capability in an NR system is summarized below:

1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. Bands have priority in the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above operation. As used herein, a fallback BC refers to a BC that can be obtained by removing a band corresponding to at least one SCell from a specific BC, and since a BC before removal of the band corresponding to at least one SCell can already cover a fallback BC, the same can be omitted. This operation is applied in MR-DC as well, that is, LTE bands are also applied. BCs remaining after the above operation constitute the final “candidate BC list”.

4. The UE selects BCs appropriate for the requested RAT type from the final “candidate BC list” and configures BCs to report. In this operation, the UE configures supportedBandCombinationList in a determined order. That is, the UE configures BCs and UE capability to report according to a preconfigured rat-Type order. (nr->eutra-nr->eutra).→(nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower operation) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

### [Regarding CA/DC]

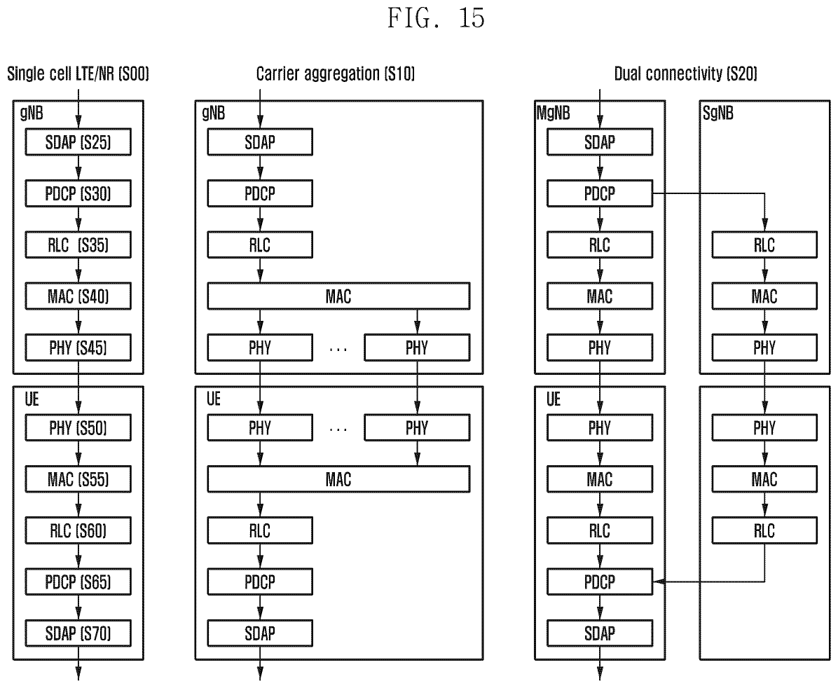

FIG. 15 is a diagram illustrating radio protocol structures of a base station and a UE in single cell (S00), carrier aggregation (S10), and dual connectivity (S20) situations according to an embodiment of the disclosure.

Referring to FIG. 15, a radio protocol of a mobile communication system includes an NR service data adaptation protocol (SDAP) S25 or S70, an NR packet data convergence protocol (PDCP) S30 or S65, an NR radio link control (RLC) S35 or S60, an NR medium access controls (MAC) S40 or S55, on each of UE and NR base station sides, and a physical layer (PHY) S45 or S50.

The main functions of the NR SDAP S25 or S70 may include some of functions below.
Transfer of user plane data
Mapping between a quality of service (QoS) flow and a data radio bearer (DRB) for both DL and UL
Marking QoS flow ID in both DL and UL packets
Reflective QoS flow to DRB mapping for the UL SDAP packet data units (PDUs)

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP S30 or S65 may include some of functions below.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in uplink

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC S35 or S60 may include some of functions below.
Transfer of upper layer PDUs
In-sequence delivery of upper layer PDUs
Out-of-sequence delivery of upper layer PDUs
Error Correction through Automatic repeat request (ARQ)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device refers to a function of delivering RLC SDUs, received from the lower layer, to the upper layer in sequence. The in-sequence delivery of the NR RLC device may include a function of reassembling and delivering multiple RLC SDUs received, into which one original RLC SDU has been segmented, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery function of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC S40 or S55 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through hybrid automatic repeat request (HARQ)
Priority handling between logical channels of one UE
Priority handling between UEs by means of dynamic scheduling
Multimedia broadcast multicast service (MBMS) service identification
Transport format selection
Padding

According to an embodiment of the disclosure, the physical layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 400. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 410. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 820.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may improve the PDCCH reception reliability of a UE by providing a PDCCH repetitive transmission method through multiple transmission points (TRPs). Specific methods thereof will be described hereinafter through the embodiments below.

Hereinafter, the operation principle of the disclosure will be described in detail in conjunction with the accompanying drawings. The contents of the disclosure may be applied to frequency division duplex (FDD) and time division duplex (TDD) and/or cross division duplex (XDD) (and/or subband non-overlapping full duplex (SBFD)) systems. As used herein, upper signaling (or higher layer signaling) is a method for transferring signals from a base station to a UE by using a downlink data channel of a physical layer, or from the UE to the base station by using an uplink data channel of the physical layer, and may also be referred to as “RRC signaling”, “PDCP signaling”, or “medium access control (MAC) control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

### [Related to NC-JT]

According to an embodiment of the disclosure, a UE may use non-coherent joint transmission (NC-JT) in order to receive a PDSCH from a plurality of TRPs.

Unlike the conventional system, the 5G wireless communication system supports not only a service requiring a high transmission rate but also both a service having a very short transmission delay and a service requiring a high connection density. In a wireless communication network including a plurality of cells, transmission and reception points (TRPs), or beams, cooperative communication (coordinated transmission) between respective cells, TRPs, and/or beams may satisfy various service requirements by increasing the strength of a signal received by the UE or efficiently controlling interference between the cells, TRPs, and/or beams.

Joint transmission (JT) is a representative transmission technology for the cooperative communication and may increase the strength or processing rate of a signal received by the UE or throughput by transmitting signals to one UE through different cells, TRPs, and/or beams. A channel between each cell, TRP, and/or beam and the UE may have significantly different characteristics, and particularly, non-coherent joint transmission (NC-JT) supporting non-coherent precoding between respective cells, TRPs, and/or beams may need individual precoding, MCS, resource allocation, and TCI indication according to the channel characteristics for each link between each cell, TRP, and/or beam and the UE.

The NC-JT described above may be applied to at least one of a physical downlink data channel (PDSCH), a physical downlink control channel (PDCCH), a physical uplink data channel (PUSCH), and a physical uplink control channel (PUCCH). In PDSCH transmission, transmission information such as precoding, MCS, resource allocation, and TCI may be indicated through DL DCI, and should be independently indicated for each cell, TRP, and/or beam for the NC-JT. This is a main factor that increases payload required for DL DCI transmission, which may have a bad influence on reception performance of a PDCCH for transmitting the DCI. Accordingly, in order to support JT of the PDSCH, it is required to carefully design a tradeoff between an amount of DCI information and reception performance of control information.

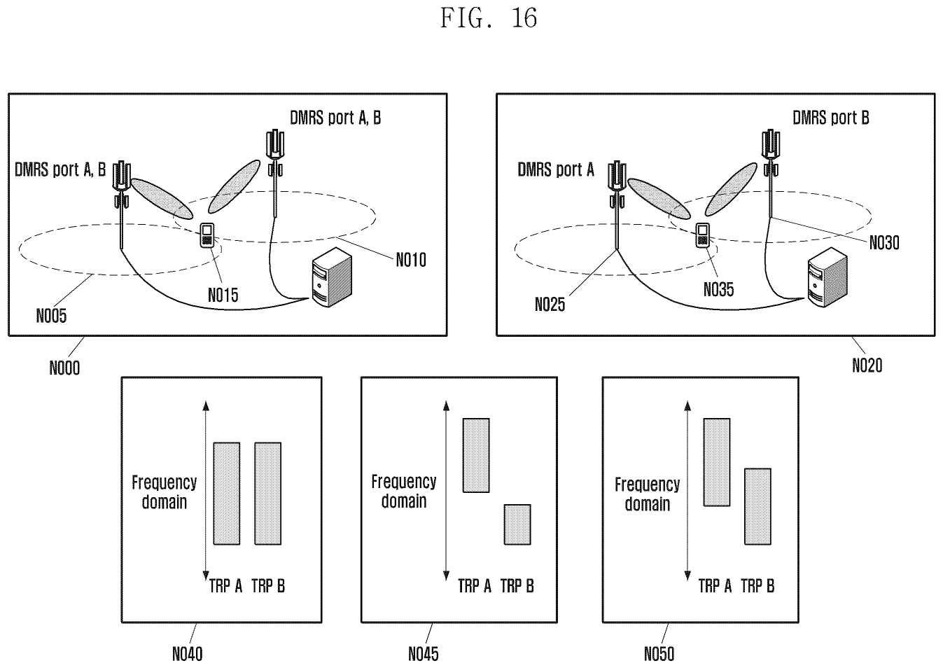

FIG. 16 illustrates a configuration of antenna ports and an example of resource allocation for performing cooperative communication in a wireless communication system according to an embodiment of the disclosure. FIG. 16 illustrates an example of antenna port configuration and resource allocation for transmitting a PDSCH using cooperative communication in a wireless communication system according to an embodiment of the disclosure.

Referring to FIG. 16, the example for PDSCH transmission is described for each scheme of joint transmission (JT), and examples for allocating radio resources for each TRP are described.

Referring to FIG. 16, an example N000 of coherent joint transmission (C-JT) supporting coherent precoding between respective cells, TRPs, and/or beams is illustrated.

In the case of C-JT, a TRP A N005 and a TRP B N010 transmit single data (PDSCH) to a UE N015, and the plurality of TRPs may perform joint precoding. This may mean that the TRP A N005 and the TRP B N010 transmit DMRSs through the same DMRS ports in order to transmit the same PDSCH. For example, the TRP A N005 and the TRP B N010 may transmit DMRSs to the UE through a DMRS port A and a DMRS port B, respectively. In this case, the UE may receive one piece of DCI information for receiving one PDSCH demodulated based on the DMRSs transmitted through the DMRS port A and the DMRS port B.

FIG. 16 illustrates an example N020 of non-coherent joint transmission (NC-JT) supporting non-coherent precoding between respective cells, TRPs, and/or beams for PDSCH transmission.

In the case of NC-JT, the PDSCH is transmitted to a UE N035 for each cell, TRP, and/or beam, and individual precoding may be applied to each PDSCH. Respective cells, TRPs (N025 or N030), and/or beams may transmit different PDSCHs or different PDSCH layers to the UE, thereby improving throughput compared to single cell, TRP, and/or beam transmission. Further, respective cells, TRPs, and/or beams may repeatedly transmit the same PDSCH to the UE, thereby improving reliability compared to single cell, TRP, and/or beam transmission. For convenience of description, the cell, TRP, and/or beam are commonly called a TRP.

At this time, various wireless resource allocations such as the case N040 in which frequency and time resources used by a plurality of TRPs for PDSCH transmission are all the same, the case N045 in which frequency and time resources used by a plurality of TRPs do not overlap at all, and the case N050 in which some of the frequency and time resources used by a plurality of TRPs overlap each other may be considered.

In order to support NC-JT, DCI in various forms, structures, and relations may be considered to simultaneously allocate a plurality of PDSCHs to one UE.

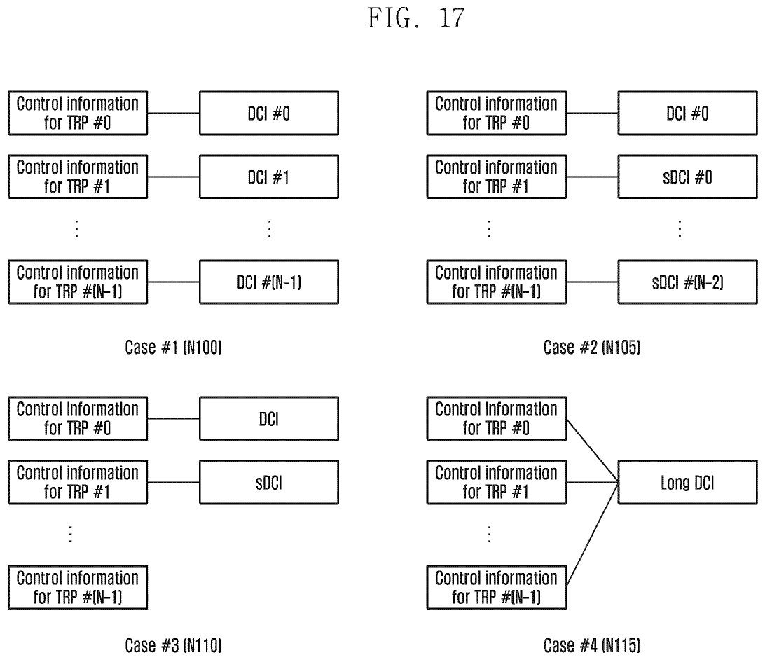

FIG. 17 illustrates an example of a configuration of downlink control information (DCI) for cooperative communication in a wireless communication system according to an embodiment of the disclosure. FIG. 17 illustrates an example of a configuration of downlink control information (DCI) for NC-JT in which respective TRPs transmit different PDSCHs or different PDSCH layers to a UE in a wireless communication system according to an embodiment of the disclosure.

Referring to FIG. 17, case #1 N100 is an example in which control information for PDSCHs transmitted from (N−1) additional TRPs is transmitted independently from control information for a PDSCH transmitted by a serving TRP in a situation in which (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCI (DCI #0 to DCI #(N−1)). Formats between the independent DCI may be the same as or different from each other, and payload between the DCI may also be the same as or different from each other. In case #1, a degree of freedom of PDSCH control or allocation can be completely guaranteed, but when respective pieces of DCI are transmitted by different TRPs, a difference between DCI coverages may be generated and reception performance may deteriorate.

Case #2 N105 is an example in which pieces of control information for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCI (hereinafter, referred to as sDCI) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TRPs has smaller payload compared to the normal DCI (nDCI) for transmitting control information related to the PDSCH transmitted from the serving TRP, and thus can include reserved bits compared to the nDCI.

In Case #2 described above, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 N110 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 12 may be gathered in one “secondary” DCI (sDCI) and transmitted. For example, the sDCI may include at least one piece of HARQ-related information such as frequency domain resource assignment and time domain resource assignment of the cooperative TRPs and the MCS. In addition, information that is not included in the sDCI such as a BWP indicator and a carrier indicator may follow DCI (DCI #0, normal DCI, or nDCI) of the serving TRP.

In case #3 N110, a degree of freedom of PDSCH control or allocation may be limited according to content of the information elements included in the sDCI but reception performance of the sDCI can be controlled, and case #3 N110 may have smaller complexity of DCI blind decoding of the UE compared to the case #1 N100 or case #2 N105.

Case #4 N115 is an example in which control information for PDSCHs transmitted from (N−1) additional TRPs is transmitted in DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In case #4 1715, complexity of DCI blind decoding of the UE may not be increased, but a degree of freedom of PDSCH control or allocation may be low since the number of cooperative TRPs is limited according to long DCI payload restriction.

In the following description and embodiments, the sDCI may refer to various pieces of supplementary DCI such as shortened DCI, secondary DCI, or normal DCI (DCI formats 1_0 and 1_1 described above) including PDSCH control information transmitted in the cooperative TRP, and unless a specific restriction is mentioned, the corresponding description may be similarly applied to the various pieces of supplementary DCI.

In the following description and embodiments, case #1 N100, case #2 N105, and case #3 N110 in which one or more pieces of DCI (or PDCCHs) are used to support NC-JT may be classified as multiple PDCCH-based NC-JT and case #4 N115 in which single DCI (or PDCCH) is used to support NC-JT may be classified as single PDCCH-based NC-JT. In multiple PDCCH-based PDSCH transmission, a CORESET for scheduling DCI of the serving TRP (TRP #0) is separated from CORESETs for scheduling DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Further, in single PDCCH-based NC-JT, single DCI schedules a single PDSCH having a plurality of layers instead of scheduling a plurality of PDSCHs, and the plurality of layers may be transmitted from a plurality of TRPs. At this time, the correlation between the layer and the TRP transmitting the corresponding layer may be indicated through a transmission configuration indicator (TCI) indication for the layer.

In embodiments of the disclosure, the “cooperative TRP” may be replaced by various terms such as a “cooperative panel” or a “cooperative beam” when actually applied.

In embodiments of the disclosure, “the case in which NC-JT is applied” may be variously interpreted as “the case in which the UE simultaneously receives one or more PDSCHs in one BWP”, “the case in which the UE simultaneously receives PDSCHs, based on two or more transmission configuration indicator (TCI) indications in one BWP”, and “the case in which the PDSCHs received by the UE are associated with one or more DMRS port groups” according to circumstances, but is used by one expression for convenience of explanation.

In the disclosure, the wireless protocol structure for NC-JT may be variously used according to a TRP development scenario. For example, when there is no backhaul delay between cooperative TRPs or there is a small backhaul delay, a method (CA-like method) using a structure based on MAC layer multiplexing can be used similarly to reference numeral S10 of FIG. 15. On the other hand, when the backhaul delay between cooperative TRPs is too large to be ignored (e.g., when a time of 2 ms or longer is needed to exchange information such as CSI, scheduling, and HARQ-ACK between cooperative TRPs), a method (DC-like method) of securing a characteristic robust to a delay can be used through an independent structure for each TRP from an RLC layer similarly to reference numeral S20 of FIG. 15.

The UE supporting C-JT/NC-JT may receive a C-JT/NC-JT-related parameter or a setting value from a higher layer configuration and set an RRC parameter of the UE based thereon. For the higher layer configuration, the UE may use a UE capability parameter, for example, tci-StatePDSCH. The UE capability parameter, for example, tciStatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 refers to a value indicated by maxNumberConfiguredTCIstatesPerCC within the parameter tci-StatePDSCH which is included in capability signaling of the UE. As described above, a series of configuration processes from the higher layer configuration to the MAC CE configuration may be applied to a beamforming indication or a beamforming change command for at least one PDSCH in one TRP.

### [Multi-DCI-Based Multi-TRP]

According to an embodiment of the disclosure, a downlink control channel for NC-JT transmission may be configured based on a multi-PDCCH.

In NC-JT based on multiple PDCCHs, there may be a CORESET or a search space separated for each TRP when DCI for scheduling the PDSCH of each TRP is transmitted. The CORESET or the search space for each TRP can be configured according to at least one of the following configuration cases.
A configuration of a higher-layer index for each CORESET: CORESET configuration information configured by a higher layer may include an index value, and a TRP for transmitting a PDCCH in the corresponding CORESET may be distinguished by the configured index value for each CORESET. That is, in a set of CORESETs having the same higher-layer index value, the same TRP may be considered to transmit the PDCCH or the PDCCH for scheduling the PDSCH of the same TRP may be considered to be transmitted. The index for each CORESET may be named CORESETPoolIndex, and it may be considered that the PDCCH is transmitted from the same TRP in CORESETs in which the same CORESETPoolIndex value is configured. In the CORESET in which the same CORESETPoolIndex value is not configured, a default value of CORESETPoolIndex may be considered to be configured, and the default value may be 0.
A configuration of multiple PDCCH-Config: a plurality of PDCCH-Config are configured in one BWP, and each PDCCH-Config may include a PDCCH configuration for each TRP. That is, a list of CORESETs for each TRP and/or a list of search spaces for each TRP may be included in one PDCCH-Config, and one or more CORESETs and one or more search spaces included in one PDCCH-Config may be considered to correspond to a specific TRP.
A configuration of a CORESET beam/beam group: a TRP that corresponds to the corresponding CORESET may be distinguished through a beam or a beam group configured for each CORESET. For example, when the same TCI state is configured in a plurality of CORESETs, the corresponding CORESETs may be considered to be transmitted through the same TRP or a PDCCH for scheduling a PDSCH of the same TRP may be considered to be transmitted in the corresponding CORESET.
A configuration of a search space beam/beam group: a beam or a beam group is configured for each search space, and a TRP for each search space may be distinguished therethrough. For example, when the same beam/beam group or TCI state is configured in a plurality of search spaces, the same TRP may be considered to transmit the PDCCH in the corresponding search space or a PDCCH for scheduling a PDSCH of the same TRP may be considered to be transmitted in the corresponding search space.

As described above, by separating the CORESETs or search spaces for each TRP, it is possible to divide PDSCHs and HARQ-ACK information for each TRP and accordingly to generate an independent HARQ-ACK codebook for each TRP and use an independent PUCCH resource.

The configuration may be independent for each cell or BWP. For example, while two different CORESETPoolIndex values may be configured in the PCell, no CORESETPoolIndex value may be configured in a specific SCell. In this case, NC-JT may be configured in the PCell, but NC-JT may not be configured in the SCell in which no CORESETPoolIndex value is configured.

### [Single-DCI-Based Multi-TRP]

According to an embodiment of the disclosure, a downlink beam for NC-JT transmission may be configured based on a single-PDCCH.

In single PDCCH-based NC-JT, PDSCH transmitted by a plurality of TRPs may be scheduled by one piece of DCI. At this time, as a method of indicating the number of TRPs transmitting the corresponding PDSCHs, the number of TCI states may be used. That is, single PDCCH-based NC-JT may be considered when the number of TCI states indicated by the DCI for scheduling the PDSCHs is 2, and single-TRP transmission may be considered when the number of TCI states is 1. The TCI states indicated by the DCI may correspond to one or two TCI states among TCI states activated by the MAC CE. When the TCI states of DCI correspond to two TCI states activated by the MAC CE, a TCI codepoint indicated by the DCI is associated with the TCI states activated by the MAC CE, and here, the number of TCI states activated by the MAC CE, corresponding to the TCI codepoint, may be 2.

The above configuration may be independent for each cell or for each BWP. For example, a PCell may have at most two activated TCI states corresponding to one TCI codepoint, while a particular SCell may have at most one activated TCI state corresponding to one TCI codepoint. In this case, it may be considered that NC-JT is configured for the PCell, while NC-JT is not configured for the SCell described above.

### [PHR]

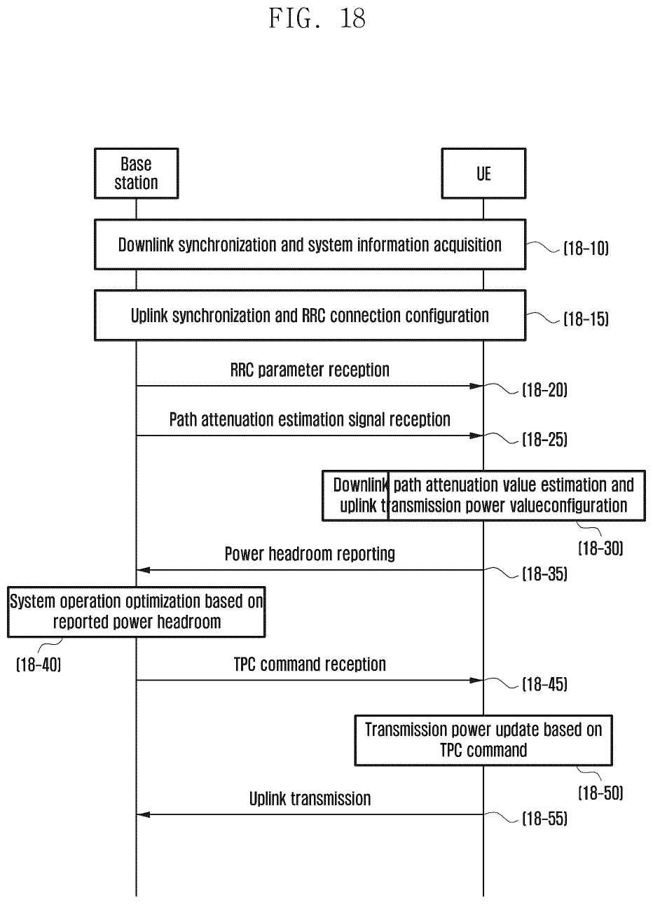

FIG. 18 illustrates a process in which a base station controls transmission power of a UE in a wireless communication system according to an embodiment of the disclosure.

Referring to FIG. 18, in operation 18-10, UEs in the coverage of a base station may perform downlink synchronization with the base station and acquire system information. According to some embodiments, downlink synchronization may be performed through a synchronization signal primary synchronization signal/secondary synchronization signal (PSS/PSS) received from the base station. UEs having performed downlink synchronization may receive a master information block (MIB) and a system information block (SIB) and acquire system information. In operation 18-15, the UE may perform uplink synchronization with the base station through a random access procedure and configure a radio resource control (RRC) connection. In the random access procedure, the UE may transmit a random access preamble and message 3 (msg3) to the base station through the uplink. During transmission of the random access preamble and message 3, uplink transmission power may be controlled. Specifically, the UE may receive parameters for controlling uplink transmission power from the base station through the acquired system information, for example, the SIB or may control uplink transmission power by using appointed parameters. In another embodiment of the disclosure, the UE may measure reference signal received power (RSRP) from a path attenuation estimation signal transmitted by the base station and estimate a downlink path attenuation value as shown in Equation 7. In addition, the UE may configure an uplink transmission power value for transmitting the random access preamble and message 3, based on the estimated path attenuation value.

Downlink path attenuation=transmission power of signal of base station—RSRP measured by UE. Equation 7

In Equation 7, transmission power of the signal of the base station may refer to transmission power of a downlink path attenuation estimation signal transmitted by the base station. The downlink path attenuation estimation signal transmitted by the base station may be a cell-specific reference signal (CRS) or a synchronization signal block (SSB). When the path attenuation estimation signal is a cell-specific reference signal (CRS), transmission power of the signal of the base station may refer to transmission power of the CRS and may be transmitted to the UE through a parameter referenceSignalPower of system information. When the path attenuation estimation signal is a synchronization signal block (SSB), transmission power of the signal of the base station may refer to transmission power of a demodulation reference signal (DMRS) transmitted through a secondary synchronization signal (SSS) and a PBCH and may be transmitted to the UE through a parameter ss-PBCH-BlockPower of system information.

In operation 18-20, the UE may receive RRC parameters for controlling uplink transmission power from the base station through UE-specific RRC or common RRC. The received transmission power control parameters may be different according to the type of an uplink channel transmitted through the uplink and type of a signal. In other words, transmission power control parameters applied to transmission of an uplink control channel (physical uplink control channel (PUCCH)), an uplink data channel (physical uplink shared channel (PUSCH)), and a sounding reference signal (SRS) may be different from each other. In addition, as described above, transmission power control parameters which the UE receives from the base station through the SIB before the RRC connection configuration or transmission power control parameters used by the UE as pre-appointed values before the RRC connection configuration may be included in RRC parameters transmitted from the base station after the RRC connection configuration. The UE may use the RRC parameter value received from the base station after the RRC connection configuration to control uplink transmission power.

In operation 18-25, the UE may receive a path attenuation estimation signal from the base station. More specifically, the base station may configure a channel state information-reference signal (CSI-RS) as the path attenuation estimation signal of the UE after the RRC connection configuration of the UE. In this case, the base station may transmit information on transmission power of the CSI-RS to the UE through a parameter powerControlOffsetSS of UE-dedicated RRC information. At this time, powerControlOffsetSS may refer to a transmission power offset between the SSB and the CSI-RS.

In operation 18-30, the UE may estimate the downlink path attenuation value and configure the uplink transmission power value. More specifically, the UE may measure downlink RSRP by using the CSI-RS and estimate the downlink path attenuation value through Equation 7, by using information on transmission power of the CSI-RS received from the base station. In addition, the UE may configure the uplink transmission power value for transmitting a PUCCH, a PUSCH, and an SRS, based on the estimated path attenuation value.

In operation 18-35, the UE may transmit power headroom reporting (PHR) to the base station. The power headroom may be a difference between current transmission power of the UE and maximum output power of the UE.

In operation 18-40, the base station may optimize the operation of a system, based on the reported power headroom. For example, when a power headroom value which a specific UE reports to the base station is a positive value, the base station may allocate the larger number of resource blocks (RBs) to the corresponding UE to increase a system yield.

In operation 18-45, the UE may receive a transmission power control (TCP) command from the base station. For example, when the power headroom value which the specific UE reports to the base station is a negative value, the base station may allocate the smaller number of resources to the corresponding UE or reduce transmission power of the corresponding UE through the transmission power control command (TPC). Accordingly, it is possible to increase a system yield or decrease unnecessary power consumption of the UE.

In operation 18-50, the UE may update transmission power, based on the TPC command. The TPC command may be transmitted to the UE through UE-specific DCI or group command DCI. Accordingly, the base station may dynamically control transmission power of the UE through the TPC command. In operation 18-55, the UE may perform uplink transmission, based on the updated transmission power.

### [PUSCH Power Control]

PUSCH transmission power may be determined through Equation 8 below.

$$Equation 8$$

$${P}_{PUCCH} ( i , j , {q}_{d} , l ) = min \{ \begin{matrix}{P}_{CMAX , f , c} ( i ) , \\ \begin{matrix}{P}_{{0}_{PUCCH} , b , f , c} ( j ) + 10 {log}_{10} ( {2}^{μ} \cdot {M}_{RB , b , f , c}^{PUCCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ]$$

In Equation 8, P_{CMAx,f,c}(i) denotes maximum transmission power configured in the UE for a carrier f of a serving cell c at a PUSCH transmission time point i. P₀_{_{PUsCH}}_{b,f,c}(j) denotes a reference configuration transmission power configuration value according to an activated uplink bandwidth part (BWP) b of the carrier f of the serving cell c and has different values according to various transmission types j. The values may be various according to the case in which PUSCH transmission is a message 3 PUSCH for random access, the case in which a PUSCH is a configured grant PUSCH, or a scheduled PUSCH. M_{RB,b,f,c}^{PUSCH}(i) denotes the size of a frequency to which the PUSCH is allocated. α_{b,f,c}(j) denotes a compensation rate degree value for path loss of UL BWP b of the carrier f of the serving cell c, and may be configured by a higher layer signal and may have different values according to j. PL_{b,f,c} (q) denotes a downlink path loss estimation value of the UL BWP b of the carrier f of the serving cell c and may use a value measured through a reference signal in an activated downlink BWP. The reference signal may be an SS/PBCH block or a CSI-RS. As shown in Equation 7, the downlink path loss may be calculated. In another embodiment of the disclosure, PL_{b,f,c}(q_{d}) denotes a downlink path attenuation value and corresponds to path attenuation calculated by the UE as shown in Equation 7. The UE calculates path attenuation, based on reference signal resources associated with the SS/PBCH block or the CSI-RS according to whether a higher layer signal is configured. For the reference signal resources, one of a plurality of reference signal resource sets is selected by a higher layer signal or an L1 signal, and the UE calculates path attenuation, based on the reference signal resources. Δ_{TF,b,f,c}(i) denotes a value determined by a modulation and coding scheme (MCS) value of the PUSCH at the PUSCH transmission time point i of the UL BWP b of the carrier f of the serving cell c. f_{b,f,c}(i,l) denotes a power control adaption value and may dynamically control a power value by a TPC command.

The TPC command is divided into an accumulated mode and an absolute mode, and one of the two modes is determined by a higher layer signal. In the accumulated mode, the currently determined power control adaption value is accumulated on a value indicated by the TPC command and may increase or decrease according to the TPC command, and the relation of f_{b,f,c}(i,l)=f_{b,f,c}(i−i₀, l)+Σδ_{PUSCH,b,f,c} is established. δ_{PUSCH,b,f,c} is a value indicated by the TPC command. In the absolute mode, the value is determined by the TPC command regardless of the currently determined power control adaption value, and the relation of f_{b,f,c}(i, l)=δ_{PUSCH,b,f,c} is established. Table 43 below shows values which can be indicated by the TPC commands.

TABLE 43

| | Accumulated | Absolute |
|---|---|---|
| | δ_{PUSCH, b, f, c} | δ_{PUSCH, b, f, c} |
| TPC | or | or |
| Command | δ_{SRS, b, f, c} | δ_{SRS, b, f, c} |
| Field | [dB] | [dB] |
| 0 | −1 | −4 |
| 1 | 0 | −1 |
| 2 | 1 | 1 |
| 3 | 3 | 4 |

### [PUCCH Power Control]

Equation 9 is an equation of determining PUCCH transmission power:

$$Equation 9$$

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{{0}_{PUCCH} , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{{F}_{PUCCH}} ( i ) + {Δ}_{TF , b , f , c} ( i ) + {f}_{b , f , c} ( i , l )\end{matrix}\end{matrix} \} [ dBm ]$$

In Equation 9, P₀_{_{PUCCH}}_{,b,f,c}(qᵤ) denotes a reference configuration transmission power configuration value, and may have different values according to various transmission types q_{U} and be changed by a higher layer signal such as RRC or an MAC CE. When the value is changed by the MAC CE and a slot for transmitting HARQ-ACK is k with respect to a PDSCH having received the MAC CE, the UE determines that the corresponding value is applied starting at a slot (k+k_{offset}). K_{offset} may have different values according to subcarrier spacing and have, for example, 3 ms. M_{RB,b,f,c}^{PUCCH}(i) denotes the size of a frequency resource area to which the PUCCH is allocated. PL_{b,f,c}(q_{d}) denotes a path attenuation estimation value of the UE and is calculated by the UE, based on a specific reference signal among various CSI-RSs or SS/PBCHs according to whether a higher layer signal is configured and according to the type thereof as shown in Equation 7. The same q_{d} is applied to repeated transmission PUCCHs. The same qᵤ is applied to repeated transmission PUCCHs.

### [HARQ-ACK: Related to Type 1 (Semi-Static) Codebook]

In a situation where the number of HARQ-ACK PUCCHs which the UE can transmit in one slot is limited to one, when a semi-static HARQ-ACK codebook higher configuration is received by the UE, the UE receives a PDSCH in an HARQ-ACK codebook in a slot indicated by the value of a PDSCH-to-HARQ feedback timing indicator in DCI format 1_0 or DCI format 1_1, or report HARQ-ACK information for SPS PDSCH release in the slot. The UE reports an HARQ-ACK information bit value, as a NACK, in an HARQ-ACK codebook in a slot that is not indicated by a PDSCH-to-HARQ feedback timing indicator field in DCI format 1_0 or DCI format 1_1. In case that the UE reports only HARQ-ACK information for one SPS PDSCH release or one PDSCH reception in MA,C cases for candidate PDSCH reception, and the report is scheduled by DCI format 1_0 including information indicating that a counter DACI field is 1 in a Pcell, the UE determines one HARQ-ACK codebook for the SPS PDSCH release or the PDSCH reception.

Other than the above case, an HARQ-ACK codebook determination method according to the below methods is employed.

When a set of PDSCH reception candidate occasions in serving cell c is MA,c, MA,c may be obtained through the [pseudo-code 1] stages below.

### [Pseudo-Code 1 Start]

Stage 1: initializing j to 0, and initializing MA,c to an empty set. Initializing k, which is an HARQ-ACK transmission timing index, to 0.

Stage 2: configuring R as a set of rows of a table including information of a slot to which a PDSCH is mapped, start symbol information, and information of the number or length of symbols. When a PDSCH-available mapping symbol indicated by a value of R is configured to a UL symbol according to DL and UL configurations configured through higher layer, removing a corresponding row from R.

Stage 3-1: In case that the UE is able to receive one unicast PDSCH in one slot, and when R is not an empty set, adding one PDSCH to set MA,c.

Stage 3-2: In case that the UE is able to receive two or more unicast PDSCHs in one slot, counting the number of PDSCHs allocatable in different symbols from the calculated R, and adding the counted number of PDSCHs to MA,c.

Stage 4: increasing k by one and restarting from stage 2.

### [Pseudo-Code 1 End]

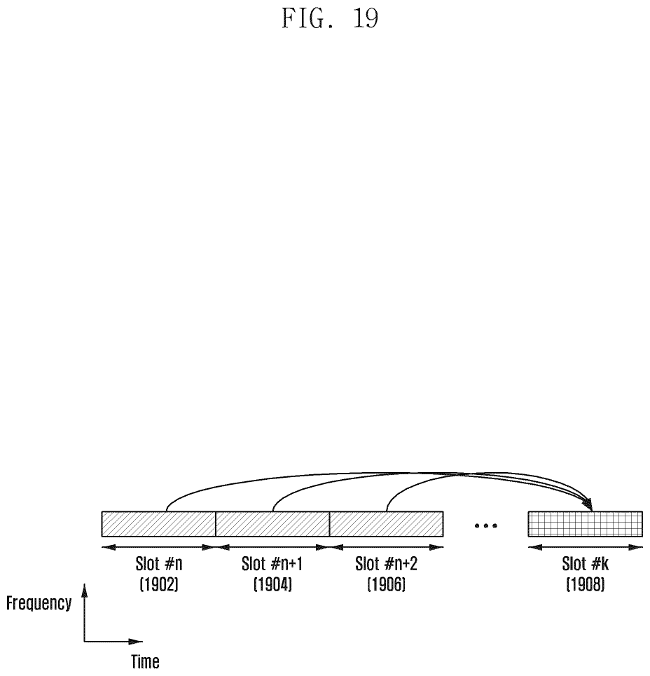

FIG. 19 illustrates a procedure in which a UE generates a Type-1 (semi-static) HARQ-ACK codebook according to an embodiment of the disclosure.

In pseudo-code 1, as illustrated in FIG. 19, in order to transmit an HARQ-ACK PUCCH in slot #k 1908, all slot candidates in which a PDSCH-to-HARQ-ACK timing which can indicate slot #k 1908 is possible are considered. Referring to FIG. 19, it is assumed that HARQ-ACK transmission is possible in slot #k 1908 by a combination of PDSCH-to-HARQ-ACK timings that are possible by only PDSCHs scheduled in slot #n 1902, slot #(n+1) 1904, and slot #(n+2) 1906. By considering time domain resource configuration information of a PDSCH which can be scheduled in each of the slots 1902, 1904, and 1906, and information indicating whether a symbol in a slot corresponds to the uplink or the downlink, the number of PDSCHs which can be maximally scheduled for each slot is derived. For example, when two PDSCHs can be maximally scheduled in the slot 1902, three PDSCHs can be maximally scheduled in the slot 1904, and two PDSCHs can be maximally scheduled in the slot 1906, the maximum number of PDSCHs included in an HARQ-ACK codebook transmitted in the slot 1908 is 7. This is called the cardinality of an HARQ-ACK codebook.

In a particular slot, stage 3-2 will be described through Table 44 below (default PDSCH time domain resource allocation A for normal CP).

TABLE 44

| Row | dmrs-TypeA- | PDSCH | | | | | |
|---|---|---|---|---|---|---|---|
| index | Position | mapping type | K₀ | S | L | Ending | Order |
| 1 | 2 | Type A | 0 | 2 | 12 | 13 | 1x |
| | 3 | Type A | 0 | 3 | 11 | 13 | 1x |
| 2 | 2 | Type A | 0 | 2 | 10 | 11 | 1x |
| | 3 | Type A | 0 | 3 | 9 | 11 | 1x |
| 3 | 2 | Type A | 0 | 2 | 9 | 10 | 1x |
| | 3 | Type A | 0 | 3 | 8 | 10 | 1x |
| 4 | 2 | Type A | 0 | 2 | 7 | 8 | 1x |
| | 3 | Type A | 0 | 3 | 6 | 8 | 1x |
| 5 | 2 | Type A | 0 | 2 | 5 | 6 | 1x |
| | 3 | Type A | 0 | 3 | 4 | 6 | 1x |
| 6 | 2 | Type B | 0 | 9 | 4 | 12 | 2x |
| | 3 | Type B | 0 | 10 | 4 | 13 | 3 |
| 7 | 2 | Type B | 0 | 4 | 4 | 7 | 1x |
| | 3 | Type B | 0 | 6 | 4 | 9 | 2 |
| 8 | 2, 3 | Type B | 0 | 5 | 7 | 11 | 1x |
| 9 | 2, 3 | Type B | 0 | 5 | 2 | 6 | 1x |
| 10 | 2, 3 | Type B | 0 | 9 | 2 | 10 | 2x |
| 11 | 2, 3 | Type B | 0 | 12 | 2 | 13 | 3x |
| 12 | 2, 3 | Type A | 0 | 1 | 13 | 13 | 1x |
| 13 | 2, 3 | Type A | 0 | 1 | 6 | 6 | 1x |
| 14 | 2, 3 | Type A | 0 | 2 | 4 | 5 | 1 |
| 15 | 2, 3 | Type B | 0 | 4 | 7 | 10 | 1x |
| 16 | 2, 3 | Type B | 0 | 8 | 4 | 11 | 2x |

Table 44 is a time resource allocation table by which a UE operates in the default mode before a time resource is allocated for the UE through a separate RRC signal. For reference, in addition to a row index value being separately indicated by RRC, a PDSCH time resource allocation value is determined by a dmrs-TypeA-Position, which is a UE-common RRC signal. In Table 44, the ending column and the order column are separately added for convenience of explanation, and it is possible that the two columns do not actually exist. The ending column implies the ending symbol of a scheduled PDSCH, and the order column implies the position value of a code located in a particular codebook in a semi-static HARQ-ACK codebook. Table 44 is applied to time resource allocation applied to DCI format 1_0 of a common search region of a PDCCH.

The UE performs the following stages to calculate the maximum number of PDSCHs that do not overlap in a particular slot, so as to determine an HARQ-ACK codebook.

Stage 1: Search for a PDSCH allocation value indicating the first ended PDSCH in a slot among all rows in a PDSCH time resource allocation table. In Table 44, it may be noted that row index 14 is ended first. Row index 14 is expressed by 1 in the order column. Other row indexes that overlap row index 14, by at least one symbol, are expressed by 1× in the order column.

Stage 2: Search for a PDSCH allocation value indicating the first ended PDSCH among the remaining row indexes which are not expressed in the order column. In Table 44, the PDSCH allocation value corresponds to the row indicated by row index 7 and the dmrs-TypeA-Position value, which is 3. In addition, other row indexes that overlap the corresponding row index, by at least one symbol, are expressed by 2× in the order column.

Stage 3: Repeat stage 2, and increasing and displaying the order values. For example, in Table 44, a PDSCH allocation value is found that indicates the first ended PDSCH among the row indexes which are not expressed in the order column. In Table 44, the PDSCH allocation value corresponds to the row indicated by row index 6 and the dmrs-TypeA-Position value, which is 3. In addition, other row indexes overlapping the corresponding row index, by at least one symbol, are expressed by 3× in the order column.

Stage 4: When the order is expressed for all the row indexes, the procedure is ended. In addition, the size of a corresponding order corresponds to the maximum number of PDSCHs that can be scheduled in a corresponding slot without time overlap. Scheduling without time overlap implies that different PDSCHs are scheduled by TDM.

In the order column of Table 44, the maximum order value implies an HARQ-ACK codebook size of a corresponding slot, and an order value implies an HARQ-ACK codebook point at which an HARQ-ACK feedback bit for a corresponding scheduled PDSCH is positioned. For example, row index 16 in Table 44 implies that the HARQ-ACK feedback bit exists in the second code position in a semi-static HARQ-ACK codebook, the size of which is 3. If a set of occasions for candidate PDSCH receptions in serving cell c is M_{A,c}, a UE transmitting an HARQ-ACK feedback may obtain M_{A,c}, through the [pseudo-code 1] or [pseudo-code 2] stages. M^{A,c}, may be used to determine the number of HARQ-ACK bits that the UE is required to transmit. Specifically, an HARQ-ACK codebook may be configured by using the cardinality of a M^{A,c} set.

As another example, the considerations for determination of a semi-static HARQ-ACK codebook (or type 1 HARQ-ACK codebook) may be as below.

a) on a set of slot timing values K₁ associated with the active UL BWP
a) If the UE is configured to monitor PDCCH for DCI format 1_0 and is
not configured to monitor PDCCH for DCI format 1_1 on serving cell c,
K₁ is provided by the slot timing values { 1, 2, 3, 4, 5, 6, 7, 8} for DCI
format 1_0
b) If the UE is configured to monitor PDCCH for DCI format 1_1 for
serving cell c, K₁ is provided by dl-DataToUL-ACK for DCI format 1_1
b) on a set of row indexes R of a table that is provided either by a first
set of row indexes of a table that is provided by PDSCH-
TimeDomainResourceAllocationList in PDSCH-
ConfigCommon or by Default PDSCH time domain resource allocation
A [6, TS 38.214], or by the union of the first set of row indexes and a
second set of row indexes, if provided by PDSCH-
TimeDomainResourceAllocationList in PDSCH-Config, associated with
the active DL BWP and defining respective sets of slot offsets K₀, start
and length indicators SLIV, and PDSCH mapping types for PDSCH
reception as described in [6, TS 38.214]
c) on the ratio 2^{^{μ}}^{DL}^{^{-μ}}^{UL} between the downlink SCS configuration
μ_{DL} and the uplink SCS configuration μ_{UL} provided by subcarrierSpacing
in BWP-Downlink and BWP-Uplink for the active DL BWP and the
active UL BWP, respectively
d) if provided, on TDD-UL-DL-ConfigurationCommon and TDD-UL-
DL-ConfigDedicated as described in Subclause 11.1.

As another example, a pseudo-code for determination of an HARQ-ACK codebook may be as below.

```
  [pseudo-code 2 start]
  For the set of slot timing values K₁, the UE determines a set of M_{A,c}
occasions for candidate PDSCH receptions or SPS PDSCH releases according to the
following pseudo-code. A location in the Type-1 HARQ-ACK codebook for HARQ-
ACK information corresponding to a SPS PDSCH release is same as for a
corresponding SPS PDSCH reception.
  Set j=O - index of occasion for candidate PDSCH reception or SPS PDSCH
release
  Set B=Ø
  Set M_{A,c}=Ø
  Set c(K₁) to the cardinality of set K₁
  Set k =0 - index of slot timing values K_{1,k}, in descending order of the slot
timing values, in set K₁ for serving cell c
  while k<c(K₁)
        if mod(n_{U}−K_{1,k}+1, max(2^{μ}^{_{UL}}^{-μ}^{_{DL}},1))=0
    Set n_{D}=O - index of a DL slot within an UL slot
    while n_{D}<max(2^{μ}^{_{DL}}^{-μ}^{_{UL}},1)
      Set R to the set of rows
      Set c(R) to the cardinality of R
      Set r=0 - index of row in set R
      if slot n_{U} starts at a same time as or after a slot for an active
DL BWP change on serving cell c or an active UL BWP change on the PCell and slot
└ (n_{U}−K_{1,k})*2^{μ}^{_{DL}}^{-μ}^{_{UL}} ┘ +n_{D} is before the slot for the active DL BWP change on
serving cell c or the active UL BWP change on the PCell
        continue;
      else
        while r<c(R)
          if the UE is provided TDD-UL-DL-
ConfigurationCommon or TDD-UL-DL-ConfigDedicated and, for each slot from slot
└ (n_{U}−K_{1,k})*2^{μ}^{_{DL}}^{-μ}^{_{UL}} ┘ +n_{D}−N_{PDSCH}^{repeat}+1 to slot └ (n_{U}−K_{1,k})*2^{μ}^{_{DL}}^{-μ}^{_{UL}} ┘ +N_{D}, at least one
symbol of the PDSCH time resource derived by row r is configured as UL where
K_{1,k} is the k-th slot timing value in set K₁,
            R=R/r;
          end if
          r=r+1;
        end while
        if the UE does not indicate a capability to receive more
than one unicast PDSCH per slot and R ≠ Ø,
          M_{A,c}=M_{A,c} ∪j;
          j=j+1;
          The UE does not expect to receive SPS PDSCH
release and unicast PDSCH in a same slot;
        else
          Set c(R) to the cardinality of R
          Set m to the smallest last OFDM symbol index,
as determined by the SLIV, among all rows of R
          while R≠Ø
            Set r=0
          while r<c(R)
            if S≤m for start OFDM symbol index
S for row r
              b_{r,k,n}_{_{D}}=j; - index of occasion
for candidate PDSCH reception or SPS PDSCH release associated with row r
              R=R/r;
              B=B ∪ b_{r,k,n}_{_{D}};
              end if
            r=r+1;
            end while
            M_{A,c}=M_{A,c} ∪j
            j=j+1;
            end if Set m to the smallest last OFDM symbol
index among all rows of R;
            end while
          end if
        end if
        n_{D}=n_{D}+1;
      end while
    end if
    k=k+1;
  end while
[pseudo-code 2 end]
```

In pseudo-code 2, the position of an HARQ-ACK codebook containing HARQ-ACK information for DCI indicating DL SPS release is based on the position at which a DL SPS PDSCH is received. For example, in case that the start symbol at which a DL SPS PDSCH starts to be transmitted is the fourth OFDM symbol based on a slot and has a length of 5 symbols, the HARQ-ACK information including a DL SPS release indicating the release of a corresponding SPS is determined under an assumption that as if a PDSCH starting from the 4th OFDM symbol of the slot in which the DL SPS release is transmitted and having a length of 5 symbols is mapped, and HARQ-ACK information corresponding thereto is determined through the PDSCH-to-HARQ-ACK timing indicator and PUSCH resource indicator included in the control information indicating the DL SPS release. As another example, in case that the start symbol at which a DL SPS PDSCH starts to be transmitted is the fourth OFDM symbol based on a slot and has a length of 5 symbols, the HARQ-ACK information including a DL SPS release indicating release of a corresponding SPS is determined under an assumption that as if the PDSCH starting from the fourth OFDM symbol of a slot indicated by a time domain resource allocation (TDRA) of DCI which is the DL SPS release and having a length of 5 symbols is mapped, and HARQ-ACK information corresponding thereto is determined through a PDSCH-to-HARQ-ACK timing indicator and a PUSCH resource indicator included in control information indicating the DL SPS release.

### [HARQ-ACK: Related to Type 2 (Dynamic) Codebook]

A UE transmits HARQ-ACK information transmitted in one PUCCH in a corresponding slot n, based on a PDSCH-to-HARQ feedback timing value for PUCCH transmission of HARQ-ACK information in slot n for PDSCH reception or SPS PDSCH release, and K0 that is transmission slot position information of a PDSCH scheduled by DCI format 1_0 or 1_1. Specifically, for the HARQ-ACK information transmission described above, the UE determines an HARQ-ACK codebook of a PUCCH transmitted in a slot determined by a PDSCH-to-HARQ feedback timing and K0, based on a DAI included in DCI indicating a PDSCH or SPS PDSCH release.

The DAI is configured by a counter DAI and a total DAI. The counter DAI is information indicating the position of HARQ-ACK information in a HARQ-ACK codebook, which corresponds to a PDSCH scheduled by DCI format 1_0 or DCI format 1_1. Specifically, a counter DAI value in DCI format 1_0 or 1_1 indicates the accumulative value of PDSCH receptions or SPS PDSCH releases scheduled by the DCI format 1_0 or 11 in particular cell c. The above accumulative value is configured based on a PDCCH monitoring occasion in which the scheduled DCI exists and a serving cell.

The total DAI is a value indicating the size of an HARQ-ACK codebook. Specifically, the total DAI value implies the total number of PDSCHs or SPS PDSCH releases which are scheduled at and before the time point at which DCI is scheduled. The total DAI is a parameter used in a case where, in a carrier aggregation (CA) situation, HARQ-ACK information in serving cell c also includes HARQ-ACK information for a PDSCH scheduled in another cell including serving cell c. In other words, there is no total DAI parameter in a system operated by one cell.

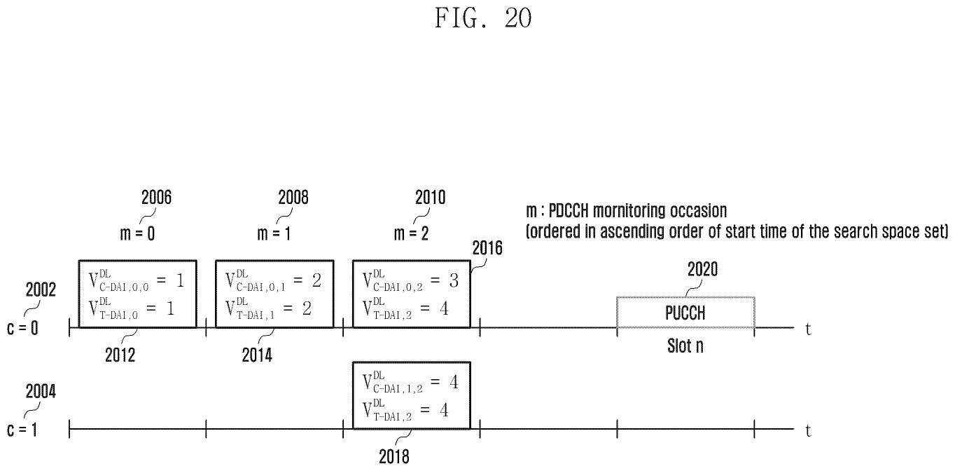

FIG. 20 illustrates a procedure in which a UE generates a Type-2 (dynamic) HARQ-ACK codebook according to an embodiment of the disclosure. An example of operation relating to the DAI is illustrated in FIG. 20.

Referring to FIG. 20, in a situation where two carriers are configured for a UE, when the UE transmits an HARQ-ACK codebook selected based on a DAI, through a PUCCH 2020 in an n-th slot of carrier 0 2002, the values of a counter DAI (C-DAI) and a total DAI (T-DAI) indicated by DCI discovered in each PDCCH monitoring occasion configured for each carrier are changed. First, in DCI discovered in an occasion 2006 indicated by m=0, each of the C-DAI and the T-DAI indicates a value of 1 (indicated by reference numeral 2012). In DCI discovered in an occasion 2008 indicated by m=1, each of the C-DAI and the T-DAI indicates a value of 2 (indicated by reference numeral 2014). In DCI discovered in an occasion 2010 indicated by m=2 in carrier 0 (c=0, 2002), the C-DAI indicates a value of 3 (indicated by reference numeral 2016). In DCI discovered in an occasion 2010 indicated by m=2 in carrier 1 (c=1, 2004), the C-DAI indicates a value of 4 (indicated by reference numeral 2018). If carriers 0 and 1 are scheduled in the same monitoring occasion, all the T-DAIs are indicated by a value of 4.

Referring to FIGS. 19 and 20, the determination of an HARQ-ACK codebook is operated in a situation where only one PUCCH containing HARQ-ACK information is transmitted in one slot. This operation is called mode 1. As an example of a method in which one PUCCH transmission resource is determined in one slot, when PDSCHs scheduled in different pieces of DCI are multiplexed on one HARQ-ACK codebook in the same slot, and the codebook is transmitted, a PUCCH resource selected for HARQ-ACK transmission is determined to be a PUCCH resource indicated by a PUCCH resource field indicated in DCI lastly scheduling a PDSCH. That is, a PUCCH resource indicated by a PUCCH resource field indicated in DCI scheduled before the DCI is ignored.

In the following description, HARQ-ACK codebook determination methods and apparatuses are defined in a situation where two or more PUCCHs containing HARQ-ACK information can be transmitted in one slot. This operation is called mode 2. A UE can operate only mode 1 (transmission of only one HARQ-ACK PUCCH in one slot) or operate only mode 2 (transmission of one or more HARQ-ACK PUCCHs in one slot). Alternatively, in a case of a UE supporting both mode 1 and mode 2, it may be possible that a base station configures the UE to be operated in only one mode by higher layer signaling, or that mode 1 and mode 2 are implicitly configured by a DCI format, an RNTI, a DCI particular field value, and scrambling. For example, a PDSCH scheduled by a DCI format A and pieces of HARQ-ACK information associated with the PDSCH are based on mode 1, and a PDSCH scheduled by a DCI format B and pieces of HARQ-ACK information associated with the PDSCH are based on mode 2. Whether the HARQ-ACK codebook described above is semi-static or dynamic is determined by an RRC signal.

### [Explanation of Satellite Communication Structure]

The characteristics of satellite communications are described below. Satellites for communication may be classified into low earth orbit (LEO), middle earth orbit (MEO), and geostationary earth orbit (GEO) according to the orbit of the satellite. Generally, the GEO refers to satellites with an altitude of approximately 36000 km, the MEO refers to satellites with an altitude of 5000 to 15000 km, and the LEO may refer to satellites with an altitude of 500 to 1000 km. Of course, communication satellites are not limited to the above examples. According to an embodiment of the disclosure, the orbital period of the Earth varies according to each altitude. In the case of GEO, the Earth's orbital period is about 24 hours, in the case of the MEO, the Earth's orbital period is about 6 hours, and in the case of the LEO, the Earth's orbital period is about 90 to 120 minutes. Low-Earth orbit (up to 2,000 km) satellites may have an advantage over geostationary orbit (36,000 km) satellites in terms of propagation delay (this may be understood as the time taken for a signal transmitted from a transmitter to reach a receiver) and losses due to their relatively low altitude.

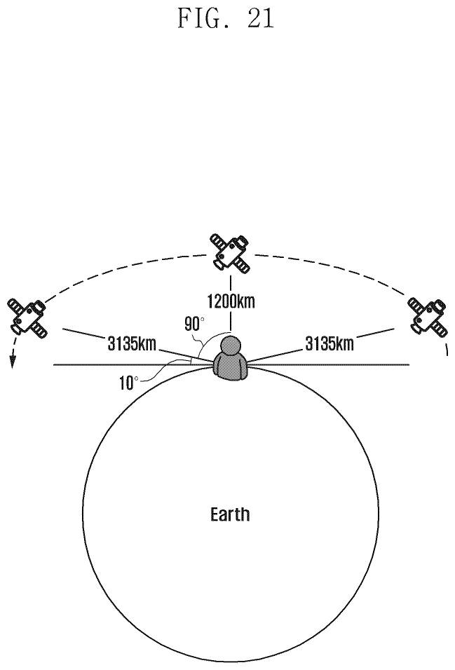

FIG. 21 illustrates the Earth orbital period of a communication satellite according to an altitude or height of the satellite according to an embodiment of the disclosure.

Referring to FIG. 21, assuming that a UE communicates with a satellite located at an altitude of 1200 km, the distance between the UE and the satellite may vary depending on the altitude angle between the satellite and the UE. For example, when the altitude angle between the satellite and the UE is 90 degrees, the distance between the UE and the satellite is 1200 km, but when the altitude angle between the satellite and the UE is 10 degrees, the distance between the UE and the satellite is about 3135 km. Therefore, in satellite communication, even if the UE is fixed, the distance between the satellite and the UE may vary due to the satellite orbiting periodically, such as a low-orbit satellite. In addition, since the distance between the UE and the satellite in satellite communication is much longer than the distance between the UE and the base station in terrestrial networks, it may be necessary to transmit control information and data information in the form of data transmission with a low code rate or repeated transmission.

### [OCC-Based PUCCH Transmission]

Hereinafter, a PUCCH transmission method using an orthogonal cover code (OCC) of a UE is described. LTE PUCCH format 5 is mainly used to deliver positive acknowledgement/negative acknowledgement (ACK/NACK) feedback for downlink data transmission by using one of signals transmitted in a PUCCH, which is an uplink control channel. In PUCCH format 5, the frequency-division multiple access (FDMA) and time-division multiple access (TDMA) methods are combined to classify signals transmitted from different UEs (i.e., OFDMA method), and cyclic shift techniques are used to transmit the signals. In order to implement these functions, LTE PUCCH format 5 applies OCC technology using orthogonality. The OCC is used to classify signals transmitted from different UEs, and each UE selects an OCC sequence based on a predefined OCC index and transmits the ACK/NACK bits covered by the corresponding sequence. Therefore, the PUCCH format 5 applying the OCC enables efficient control channel transmission in a multi-access environment, thereby improving the overall performance of the LTE system.

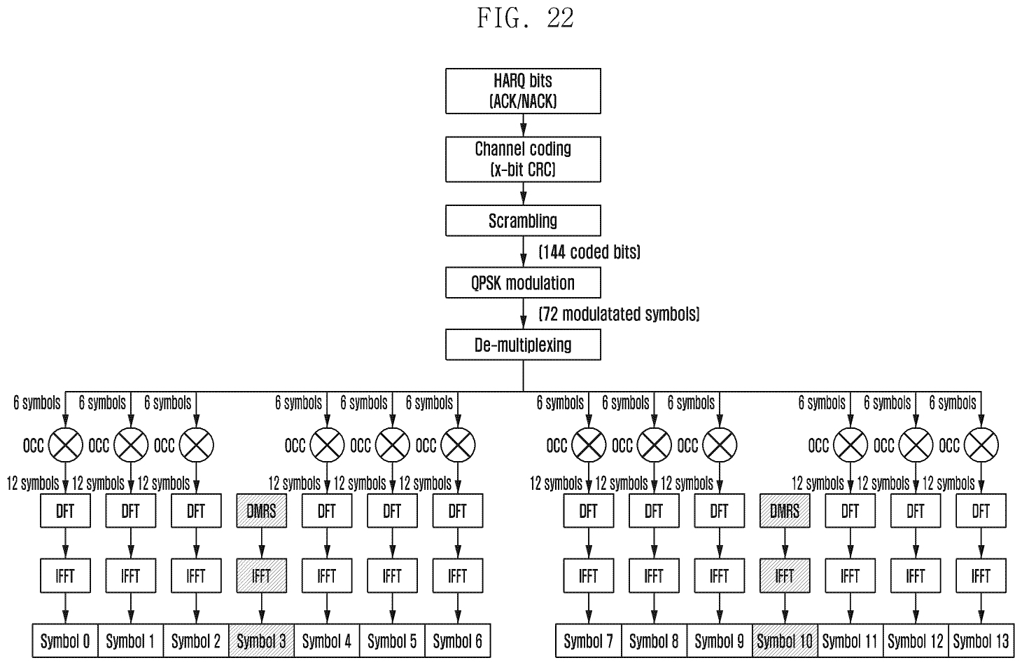

FIG. 22 is a block diagram illustrating a method of generating LTE PUCCH format 5 according to an embodiment of the disclosure.

Referring to FIG. 22, the UE generates HARQ ACK/NACK bits, and then performs a channel coding and scrambling process thereon to generate generates coded bits. In addition, the UE divides and allocates 72 modulated symbols to a total of 12 OFDM symbols through quadrature phase shift keying (QPSK) modulation and demultiplexing processes. The six modulated symbols allocated to each symbol are then mapped to 12 frequency tones through OCC spreading. The spreading scheme may be implemented such that QPSK modulation symbols are mapped to a larger number of virtual frequency tones. Accordingly, it may be possible to prevent signals of multiple users from interfering with each other.

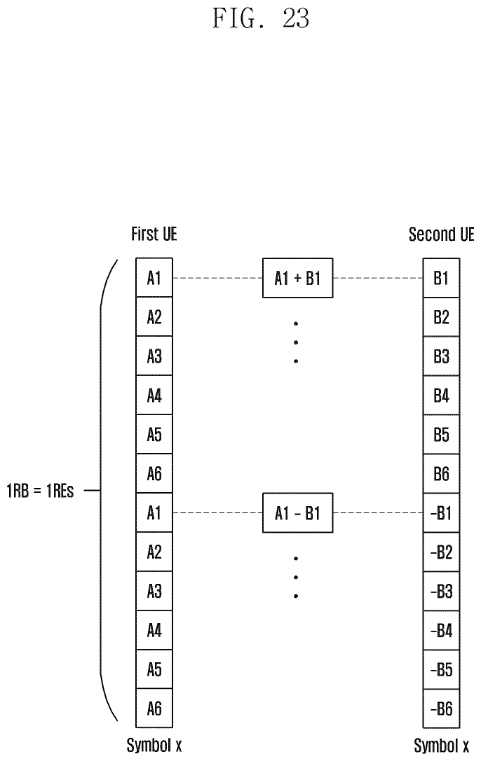

In other existing LTE PUCCH formats, 12 QPSK modulation symbols may be mapped to one resource block (RB) SC-FDMA symbol. However, in LTE PUCCH 5, only 6 QPSK modulation symbols are mapped to one RB and SC-FDMA symbol, as shown in FIG. 22. In addition, the code division multiplexing (CDM) index used by the spreading scheme is a value assigned to each user and may have a value of 0 or 1. This value determines how each user's signal is spread. For example, a user with a CDM index of 0 has his/her own signal mapped to 12 virtual frequency tones two times repeatedly, while a user with a CDM index of 1 has his/her own signal repeated twice, but half of them multiplied by −1 and mapped to 12 virtual frequency tones. This allows each user's signal to be spread over a wider bandwidth and it is possible to avoid interference with each other in a multi-user environment. Explanation of how interference can be avoided despite the use of the same time and frequency resources is further explained with reference to FIG. 23.

FIG. 23 illustrates a method by which different UEs perform mapping to virtual frequency tones by applying different OCC values according to an embodiment of the disclosure.

Referring to FIG. 23, a first UE repeatedly maps information of (A1, A2, A3, A4, A5, and A6) to 1RB. A second UE repeatedly maps information of (B1, B2, B3, B4, B5, and B6) to 1RB, wherein half of the information is multiplied by 1 and mapped and the other half of the information is multiplied by −1 and mapped. Thereafter, the first and second UEs transmit the information by performing the discrete Fourier transform (DFT) and inverse fast Fourier transform (IFFT) thereon. After receiving the information, the base station performs a de-spreading process, and may decode each of AI and B1, for example, based on a value of “(A1+B1)” and a value of “(A1-B1)”, respectively. As described above, the base station may decode the remaining pieces of information, that is, information of (A2, A3, A4, A5, and A6) of the first UE and information of (B2, B3, B4, B5, and B6) of the second UE. While FIGS. 22 and 23 illustrate an OCC spreading scheme in terms of a frequency axis as an example, it may be possible to apply an OCC spreading scheme in terms of a time axis. Furthermore, while a method of applying OCC sequences of (1, 1) and (1, −1) to two different UEs, based on an OCC length of 2, has been described with reference to FIGS. 22 and 23, it may be possible to consider sequences with an OCC length greater than 2, where two or more different UEs may transmit a PUCCH using the same time and frequency resources.

### [OCC-Based PUSCH Transmission]

Hereinafter, a PUSCH transmission method using the OCC scheme is described.

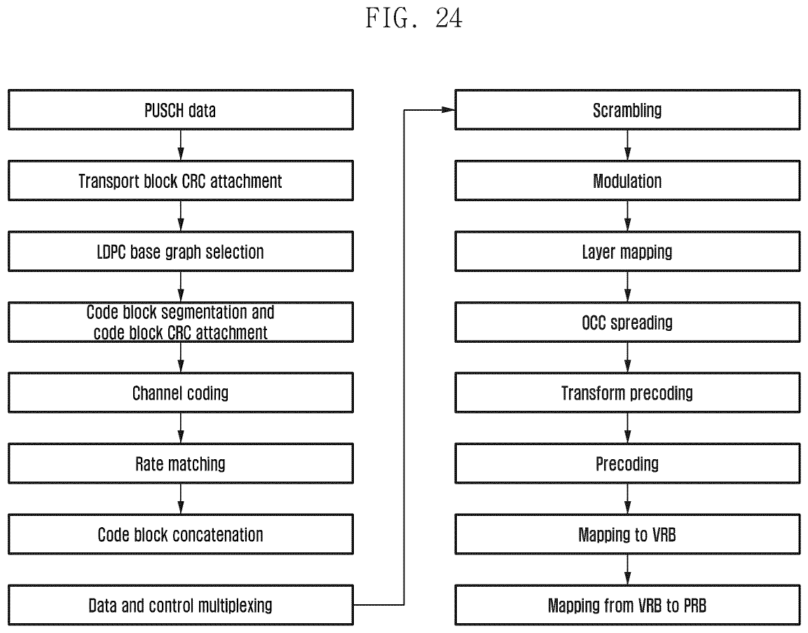

FIG. 24 is a flow diagram illustrating a UE processing procedure for PUSCH transmission according to an embodiment of the disclosure.

Referring to FIG. 24, when there is data for the UE to transmit to a base station, it may be possible to perform processing for PUSCH transmission through the following series of procedures. The following procedures are illustrative only and some of the following procedures may be omitted, or the order of the procedures may be changed to allow the UE to apply them.

Data block CRC attachment (Transport block CRC Attachment): Error check code attached to data

LDPC base graph selection: The appropriate LDPC graph is selected for channel coding.

Code block segmentation and CRC attachment: Data is segmented into smaller blocks and a CRC is attached to each block.

Channel Coding: Blocks are encoded to prevent transmission errors.

Rate Matching: Encoded data is mapped to match the available transport resources.

Code Block Concatenation: Encoded blocks are concatenated back together.

Data and Control Multiplexing: When a control resource overlaps with a data resource, the corresponding control information is multiplexed with the data information.

Scrambling: Data is scrambled to prevent predictable patterns that can degrade signal quality.

Modulation: The scrambled data is modulated by a carrier.

Layer mapping: Data is mapped over transport layers.

OCC spreading: OCC is applied to data mapped to a layer. FIG. 23 or other methods is applicable.

Transform Precoding: A frequency domain signal is reconstructed as a time domain signal through the discrete Fourier transform (DFT). This operation is particularly used in single transport layer scenarios and is used to improve signal orthogonality and reduce interference.

Precoding: This is a spatial processing operation that optimizes performance by adjusting the transformed signal before transmission. This operation involves applying, to the signal, a matrix that can improve the directionality of the signal and improve the reception of a receiver, and different antenna configurations and channel conditions are considered.

Mapping to virtual resource block (VRB): Data is mapped to virtual resource blocks in the frequency domain.

Mapping from RB to physical resource block (PRB): The virtual resource block is then mapped to a physical resource block for actual transmission.

In the above procedure, the OCC spreading scheme can be applied in different ways.

For example, when a UE transmits a PUSCH repeatedly for each slot, it may be possible to apply an OCC sequence for each slot.

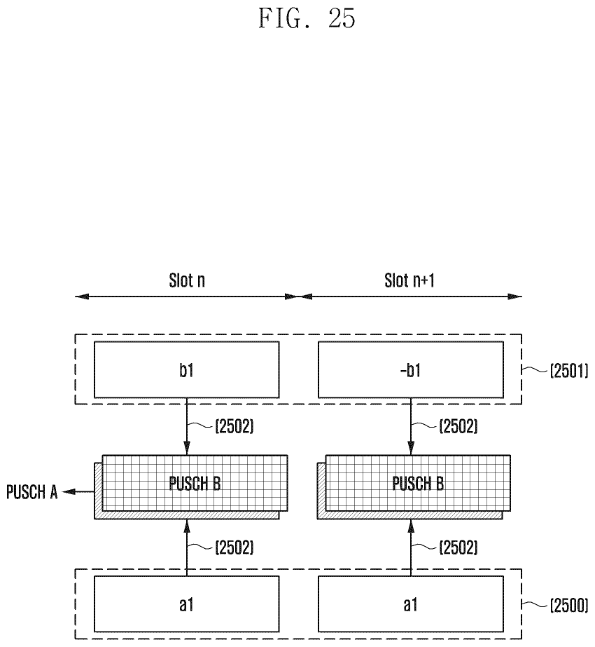

FIG. 25 illustrates a method of applying an OCC scheme when a UE performs PUSCH repeated transmission for each slot according to an embodiment of the disclosure.

In a situation where an OCC length has a value of 2, two different UEs repeatedly transmit PUSCHs through the same time and frequency resources. A first UE transmits PUSCH A, and a second UE transmits PUSCH B. The first UE generates identical data a1 (indicated by reference numeral 2500) and repeatedly transmits the data in slot n and slot (n+1) (indicated by reference numeral 2502). The second UE maps data b1 in slot n and maps −b1, obtained by multiplying data b1 by −1, in slot (n+1) (indicated by reference numeral 2501). In addition, the second UE transmits data b1 to PUSCH B in slot n and transmits data −b1 to PUSCH B in slot (n+1).

Referring to FIG. 25, PUSCH A and PUSCH B transmitted in slot n and slot (n+1) are shown to be transmitted by the first and second UEs through the same time and frequency resources, but it is possible that only some of the time and frequency resources overlap and other different time and frequency resources are used.

In addition, in FIG. 25, reference numerals 2500 and 2501 show conceptual diagrams to illustrate that data is not generated in slot n and slot (n+1), but is transmitted by the first and second UEs via a PUSCH. In reality, the data may be generated before slot n in which the PUSCH is first transmitted.

In FIG. 25, since the base station receives the information of (a1+b1) via PUSCH A and PUSCH B transmitted by the first and second UEs in slot n, and receives the information of (a1−b1) via PUSCH A and PUSCH B transmitted by the first and second UEs in slot (n+1), the base station may receive each of data a1 and b1 by applying the OCC de-spreading scheme to the received information of (a1+b1) and (a1−b1). Here, a1 and b1 refer to a set of symbols in which a series of data is channel-coded and modulated. Alternatively, a1 and b1 may be a set of data before DFT.

In order to apply the OCC scheme shown in FIG. 25, the base station may provide, to the UEs in advance, through a higher layer signal or a layer 1 (L1) signal, an indication of a value of the OCC sequence to be applied for each slot during PUSCH repeated transmission. For example, in the case of a second UE, when a DCI field called OCC index exists in the L1 signal and the corresponding value indicates a bit value corresponding to the OCC sequence (1, −1), the second UE may apply ‘1’ in slot n and apply ‘-1’ in slot (n+1). Specifically, in case that the DCI field called OCC index exists as one bit, if one bit has a value of 0, the OCC sequence may be indicated as (1,1), and if one bit has a value of 1, the OCC sequence may be indicated as (1,−1) or (−1,1). The OCC sequence type and DCI field size may be determined by a higher layer signal configuration. The length of the OCC sequence may use a value greater than the length of 2 described in the example above.

In addition, in FIG. 25, the first UE is described as applying the OCC sequence (1, 1), but regardless of this, the first UE may perform conventional PUSCH repeated transmission without applying the OCC sequence. Accordingly, in FIG. 25, the first UE may transmit or not the UE capability capable of applying the OCC spreading method. On the other hand, the second UE may apply the OCC spreading method only when the UE capability capable of applying the OCC spreading method is transmitted.

Although FIG. 25 illustrates a case where the first and second UEs apply two repeated transmissions, it is possible that the number of slots repeatedly transmitted could be four, eight, or more. In this case, when assuming that the OCC sequence (1, −1) applied by the second UE are repeatedly transmitted four times, it may be possible to apply b1 for slot n, −b1 for slot (n+1), b1 for slot (n+2), and −b1 for slot (n+3), or it may be possible to apply b1 for slot n, b1 for slot (n+1), −b1 for slot (n+2), and −b1 for slot (n+3). Alternatively, an OCC sequence of 1 (or −1) may always be applied to even-numbered slots, and an OCC sequence of −1 (or 1) may always be applied to odd-numbered slots. Alternatively, the OCC sequence may be applied by a modular operation. Since the OCC sequence (1, −1) has a length of 2, the OCC sequence value applied to the PUSCH in the nth slot may be 1 (or −1) if mod (n/2) has a value of 1, and may be −1 (or 1) if mod (n/2) has a value of 0.

In addition, although FIG. 25 illustrates that the first and second UEs start the same number of repeated transmissions from the same slot, this can be applied to the case in which the repeated transmission starts from different slots and/or different numbers of repeated transmissions are performed.

In another example, the UE may apply an OCC sequence for each PUSCH repeated transmission unit when performing PUSCH repeated transmission within one slot.

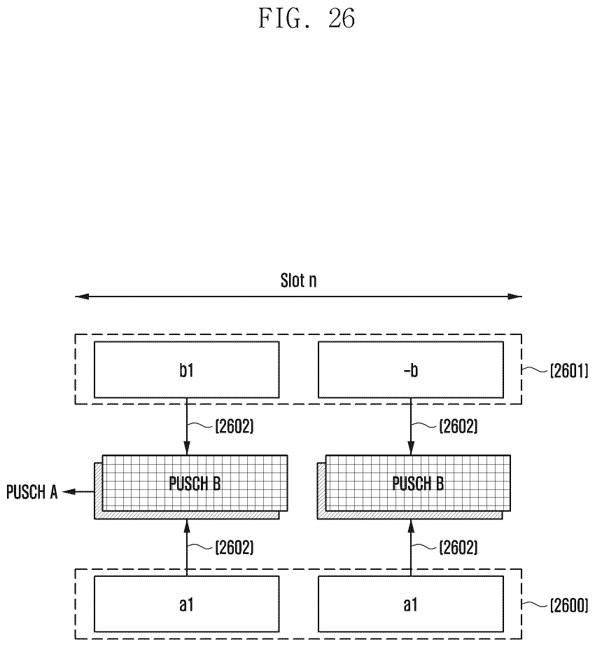

FIG. 26 illustrates a method of applying an OCC scheme when a UE performs PUSCH repeated transmission within one slot according to an embodiment of the disclosure.

The method according to an embodiment illustrated in FIG. 26 is essentially similar to the operation in FIG. 25. In a situation in which an OCC length has a value of 2, two different UEs transmit PUSCHs repeatedly using the same time and frequency resources. The first UE transmits PUSCH A, and the second UE transmits PUSCH B. The first UE generates identical data a1 (indicated by reference numeral 2600) and performs repeated transmission in one slot N (indicated by reference numeral 2602). The second UE maps data b1 to the first PUSCH B of slot n and maps data −b1, obtained by multiplying data b1 by −1, to the second PUSCH B of slot n. In addition, the second UE transmits data b1 to the first PUSCH B of slot n and data −b1 to the second PUSCH B of slot n.

Referring to FIG. 26, PUSCH A and PUSCH B transmitted in slot n are shown as being transmitted by the first UE and the second UE using the same time and frequency resources, but it is possible that only some of the time and frequency resources are overlapped and other different time and frequency resources are used. In addition, in FIG. 26, reference numerals 2600 and 2601 are conceptual diagrams to illustrate that data is not generated in slot n but is transmitted by the first UE and the second UE via PUSCH. In reality, the data may be generated before slot n in which the PUSCH is first transmitted. In FIG. 26, since the base station receives the information of (a1+b1) via the first PUSCH A and PUSCH B transmitted by each of the first UE and the second UE in slot n, and the information of (a1−b1) via the second PUSCH A and PUSCH B transmitted by each of the first UE and the second UE in slot n, the base station may receive each of data a1 and b1 by applying the OCC de-spreading scheme to the received information of (a1+b1) and (a1−b1). Here, a1 and b1 refer to a set of symbols in which a set of data is channel-coded and modulated. Alternatively, a1 and b1 may be a set of data before DFT.

In order to apply the OCC scheme as shown in FIG. 26, the base station may provide, to the UEs in advance, through a higher layer signal or L1 signal, an indication of a value of the OCC sequence to be applied for each slot during PUSCH repeated transmission. For example, in the case of a second UE, when a DCI field called OCC index exists in the L1 signal and the corresponding value indicates a bit value corresponding to the OCC sequence (1, −1), the second UE may apply ‘1’ in the first PUSCH and apply ‘-1’ in the second PUSCH. Specifically, the DCI field called OCC index exists as one bit, if one bit has a value of 0, the OCC sequence may be indicated as (1,1), and if one bit has a value of 1, the OCC sequence may be indicated as (1,−1) or (−1,1). The OCC sequence type and DCI field size may be determined by a higher layer signal configuration. The length of the OCC sequence may use a value greater than the length of 2 described in the example above.

In addition, in FIG. 26, the first UE is described as applying the OCC sequence (1, 1), but regardless of this, the first UE may perform conventional PUSCH repeated transmission without applying the OCC sequence. Accordingly, in FIG. 26, the first UE may transmit or not the UE capability capable of applying the OCC spreading method. On the other hand, the second UE may apply the OCC spreading method only when the UE capability capable of applying the OCC spreading method is transmitted.

Although FIG. 26 illustrates a case where the first and second UEs apply two repeated transmissions, it is also possible that the number of PUSCHs repeatedly transmitted could be four, eight, or more. In addition, it may also be possible for the PUSCH to be repeatedly transmitted over multiple slots rather than just one slot. In this case, when assuming that the OCC sequence (1, −1) applied by the second UE are repeatedly transmitted four times, it may be possible to apply b1 for first PUSCH, −b1 for second PUSCH, b1 for third PUSCH, and −b1 for fourth PUSCH, or it may be possible to apply b1 for first PUSCH, b1 for second PUSCH, −b1 for third PUSCH, and −b1 for fourth PUSCH. Alternatively, an OCC sequence of 1 (or −1) may always be applied to even-numbered PUSCH transmissions and an OCC sequence of −1 (or 1) may always be applied to odd-numbered PUSCH transmissions. Alternatively, the OCC sequence may be applied by a modular operation. Since the OCC sequence (1, −1) has a length of 2, the OCC sequence value applied to the nth PUSCH may be 1 (or −1) if mod (n/2) has a value of 1, and may be −1 (or 1) if mod (n/2) has a value of 0.

In addition, although FIG. 26 illustrates that the first and second UEs start the same number of repeated transmissions from the same slot, this can be applied to the case in which repeated transmission starts from different slots and/or different numbers of repeated transmissions are performed.

In another example, it may be possible to apply an OCC sequence between pieces of information belonging to different time resources within one PUSCH.

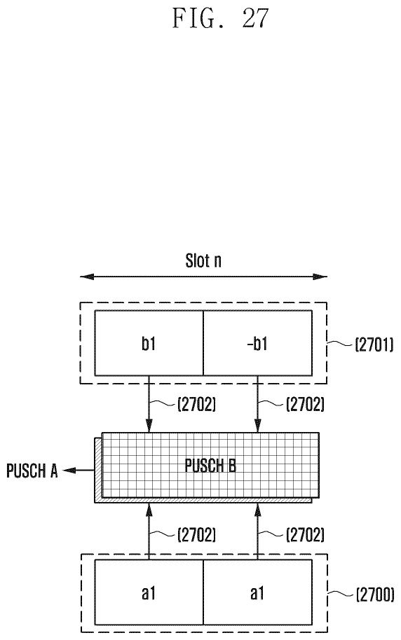

FIG. 27 illustrates a method of applying an OCC scheme from a time resource perspective when a UE performs PUSCH transmission according to an embodiment of the disclosure.

Referring to FIG. 27, in case of applying an OCC scheme with a length of 2 in terms of time resources, the first and second UEs may determine a value, obtained by dividing the size of a PUSCH resource allocated to the corresponding UE by 2, as an actual TBS value, when calculating the transport block size (TBS). Alternatively, the TBS calculation may consider the actual size of the PUSCH transmission resource area separately. The size of the PUSCH transmission resource area is determined by the frequency resource size (number of RBs) and the time resource size (number of symbols). Thereafter, the UEs perform data transmission preparation according to the procedure described in FIG. 24. In addition, in the OCC spreading operation, as shown in FIG. 27, the first UE sequentially arranges two identical pieces of data a1 in terms of time resources and applies the OCC sequence (1, 1) to the first a1 and the second a1 for each of the two pieces of data (indicated by reference numeral 2700). Furthermore, the first UE transmits them in the PUSCH A resource area allocated by the base station (indicated by reference numeral 2702). The second UE also sequentially arranges two identical pieces of data b1 in terms of time resources and applies the OCC sequence (1, −1) to the first b1 and the second b1 for each of the two pieces of data (indicated by reference numeral 2701). Further, the second UE transmits them in the PUSCH B resource area allocated by the base station (indicated by reference numeral 2702).

Although FIG. 27 illustrates that data to which OCC is applied is divided into two equal parts in terms of time resources, the data may be divided into and applied to three, four, or more equal parts. When the same data is mapped to four equal parts, the first UE may generate data (a1, a1, a1, a1), and the second UE may generate data (b1, −b1, b1, −b1) or (b1, b1, −b1, −b1). In addition, although the OCC spreading and de-spreading schemes have been described in terms of the frequency axis in FIG. 23, it is also possible to convert to the time axis perspective and apply the OCC spreading and de-spreading schemes, and they may be the same as or somewhat similar to the description with reference to FIG. 23.

Referring to FIG. 27, PUSCH A and PUSCH B transmitted in slot n are shown to be transmitted by the first and second UEs using the same time and frequency resources, but it is possible that only some of the time and frequency resources overlap and other different time and frequency resources are used.

Furthermore, in FIG. 27, reference numerals 2700 and 2701 show conceptual diagrams to illustrate that data is not generated in slot n, but is transmitted by the first and second UEs via a PUSCH. In reality, the data may be generated before slot n in which the PUSCH is first transmitted.

In FIG. 27, since the base station receives the information of (a1+b1) via PUSCH A and PUSCH B transmitted by the first and second UEs in slot n, the base station may receive each of data a1 and b1 by applying the OCC de-spreading scheme to the received information of (a1+b1) and (a1−b1). Here, a1 and b1 refer to a set of symbols in which a series of data is channel-coded and modulated. Alternatively, a1 and b1 may be a set of data before DFT.

In order to apply the OCC scheme shown in FIG. 27, the base station may provide, to the UEs in advance, through a higher layer signal or L1 signal, an indication of a value of the OCC sequence to be applied for each slot during PUSCH repeated transmission. For example, in the case of the second UE, when a DCI field called OCC index exists in the L1 signal and the corresponding value indicates a bit value corresponding to the OCC sequence (1, −1), the second UE may apply a value of ‘1’ to the first part of the PUSCH and a value of ‘-1’ to the second part of the PUSCH. Specifically, the DCI field called an OCC index exists as one bit, and if one bit has a value of 0, the OCC sequence may be indicated as (1,1), and if one bit has a value of 1, the OCC sequence may be indicated as (1,−1) or (−1,1). The OCC sequence type and DCI field size may be determined by a higher layer signal configuration. The length of the OCC sequence may use a value greater than the length of 2 described in the example above.

In FIG. 27, the first UE may transmit or not the UE capability capable of applying the OCC spreading method.

Although a case where one PUSCH is transmitted is described as an example in FIG. 27, it is not limited thereto, and a case where the PUSCH is repeatedly transmitted over multiple slots may also be possible.

In addition, although FIG. 27 illustrates that the first and second UEs start PUSCH transmission from the same slot, this case can be applied to the case in which PUSCH transmission starts from different slots and/or different numbers of repeated transmissions are performed.

In another example, it may be possible to apply an OCC sequence between pieces of information belonging to different time resources within one PUSCH.

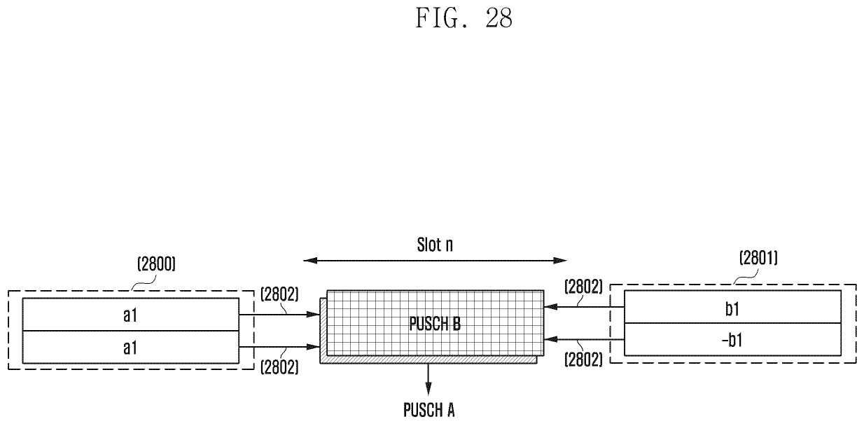

FIG. 28 illustrates a method of applying an OCC scheme from a frequency resource perspective when a UE performs PUSCH transmission according to an embodiment of the disclosure.

Referring to FIG. 28, in case that the first and second UEs apply an OCC scheme with a length of 2 in terms of frequency resources, the UEs may determine a value obtained by dividing the size of a PUSCH resource allocated to the corresponding UE by 2, as an actual TBS value, when calculating the TBS. Alternatively, the TBS calculation may consider the actual size of the PUSCH transmission resource area separately. The size of the PUSCH transmission resource area is determined by the frequency resource size (number of RBs) and the time resource size (number of symbols). Thereafter, the UEs perform data transmission preparation by the procedure described in FIG. 24. In addition, in the OCC spreading operation, as illustrated in FIG. 28, the first UE sequentially arranges two identical pieces of data a1 in terms of frequency resources and applies the OCC sequence (1, 1) to the first a1 and the second a1 for each of the two pieces of data (indicated by reference numeral 2800). Further, the first UE transmits them in the PUSCH A resource area allocated by the base station (indicated by reference numeral 2802). The second UE also sequentially arranges two identical pieces of data b1 in terms of time resources and applies the OCC sequence (1, −1) to the first b1 and the second b1 for each of the two pieces of data (indicated by reference numeral 2801). Further, the second UE transmits them in the PUSCH B resource area allocated by the base station (indicated by reference numeral 2802).

Although FIG. 28 illustrates that data to which OCC is applied is divided into two equal parts in terms of frequency resources, the data may be divided into and applied to three, four, or more equal parts. In case that the same data is mapped to four equal parts, the first UE may generate data (a1, a1, a1, a1), and the second UE may generate data (b1, −b1, b1, −b1) or (b1, b1, −b1, −b1). In addition, the scheme of OCC spreading and de-spreading may be the same as or somewhat similar to the description with reference to FIG. 23. Referring again to FIG. 28, PUSCH A and PUSCH B transmitted in slot n are shown to be transmitted by the first and second UEs using the same time and frequency resources, but it is possible that only some of the time and frequency resources overlap and other different time and frequency resources are used.

Furthermore, in FIG. 28, reference numerals 2800 and 2801 show conceptual diagrams to illustrate that data is not generated in slot n, but is transmitted by the first and second UEs via a PUSCH. In reality, the data may be generated before slot n in which the PUSCH is first transmitted.

In FIG. 28, since the base station receives the information of (a1+b1) and (a1−b1) via PUSCH A and PUSCH B transmitted by the first and second UEs in slot n, the base station may receive each of data a1 and b1 by applying the OCC de-spreading scheme to the received information of (a1+b1) and (a1−b1). Here, a1 and b1 refer to a set of symbols in which a series of data is channel-coded and modulated. Alternatively, a1 and b1 may be a set of data before DFT.

In order to apply the OCC scheme shown in FIG. 28, the base station may provide, to the UEs in advance, through a higher layer signal or L1 signal, an indication of a value of the OCC sequence to be applied for each slot during PUSCH repeated transmission. For example, in the case of the second UE, when a DCI field called OCC index exists in the L1 signal and the corresponding value indicates a bit value corresponding to the OCC sequence (1, −1), the second UE may apply a value of ‘1’ to the first part of the PUSCH and a value of ‘-1’ to the second part of the PUSCH. Specifically, the DCI field called an OCC index exists as one bit, and if one bit has a value of 0, the OCC sequence may be indicated as (1,1), and if one bit has a value of 1, the OCC sequence may be indicated as (1,−1) or (−1,1). The OCC sequence type and DCI field size may be determined by a higher layer signal configuration. The length of the OCC sequence may use a value greater than the length of 2 described in the example above.

In FIG. 28, the first UE and the second UE may transmit or not the UE capability capable of applying the OCC spreading method.

Although a case where one PUSCH is transmitted is described as an example in FIG. 28, it is not limited thereto, and a case where the PUSCH is repeatedly transmitted over multiple slots may also be possible.

In addition, although FIG. 28 illustrates that the first and second UEs start PUSCH transmission from the same slot, this can be applied to the case in which PUSCH transmission starts from different slots and/or different numbers of repeated transmissions are performed.

Hereinafter, embodiments of the disclosure will be described in detail in conjunction with the accompanying drawings. In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, 5G systems will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure. The contents of the disclosure may be applied to FDD, TDD, and/or XDD (and/or SBFD) systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, higher layer signaling (or upper signal) may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (e.g., DCI used for the purpose of scheduling downlink or uplink data)
Non-scheduling DCI (e.g., DCI not used for the purpose of scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority. As used herein, the term “drop” may be replaced by other terms having similar meanings. For example, the “drop” may be replaced by the terms “cancel”, “omit”, “suspend”, and the like.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through several embodiments, but they are not independent of each other, and one or more embodiments may be applied simultaneously or in combination.

Hereinafter, a situation in which OCC-based PUSCH transmission is applied in satellite communication is described. The methods described below can also be applied to terrestrial networks. Satellite communication is broadly divided into three components, such as a UE, a ground station (base station), and a satellite. A link between the UE and the satellite is called a service link, and a link between the ground station and the satellite is called a feeder link. In the service link, a downlink usually refers to a link of satellite→UE (a link from a satellite to a UE), and an uplink refers to a link of UE→satellite (a link from a UE to a satellite).

Similar to terrestrial networks, satellites may have insufficient uplink coverage because the transmission power of the UE may be significantly lower than that of the satellite, and to address this, it is common for UEs to perform repeated transmission for uplink data transmission. If all UEs within satellite coverage perform repeated transmissions of the same data through the uplink, the frequency and time resources available to the satellite network may be insufficient. To solve this problem, it is necessary to support a larger number of UEs by using code resources in addition to frequency and time resources. Therefore, it may be possible to consider transmitting uplink data by using the OCC scheme described above.

### First Embodiment

When a UE receives scheduling of PUSCH repeated transmission by a higher layer signal or L1 signal, it may be possible to apply the same or different redundancy version (RV) values for each PUSCH transmission interval unit for repeated transmission or each slot in which PUSCH is transmitted. The reason for applying RV may generally be to increase the reliability of data transmission. Specifically, it is possible for a receiving node to increase the reliability by detecting and correcting errors in the data transmitted by a transmitting node.

In the case of a configured grant (CG) PUSCH that is normally only configured by the higher layer signal or is activated by the higher layer signal and the L1 signal, it may be possible for the RV value to be configured as at least one of {0, 2, 3, 1}, {0, 3, 0, 3}, {0, 0, 0, 0} for each PUSCH which is repeatedly transmitted within one CG PUSCH cycle. For example, in case that four CG PUSCHs are repeatedly transmitted within one CG PUSCH cycle, and that the RV value is configured to have a value of {0, 2, 3, 1}, the UE applies an RV of 0 to the first CG PUSCH, an RV of 2 to the second CG PUSCH, an RV of 3 to the third CG PUSCH, and an RV of 1 to the fourth CG PUSCH. In the case of dynamic grant (DG) PUSCHs scheduled by the L1 signal (e.g., DCI), it may be possible to apply the RV value for each repeatedly transmitted PUSCH as shown in Table 45.

TABLE 45
Redundancy version for PUSCH transmission

| | rv_{id} to be applied to n^{th} transmission occasion | | | |
|---|---|---|---|---|
| rv_{id} indicated | (repetition Type A or TB processing over multiple slots) | | | |
| by the DCI | or n^{th} actual repetition (repetition Type B) | | | |
| scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

In case that OCC is applied in a state where different RV values are applied to the repeatedly transmitted PUSCHs as described above, the base station may not be able to perform reception. For example, referring to FIG. 25, in case that the base station provides a first UE and a second UE each with DCI for scheduling PUSCH repeated transmission over two slots, and the RV value of the DCI is indicated to be 0, the first UE transmits a1 with RV=0 in slot n, and transmits a1′ with RV=1 in slot (n+1). The second UE transmits data b1 with rv=0 in slot n, and transmits data −b1′ with rv=1 in slot (n+1). Therefore, since the base station receives information of (a1+b1) in slot n and information of (a1′−b1′) in slot (n+1), it is difficult to decode a1 and b1 by using these two received signals through the OCC de-spreading process. Accordingly, it may be necessary to have identical data having at least the same RV value for the PUSCH repeated transmission to which OCC spreading is applied, and it may be possible to consider at least one or at least one combination of the following methods.

Method 1-1: In case that the UE receives DCI indicating the OCC spreading method and PUSCH repeated transmission, the UE applies the same RV applied to the first PUSCH to repeatedly transmitted PUSCHs. This method ignores the RV modification rules described in Table 45, and in case that the UE receives DCI that specifies an OCC spreading method, the same RV value applied to the first PUSCH is used for all subsequent repeatedly transmitted PUSCHs. In case that the UE receives DCI that does not indicate an OCC spreading method, the UE may apply Table 45 to PUSCHs that are repeatedly transmitted. In other word, depending on the OCC spreading method, the UE may apply the RV value to the PUSCH transmission resource interval scheduled to be repeated transmitted, in a different way.

Method 1-2: It may be possible to apply the same RV application method for each group to which OCC is applied.

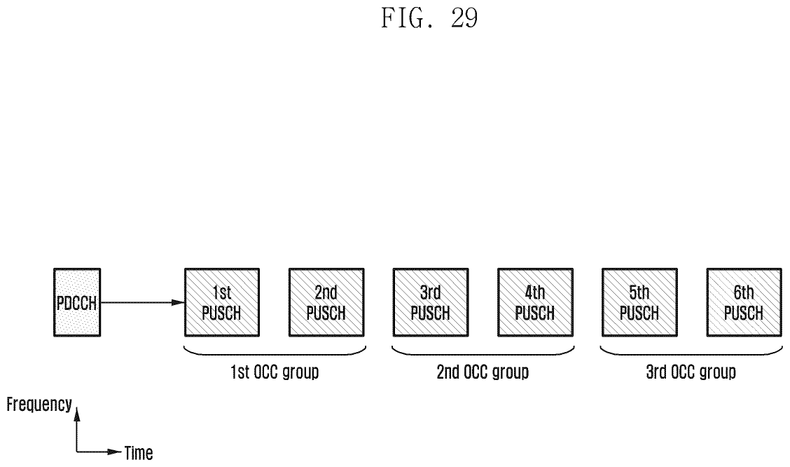

FIG. 29 illustrates OCC spreading applied for each PUSCH group according to an embodiment of the disclosure. FIG. 29 illustrates a situation where the first and second PUSCHs are configured as the same OCC group, the third and fourth PUSCHs are configured as the same OCC group, and the fifth and sixth PUSCHs are configured as the same OCC group. An OCC group is a group applied by the base station to perform OCC de-spreading thereon, and it may be possible for the two PUSCHs transmitted by each of the UEs shown in FIG. 25 to be grouped as one OCC group. FIG. 29 is shown in view of a first UE, and a second UE may receive scheduling of PUSCH transmission resources having the same time and frequency resources as those of the first UE, or may receive scheduling of PUSCH transmission resources having at least different time or frequency resources. In the case shown in FIG. 29, since the RV value only needs to be the same within the at least one OCC group, the UE is required to receive information on the number of PUSCH repeated transmissions within the OCC group from the base station via a separate higher layer signal or L1 signal. In case that the UE receives DCI indicating the OCC spreading method and determines that the number of PUSCH repeated transmissions within an OCC group is N, the UE may apply the RV value as shown in Table 46. For example, in case that the base station indicates a value of rv=0 using DCI, the UE may determine a value of rv=0 for the first and second PUSCHs, a value of rv=2 for the third and fourth PUSCHs, and a value of rv=3 for the fifth and sixth PUSCHs according to Table 46.

TABLE 46
Redundancy version for PUSCH transmission

| | rv_{id} to be applied to n^{th} transmission occasion | | | |
|---|---|---|---|---|
| | (repetition Type A or TB processing over multiple slots) | | | |
| rv_{id} indicated | or n^{th} actual repetition (repetition Type B) | | | |
| by the DCI | ((n-(n | ((n-(n | ((n-(n | ((n-(n |
| scheduling | mod N))/N) | mod N))/N) | mod N))/N) | mod N))/N) |
| the PUSCH | mod 4 = 0 | mod 4 = 1 | mod 4 = 2 | mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

N: the number of slots applied for the same OCC group

The methods described above may be applicable only when the OCC spreading scheme is applied on a time axis, or may be applicable only when different OCC sequence values are applied for each repeatedly transmitted PUSCH. Further, the methods described above may be applicable to only PUSCH repeated transmission scheduled from DCI including a CRC scrambled by a C-RNTI.

### Second Embodiment

The following describes a situation where some PUSCHs overlap with a PUCCH during PUSCH repeated transmission to which OCC spreading is applied.

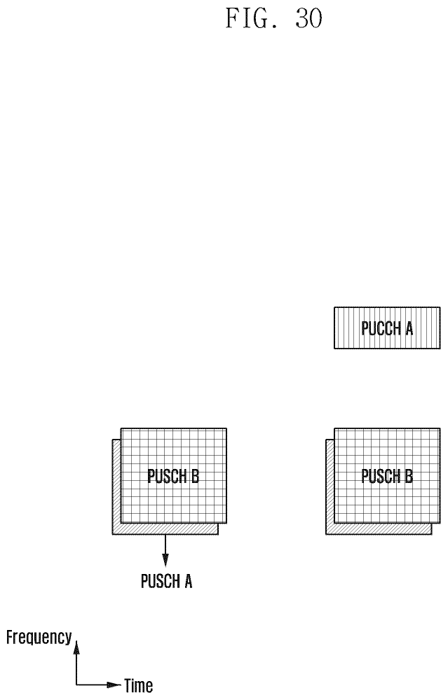

FIG. 30 illustrates a situation in which a specific PUSCH and a PUCCH overlap when UEs perform PUSCH repeated transmission according to an embodiment of the disclosure. FIG. 30 illustrates an example of a situation in which an embodiment of the disclosure is applicable.

Referring to FIG. 30, the first UE is transmitting PUSCH A repeatedly, and the second UE is transmitting PUSCH B repeatedly. The repeatedly transmitted PUSCHs may be located in the same slot or in different slots. If the PUCCH A of the first UE overlaps with the second repeatedly transmitted PUSCH A, the UE may multiplex the hybrid automatic repeat request acknowledgment (HARQ-ACK) or channel state information (CSI) contained in the PUCCH A to the PUSCH A.

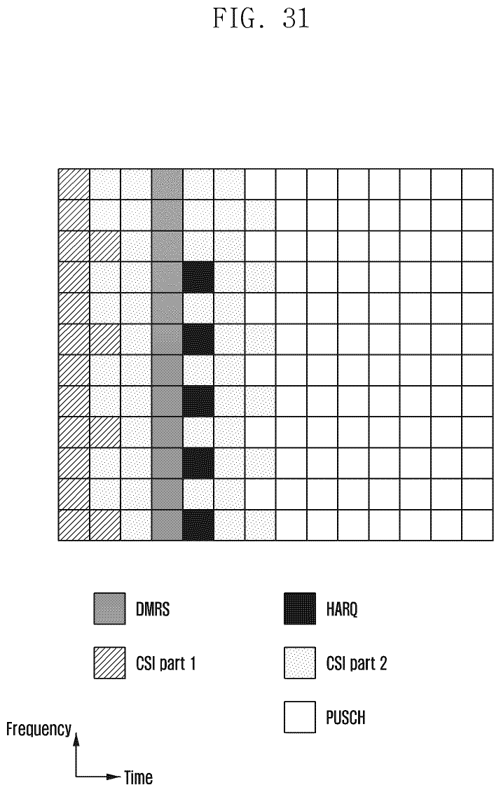

FIG. 31 illustrates a resource allocation showing the order of multiplexing when UCI is multiplexed to a PUSCH according to an embodiment of the disclosure.

Referring to FIG. 31, the UE performs rate matching by mapping HARQ-ACK information immediately after the DMRS symbol and mapping CSI part 1 and CSI part 2 from the first symbol in which the PUSCH is scheduled.

In such a situation, in case that each UE applies the OCC spreading method as shown in FIG. 25 and a receiving node of a base station applies OCC de-spreading thereto, the base station cannot receive it correctly. This is because, in a situation shown in FIG. 30, the base station receives information of (a1+b1) through the first PUSCH A transmitted by the first UE and the first PUSCH B transmitted by the second UE, but receives information of (c1−b1) through the second PUSCH A transmitted by the first UE and the second PUSCH B transmitted by the second UE. In other words, since the first UE performs mapping in a manner different from the existing PUSCH resource allocation method that has been allocated without the existing UCI, by performing UCI mapping, it is difficult for the base station to decode by using information of (a1+b1) and (c1−b1) in terms of performing OCC de-spreading.

Accordingly, it may be possible to consider at least one or a combination of one or more of the following methods to address these issues. The disclosure can be applied to overlap occurring within a single cell and can also be applicable to an environment where multiple cells exist. In a situation where multiple cells are considered, the disclosure can only be applied to a case in which PUSCH A is selected to perform multiplexing for the UCI of PUCCH A.

Method 2-1: In a situation where the UE has received DCI indicating OCC spreading and PUSCH repeated transmission, if at least one of the repeatedly transmitted PUSCHs is overlapped with a PUCCH, the UE does not transmit the PUCCH and drops the UCI contained in the PUCCH. This method may also be applicable to PUSCH repeated transmission where the PUSCH is configured via a higher layer signal without receiving separate DCI. This method can be applied only to PUCCHs where PUCCH is scheduled via the L1 signal, or only to PUCCHs where PUCCH is configured via the higher layer signal, or both.

Method 2-2: In a situation where the UE has received DCI indicating OCC spreading and PUSCH repeated transmission, if at least one of the repeatedly transmitted PUSCHs is overlapped with a PUCCH, the UE performs PUCCH transmission instead of performing the overlapping PUSCH transmission. This method may also be applicable to PUSCH repeated transmission where PUSCH is configured via a higher layer signal without separate DCI reception. This method may be applied only to PUCCHs where PUCCH is scheduled via the L1 signal, or only to PUCCHs where PUCCH is configured via the higher layer signal, or both.

Method 2-3: In a situation where the UE has received DCI indicating the OCC spreading method and PUSCH repeated transmission, if at least one of the repeatedly transmitted PUSCHs is overlapped with a PUCCH, the UE may multiplex the UCI of the overlapping PUCCH not only to the overlapping PUSCH, but also to other non-overlapping PUSCHs having the same data (TB). Alternatively, in a situation where the UE has received DCI indicating the OCC spreading method and PUSCH repeated transmission, if at least one of the repeatedly transmitted PUSCHs is overlapped with a PUCCH, the UE may multiplex the UCI of the overlapping PUCCH not only to the overlapping PUSCH but also to other PUSCHs belonging to the same OCC group as the corresponding PUSCH and not overlapping with the PUCCH. Referring to FIG. 30 as an example, when the first UE transmits a PUSCH A and a PUCCH A, and the second PUSCH A and the PUCCH A overlap, the first UE may multiplex the UCI of the PUCCH A on the first PUSCH A as well as on the second PUSCH A. In this case, when calculating the minimum time required to multiplex the UCI of the PUCCH, the time (time interval) between a symbol which is last among the last symbol of the PDCCH or PDSCH associated with the PUCCH A and the last symbol of the PDCCH providing the PUSCH A, and the start symbol of the first PUSCH A should be greater than the minimum time required for the UE to multiplex the UCI. Accordingly, when multiplexing the UCI of the PUCCH A to the PUSCH A, the first UE may determine whether to multiplex the UCI only to the overlapping PUSCH A (e.g., the second PUSCH A of FIG. 30) or also to the non-overlapping PUSCH A (e.g., the first PUSCH A of FIG. 30), depending on whether the OCC spreading method provided via the DCI is applied. Thus, the processing time of the UE for UCI multiplexing and PUSCH preparation may be determined by considering the earliest time (X1) of the PUSCH to which the UCI is to be multiplexed and the PUCCH containing the UCI, and the latest time (X2) of the PDSCH and PDCCH associated with the corresponding PUSCH and PUCCH, and only if the time difference between the earliest time (X1) and the latest time (X2) is greater than the minimum processing requirement time of the UE, the UE may map and transmit the UCI to the PUSCH on which the UCI is to be multiplexed.

Method 2-4: In a situation where the UE has received DCI indicating OCC spreading and PUSCH repeated transmission, if at least one of the repeatedly transmitted PUSCHs is overlapped with a PUCCH, the UE may transmit both the PUSCH and the PUCCH simultaneously without multiplexing the UCI of the PUCCH to the PUSCH. On the other hand, in a situation where the UE does not receive indication of OCC spreading and the UE receives DCI indicating to perform PUSCH repeated transmission, if at least one of the repeatedly transmitted PUSCHs is overlapped with a PUCCH, the UE may multiplex the UCI of the PUCCH to the overlapping PUSCH. Alternatively, and separately, in case that the OCC spreading method is configured via a higher layer signal and can be dynamically indicated by an L1 signal, the UE may always be able to transmit both the PUCCH and the PUSCH at the same time regardless of whether OCC spreading is applied.

Method 2-5: In a situation where the UE has received DCI indicating OCC spreading and PUSCH repeated transmission, if at least one of the repeatedly transmitted PUSCHs is overlapped with a PUCCH, the UE multiplexes the UCI of the PUCCH to the overlapping PUSCH and the UE allocates UCI information to the PUSCH by puncturing data of the PUSCH to which the UCI is multiplexed. In the puncturing method, the UE first allocates the data of the PUSCH to PUSCH resources regardless of whether the UCI is mapped or not, and then changes the data of the PUSCH to UCI data with respect to resources to which the UCI is mapped. Accordingly, the base station may demodulate/decode at least some code blocks or transport blocks via OCC de-spreading with respect to pieces of data to which the UCI is not mapped. On the other hand, in a situation where OCC spreading is not indicated and the UE has received DCI indicating PUSCH repeated transmission, if at least one of the repeatedly transmitted PUSCHs is overlapped with a PUCCH, the UE multiplexes the UCI of the PUCCH to the overlapping PUSCH, and the UE allocates the UCI information to the PUSCH by rate matching the data of the PUSCH to which the UCI is multiplexed. The rate matching method means that the UE first allocates the UCI mapping to the PUSCH resources, and then allocates the data of the PUSCH sequentially to areas where UCI mapping is not allocated.

Method 2-6: In a situation where the UE has received DCI indicating OCC spreading and PUSCH repeated transmission, the UE may schedule the UE such that at least one of the repeatedly transmitted PUSCHs does not overlap with a PUCCH. Referring to FIG. 30 as an example, when the base station applies the OCC scheme to schedule PUSCH repeated transmission to the UEs as shown in FIG. 30, the base station avoids scheduling PUCCHs that overlap with the corresponding PUSCH resources. In case that a case such as that shown in FIG. 30 occurs, the UE may consider the case to be an error case and may apply at least one of methods 2-1 to 2-5.

### Third Embodiment

The following describes the case where PUCCH repeated transmission and PUSCH repeated transmission to which the OCC scheme is applied are overlapped.

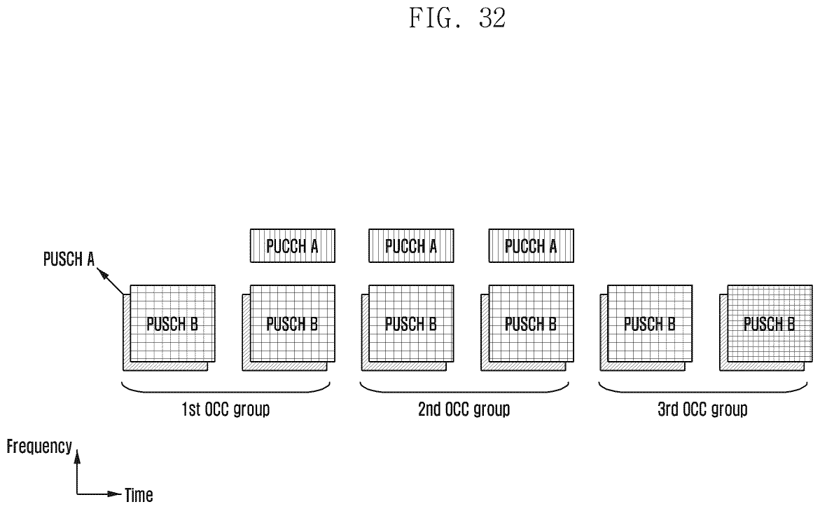

FIG. 32 illustrates a situation in which UEs receive scheduling of PUSCH repeated transmission and the PUSCH repeated transmission overlaps with PUCCH repeated transmission according to an embodiment of the disclosure. FIG. 32 illustrates an example of a situation where an embodiment of the disclosure is applicable.

Referring to FIG. 32, in a situation where the first UE repeatedly transmits PUSCH A and the second UE repeatedly transmits PUSCH B, if the second, third, or fourth repeatedly transmitted PUSCH A overlaps with the repeatedly transmitted resource of PUCCH A, the UE does not perform the transmission of the second, third, or fourth repeatedly transmitted PUSCH A. In case that the PUSCH A repeatedly transmitted by the first UE and the PUCCH A repeatedly transmitted by the first UE overlap, the PUSCH repeated transmission A is not performed on the overlapping resources.

Assuming that the scheme described in FIG. 25 is applied to each OCC group, the base station will receive (a1+b1) and −b1 in the first OCC group, receive b1 and −b1 in the second OCC group, and receive (a1+b1) and (a1−b1) in the third OCC group. In other words, the second, third, and fourth PUSCH A overlapping with PUCCH A are not transmitted, and thus a1 signal is not acquired in the corresponding resource area. Accordingly, when the scheme of FIG. 25 is applied, the base station will receive (a1+b1) and −b1 in the first OCC group, receive b1 and −b1 in the second OCC group, and receive (a1+b1) and (a1−b1) in the third OCC group.

In case that, depending on the implementation of a base station receiver, the OCC de-spreading procedure is fixed for the PUSCHs to which the OCC sequence is applied without considering whether or not the corresponding PUSCH is dropped (i.e., in case that the OCC de-spreading procedure is performed regardless of whether or not the PUSCH is dropped), e.g., assuming that (a1+b1) and (a1−b1) received in the third OCC group are the first and second received signals, respectively, the base station may fix/define the procedure to perform “((first received signal)+(second received signal))/2” or “(first received signal)+(second received signal)” to obtain the a1 signal and to perform “((first received signal)−(second received signal))/2” or “(first received signal)−(second received signal)” to obtain the b1 signal during the OCC de-spreading process. In this case, the base station may not be able to properly detect the second received signal with respect to (a1+b1) and −b1 received in the first OCC group. Therefore, it may be possible for the UE to apply at least one or a combination of at least one of the following methods. The following methods can be applied only to a case in which the PUSCH is a DG PUSCH in FIG. 32, or only to a case in which the PUSCH is a CG PUSCH, or both.

Method 3-1: In case that the first UE receives scheduling information which is the same as or similar to that shown with reference to FIG. 32 (scheduling information for repeated transmissions of PUSCHs (and/or PUCCHs) which are the same/similar to those exemplified in FIG. 32), the UE may not transmit PUSCH A belonging to the first OCC group. In other words, if at least one PUSCH within one OCC group is not transmitted for the same reason as the case exemplified in FIG. 32 described above (or for other reasons), it may be possible for the UE not to perform the remaining PUSCH transmissions. Such other reasons may include failure to transmit the PUSCH due to overlap with downlink resources, or failure to transmit the PUSCH due to transmission power prioritization.

Method 3-2: In case that the first UE receives scheduling information which is the same as or similar to FIG. 32 (scheduling information for repeated transmissions of PUSCH (and/or PUCCH) which are the same/similar to those exemplified in FIG. 32), the UE does not perform the transmission of the first PUCCH A. That is, it may be possible for the UE to perform repeated transmissions of the second and third PUCCH A, excluding the transmission of the first PUCCH A.

### Fourth Embodiment

Hereinafter, a method in which a UE determines the transmission power of a PUSCH when the UE transmits the PUSCH to which the OCC scheme is applied.

Basically, the UE operates as described in Equation 8 for the transmission power of the PUSCH. In addition, the transmission power between repeatedly transmitted PUSCHs with respect to the same data may or may not be the same. An example in which the transmission power between PUSCHs is not the same may correspond to a case in which the UE receives a group common TPC from the base station in the middle of PUSCH repeated transmission. In other cases (when the transmission power between the PUSCHs is the same), the UE may apply the same transmission power, which is applied to the first PUSCH transmission with respect to the repeatedly transmitted PUSCHs, to the remaining repeatedly transmitted PUSCHs.

In a situation where the UE applies OCC to PUSCHs that are repeatedly transmitted, if a transmission power difference between repeatedly transmitted PUSCHs is caused by a group common TPC, the base station receiving node is unable to perform OCC de-spreading correctly.

Therefore, to solve this problem, the UE may determine the transmission power determination unit not by the PUSCH transmission interval units, but by the OCC group units when the OCC is applied. When describing with reference to FIG. 29 as an example, if the UE conventionally determines the changed transmission power value from the 4th PUSCH by the group common TPC, the above method means that the UE maintains the same transmission power as the third PUSCH until the fourth PUSCH and applies the changed transmission power from the fifth PUSCH.

### Fifth Embodiment

Hereinafter, a method of aligning DMRS symbols from the base station's perspective when a UE transmits a PUSCH applying the OCC scheme is described.

During PUSCH transmission, there are two types of DMRS depending on a symbol in which the DMRS is located. The first is DMRS type A, where the DMRS is located in the third or fourth symbol in a slot, regardless of the starting position and length of the PUSCH transmission. The second is DMRS type B, where the DMRS is always located at the first symbol to which a PUSCH resource is allocated.

When the base station receives, from two different UEs, PUSCHs to which the OCC is applied and which overlap in time and frequency resources, at least the DMRS symbol should not overlap with data transmitted by other UEs. For this reason, the resource areas in which DMRSs are located may be required to be aligned between the UEs. Therefore, when the OCC scheme is applied to PUSCH repeated transmission, it may be possible to always provide a DMRS type A configuration to the UE, so as to avoid the complexity of aligning the DMRS resource areas in view of the base station scheduling.

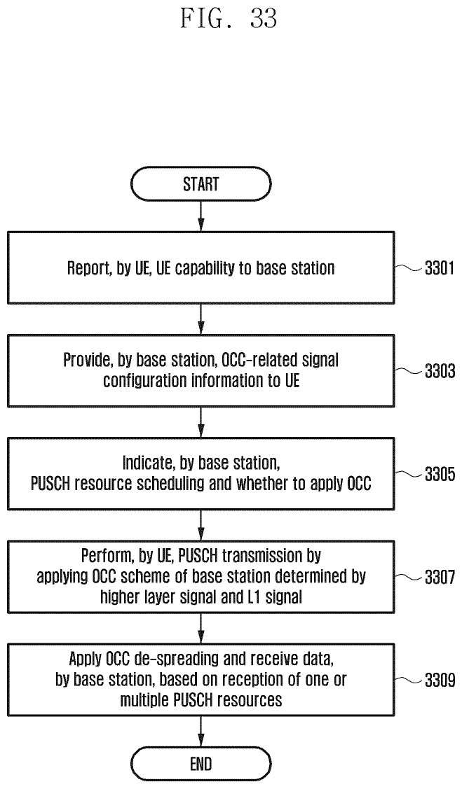

FIG. 33 illustrates a procedure for performing a PUSCH transmission to which an OCC scheme is applied according to an embodiment of the disclosure. Various modifications can be made to the method illustrated in the flowchart of FIG. 33. For example, although shown as a series of operations, the various operations in each figure may overlap, occur in parallel, occur in a different order, or occur multiple times. In other examples, operations may be omitted or replaced by other operations.

Referring to FIG. 33, in operation 3301, a UE transmits to a base station a UE capability indicating whether an OCC sequence is applicable in the PUSCH transmission to the base station. The base station receives, from the UE, the UE capability indicating whether the OCC sequence is applicable in the PUSCH transmission.

In operation 3303, the base station provides OCC-related higher layer signal information to the UE. The base station may provide OCC-related signal configuration information to the UE through a higher layer signal. For example, this may be, but is not limited to, a case in which the UE reports the UE capability indicating that the UE is capable of applying the OCC sequence during PUSCH transmission. The UE may receive the OCC-related signal configuration information from the base station through the higher layer signal.

In operation 3305, the base station may indicate to the UE whether to apply the OCC through the higher layer signal and/or the L1 signal during PUSCH scheduling. The base station may indicate whether to apply the OCC via the higher layer signal and/or the L1 signal. The UE may receive, from the base station, an indication on whether to apply the OCC through the higher layer signal and/or the L1 signal.

In operation 3307, the UE may perform the PUSCH transmission by applying an OCC scheme determined/indicated by the higher layer signal and/or the L1 signal. The UE is capable of performing the PUSCH transmission by applying the OCC scheme by at least one of the methods described in the first to fifth embodiments above, or some combination thereof.

In operation 3309, the base station performs demodulation/decoding of the data of each UE by applying an OCC de-spreading scheme to reception signals received from multiple UEs.

Specific details of the operation of the UE and the operation of the base station according to an embodiment of the disclosure described above may be referred to in the description of an embodiment of the disclosure described above.

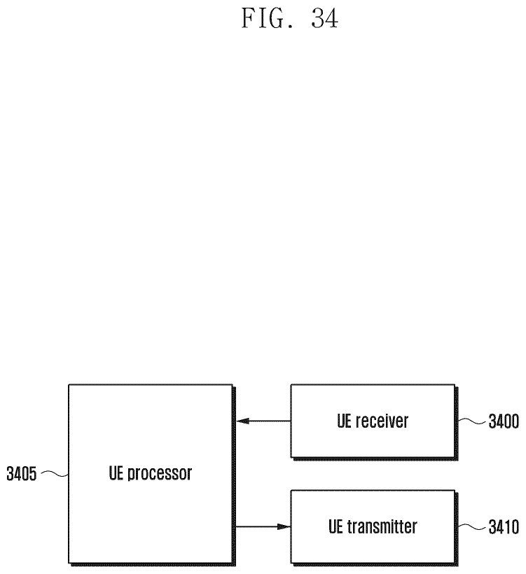

FIG. 34 illustrates a structure of a UE in a wireless communication system according to an embodiment of the disclosure.

Referring to FIG. 34, the UE may include a transceiver, which refers to a UE receiver 3400 and a UE transmitter 3410 as a whole, memory (not illustrated), and a UE processor 3405 (or UE controller or processor). The UE transceiver 3400 and 3410, the memory, and the UE processor 3405 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

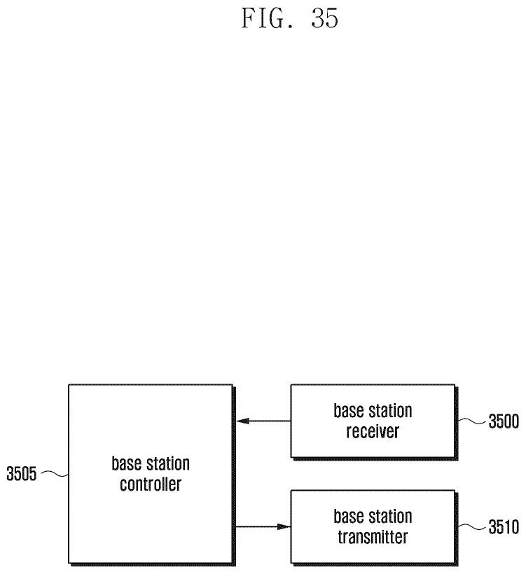

FIG. 35 illustrates a structure of a base station in a wireless communication system according to an embodiment of the disclosure.

Referring to FIG. 35, the base station may include a transceiver, which refers to a base station receiver 3500 and a base station transmitter 3510 as a whole, memory (not illustrated), and a base station processor 3505 (or base station controller or processor). The base station transceiver 3500 and 3510, the memory, and the base station processor 3505 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which operations are performed, and the order relationship between the operations may be changed or the operations may be performed in parallel.

1. A method performed by a user equipment (UE) in a communication system, the method comprising:
identifying physical uplink shared channel (PUSCH) transmissions to be transmitted on slots;
identifying orthogonal cover code (OCC) groups corresponding to the PUSCH transmissions; and
transmitting, on the slots, the PUSCH transmissions with OCC applied based on the OCC groups,
wherein a same redundancy version (RV) value is applied for one OCC group among the OCC groups.

2. The method of claim 1, further comprising receiving downlink control information (DCI) including PUSCH scheduling information and an RV field,
wherein the PUSCH transmissions are identified based on the DCI, and
wherein RV values identified based on the RV field are cyclically applied for the OCC groups.

3. The method of claim 2, further comprising:
receiving a first configuration associated with a PUSCH repetition and a second configuration associated with OCC length,
wherein the PUSCH transmissions correspond to the PUSCH repetition, and
wherein the RV values are cyclically applied for the OCC groups in case that a repetition number of the PUSCH repetition is greater than the OCC length.

4. The method of claim 1, wherein the same RV value is applied for the OCC groups.

5. The method of claim 1, wherein the PUSCH transmissions are transmitted in a non-terrestrial network (NTN).

6. A user equipment (UE) in a communication system, the UE comprising:
a transceiver; and
a processor coupled with the transceiver and configured to:
identify physical uplink shared channel (PUSCH) transmissions to be transmitted on slots,
identify orthogonal cover code (OCC) groups corresponding to the PUSCH transmissions, and
transmit, on the slots, the PUSCH transmissions with OCC applied based on the OCC groups,
wherein a same redundancy version (RV) value is applied for one OCC group among the OCC groups.

7. The UE of claim 6,
wherein the processor is further configured to receive downlink control information (DCI) including PUSCH scheduling information and an RV field,
wherein the PUSCH transmissions are identified based on the DCI, and
wherein RV values identified based on the RV field are cyclically applied for the OCC groups.

8. The UE of claim 7,
wherein the processor is further configured to receive a first configuration associated with a PUSCH repetition and a second configuration associated with OCC length,
wherein the PUSCH transmissions correspond to the PUSCH repetition, and
wherein the RV values are cyclically applied for the OCC groups in case that a repetition number of the PUSCH repetition is greater than the OCC length.

9. The UE of claim 6, wherein the same RV value is applied for the OCC groups.

10. The UE of claim 6, wherein the PUSCH transmissions are transmitted in a non-terrestrial network (NTN).

11. A method performed by a base station in a communication system, the method comprising:
transmitting downlink control information (DCI) including physical uplink shared channel (PUSCH) scheduling information; and
receiving, on slots, PUSCH transmissions with orthogonal cover code (OCC) applied based on OCC groups corresponding to the PUSCH transmissions,
wherein a same redundancy version (RV) value is applied for one OCC group among the OCC groups.

12. The method of claim 11,
wherein the DCI includes an RV field, and
wherein RV values associated with the RV field are cyclically applied for the OCC groups.

13. The method of claim 12, further comprising:
transmitting a first configuration associated with a PUSCH repetition and a second configuration associated with OCC length,
wherein the PUSCH transmissions correspond to the PUSCH repetition, and
wherein the RV values are cyclically applied for the OCC groups in case that a repetition number of the PUSCH repetition is greater than the OCC length.

14. The method of claim 11, wherein the same RV value is applied for the OCC groups.

15. The method of claim 11, wherein the PUSCH transmissions are received in a non-terrestrial network (NTN).

16. A base station in a communication system, the base station comprising:
a transceiver; and
a processor coupled with the transceiver and configured to:
transmit downlink control information (DCI) including physical uplink shared channel (PUSCH) scheduling information, and
receive, on slots, PUSCH transmissions with orthogonal cover code (OCC) applied based on OCC groups corresponding to the PUSCH transmissions,
wherein a same redundancy version (RV) value is applied for one OCC group among the OCC groups.

17. The base station of claim 16,
wherein the DCI includes an RV field, and
wherein RV values associated with the RV field are cyclically applied for the OCC groups.

18. The base station of claim 17,
wherein the processor is further configured to transmit a first configuration associated with a PUSCH repetition and a second configuration associated with OCC length, and
wherein the RV values are cyclically applied for the OCC groups in case that a repetition number of the PUSCH repetition is greater than the OCC length.

19. The base station of claim 16, wherein the same RV value is applied for the OCC groups.

20. The base station of claim 16, wherein the PUSCH transmissions are received in a non-terrestrial network (NTN).
